(19) United States
(12) Patent Application Publication
(10) Pub. No.: US 2026/0180794 A1
(43) Pub. Date: Jun. 25, 2026

(54) Efficient Cryptographic Key Management in Resource Constrained Devices

(71) Applicant: Oracle International Corporation, Redwood Shores, CA (US)

(72) Inventors: Sebastian Jürgen Hans, Berlin (DE); Nicolas Michel Raphaël Ponsini, Mougins (FR)

(73) Assignee: Oracle International Corporation, Redwood Shores, CA (US)

(21) Appl. No.: 18/987,859

(22) Filed: Dec. 19, 2024

(51) Int. Cl. H04L 9/08; H04L 9/14

(52) U.S. Cl. CPC H04L 9/0869; H04L 9/0852; H04L 9/0891; H04L 9/0894; H04L 9/14

(57) ABSTRACT

One or more embodiments address the transition to Post Quantum Cryptography (PQC) within secure element hardware environments. The embodiments focus on key management solutions for resource-constrained devices running JAVA CARD or similar platforms. PQC implementations face challenges from large key sizes that strain secure element resources, including RAM, ROM, flash memory, input/output bandwidth, and processing capabilities. The embodiments present methods for handling PQC keys through importation, exportation, generation, storage, utilization, and protection operations. The implementation manifests as an Application Programming Interface (API) that enables applications to leverage key management capabilities efficiently within secure element resource constraints. The API delivers advantages through memory optimization using flexible condensation and derivation mechanisms. Security benefits emerge from integrating key operations within the certified platform environment, enabling hardware acceleration and side-channel attack countermeasures through native code implementation.

### TECHNICAL FIELD

This disclosure relates generally to cryptographic key management. More particularly, this disclosure relates to efficient cryptographic key management in resource constrained devices.

### BACKGROUND

Resource constrained hardware encompasses computational devices with limitations in processing power, memory capacity, and energy resources. Secure elements represent a prominent category of such constrained hardware, typically manifesting as tamper-resistant integrated circuits. These specialized microcontrollers commonly include cryptographic coprocessors, limited Random Access Memory (RAM) ranging from 4 Kilobytes (KB) to 32 KB, and flash memory typically not exceeding 400 KB.

The architectural design of secure elements prioritizes security features over computational capabilities, incorporating hardware-based cryptographic accelerators while maintaining minimal power consumption. Secure elements operate at clock frequencies generally below 50 Megahertz (MHz), which restricts complex computational tasks. The memory hierarchy in secure elements exhibits particular constraints, with specific segmentation between Read-Only Memory (ROM), RAM, and Electrically Erasable Programmable ROM (EEPROM) or flash memory. ROM stores immutable code and security parameters, while the limited RAM accommodates runtime operations, stack space, and temporary data storage. EEPROM, or flash segments, retains persistent data but may face endurance limitations of typically 500,000 to 1,000,000 write cycles.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

One or more embodiments of the present disclosure are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an example of a secure element system architecture designed for post-quantum cryptographic key management in accordance with one or more embodiments;

FIG. 2A and FIG. 2B illustrate an example of PQC key generation through seed derivation in accordance with one or more embodiments;

FIG. 3A and FIG. 3B illustrate an example of PQC key seed import with transaction protection in accordance with one or more embodiments;

FIG. 4A and FIG. 4B illustrate an example of PQC derived key import with memory selection in accordance with one or more embodiments;

FIG. 5A and FIG. 5B illustrate an example of a streaming protocol for PQC key import to secure elements in accordance with one or more embodiments;

FIG. 6A and FIG. 6B illustrate an example of a secure element API for protected PQC key import in accordance with one or more embodiments;

FIG. 7A and FIG. 7B illustrate an example of PQC key object creation through parameter-driven storage management in accordance with one or more embodiments;

FIG. 8A and FIG. 8B illustrate an example of format-specific PQC key exportation with memory-optimized streaming and access control in accordance with one or more embodiments;

FIG. 9A and FIG. 9B illustrate an example of a chunk-based PQC key export protocol for secure elements in accordance with one or more embodiments;

FIG. 10A and FIG. 10B illustrate an example of parameter-driven PQC key pair creation with secure element memory management in accordance with one or more embodiments;

FIG. 11A and FIG. 11B illustrate an example of memory-optimized post-quantum key management for secure elements through linked public-private key references in accordance with one or more embodiments;

FIG. 12A and FIG. 12B illustrate an example of memory-optimized post-quantum key management for resource-constrained secure elements through format-specific memory allocation and condensation in accordance with one or more embodiments;

FIG. 13A and FIG. 13B illustrate an example of runtime derivation of PQC key seeds into derived key structures enabling secure element applications to perform cryptographic operations while optimizing memory usage through deterministic key derivation procedures in accordance with one or more embodiments;

FIGS. 14A and 14B illustrate an example of hardware-backed secure erasure of derived PQC keys while preserving associated key seeds through synchronized memory management, transaction monitoring, and access control operations in accordance with one or more embodiments;

FIG. 15A and FIG. 15B illustrate an example of a post-quantum cryptography key management API that enables secure element applications to execute cryptographic operations through specialized objects that process derived key formats stored in memory while maintaining security boundaries and optimizing resource utilization in accordance with one or more embodiments;

FIG. 16A and FIG. 16B illustrates an example of a secure element application platform that implements PQC key management through an API that processes cryptographic operations by temporarily deriving condensed key seeds into volatile memory while maintaining security boundaries between derived and condensed formats in accordance with one or more embodiments; and

FIG. 17 illustrates an example computer system for use in efficient cryptographic key management in resource constrained devices in accordance with one or more embodiments.

### DETAILED DESCRIPTION

In the following detailed description, for the purposes of explanation, numerous specific details are set forth to aid understanding of one or more embodiments of the present disclosure. In some instances, an embodiment of the present disclosure may be practiced without one or more of these specific details. In some cases, a described feature of one embodiment of the present disclosure is also a feature of one or more other embodiments of the present disclosure even though the feature is not expressly described with respect to one or more other embodiments. In some embodiments, well-known structures and devices are shown in the figures in block diagram form to avoid unnecessarily obscuring the embodiment.

One or more embodiments address the ongoing transition from traditional cryptographic systems to Post-Quantum Cryptography (PQC) within the security industry. This migration has gained significant momentum following the National Institute of Standards and Technology's publication of initial PQC standards, reflecting a broader industry-wide preparation for quantum computing threats. One or more embodiments focus on key management solutions designed for resource constrained devices, such as secure element hardware running a JAVA CARD platform or the like.

PQC implementations face challenges due to substantially larger key sizes, often reaching several kilobytes, which strain the limited resources of secure elements. These constraints encompass restricted RAM, ROM, flash memory, input/output bandwidth, and processing capabilities. One or more embodiments present a method for handling PQC keys through multiple operations: importation, exportation, generation, storage, utilization, and protection. The methodology incorporates optimization techniques and flexible approaches to overcome the resource limitations of constrained devices. The technical implementation of one or more embodiments manifests as an Application Programming Interface (API), enabling applications to leverage these key management capabilities efficiently. This API-centric approach allows developers to implement PQC solutions while working within the strict resource boundaries of secure elements.

While some examples described herein involve the JAVA CARD secure element platform, the principles and methods of this disclosure can be adapted for other secure element platforms, such as Multi-Application Operating System (MULTOS) smart cards, Trusted Platform Module (TPM) devices, Fast IDentity Online (FIDO) secure authenticators, embedded Secure Elements (eSEs) in mobile devices, Internet-of-Things (IoT) secure elements, automotive secure microcontrollers, industrial control system security modules, and smart card microcontrollers based on proprietary native operating systems.
1. GENERAL OVERVIEW
2. CHALLENGES OF PQC KEY MANAGEMENT IN RESOURCE CONSTRAINED DEVICES
3. SECURE ELEMENT SYSTEM WITH EFFICIENT CRYPTOGRAPHIC KEY MANAGEMENT
4. EXAMPLE KEY MANAGEMENT APPLICATION PROGRAMMING INTERFACES
   4.1 PQC KEY GENERATION THROUGH SEED DERIVATION
   4.2 KEY OBJECT
   4.3 PQC KEY SEED IMPORT WITH TRANSACTION PROTECTION
   4.4 PQC DERIVED KEY IMPORT WITH MEMORY SELECTION
   4.5 STREAMING PROTOCOL FOR PQC KEY IMPORT
   4.6 PROTECTED PQC KEY IMPORT
   4.7 PQC KEY OBJECT CREATION THROUGH PARAMETER-DRIVEN STORAGE MANAGEMENT
   4.8 FORMAT-SPECIFIC PQC KEY EXPORTATION WITH MEMORY-OPTIMIZED STREAMING AND ACCESS CONTROL
   4.9 CHUNK-BASED PQC KEY EXPORT PROTOCOL
   4.10 PARAMETER-DRIVEN PQC KEY PAIR CREATION
   4.11 LINKED PUBLIC-PRIVATE KEY REFERENCES
   4.12 FORMAT-SPECIFIC MEMORY ALLOCATION AND CONDENSATION
   4.13 RUNTIME DERIVATION OF PQC KEY SEEDS
   4.14 SECURE ERASURE OF DERIVED PQC KEYS
   4.15 EXECUTION OF CRYPTOGRAPHIC OPERATIONS THROUGH SPECIALIZED OBJECTS THAT PROCESS DERIVED KEY FORMATS
   4.16 PROCESSING CRYPTOGRAPHIC OPERATIONS BY TEMPORARILY DERIVING CONDENSED KEY SEEDS
5. PRACTICAL APPLICATIONS; ADVANTAGES; IMPROVEMENTS
6. HARDWARE OVERVIEW
7. MISCELLANEOUS; EXTENSIONS

### 1. GENERAL OVERVIEW

One or more embodiments maintain a cryptographic key seed in non-volatile memory for use in the runtime generation of a temporary cryptographic key, as needed, for cryptographic processes. Initially, the system stores a cryptographic key seed in non-volatile memory without storing any corresponding cryptographic key that may be derived using the cryptographic key. In response to receiving a request, the system derived a cryptographic key by applying a deterministic cryptographic key derivation process to the cryptographic key seed. Based at least in part on the request, the system executes a cryptographic process using the cryptographic key. Subsequent to executing the cryptographic process, the system discards the cryptographic key while maintaining the cryptographic key seed in the non-volatile memory. The system may discard the cryptographic key immediately after executing the cryptographic process or in response to a separate triggering event. In an example, the triggering event may include determining that the cryptographic key is unlikely to be needed in an upcoming time period.

By temporarily deriving the cryptographic key for execution of a cryptographic process and discarding the cryptographic key after execution of the cryptographic process, the system may reduce the use of storage resources for storing the cryptographic key. Furthermore, by temporarily deriving the cryptographic key for execution of a cryptographic process and discarding the cryptographic key after execution of the cryptographic process, the system may reduce a time period during which the cryptographic key may be accessed by an unauthorized entity.

One or more embodiments described in this Specification and/or recited in the claims may not be included in the General Overview section.

### 2. CHALLENGES OF PQC KEY MANAGEMENT IN RESOURCE CONSTRAINED DEVICES

Migration to PQC presents significant challenges for secure element implementations due to the substantial size of PQC keys. These keys, used for signature and key encapsulation operations, exceed traditional cryptographic key lengths by several orders of magnitude. The implementation challenges manifest in multiple operational aspects of secure elements, specifically during key importation, exportation, storage, generation, usage, and protection phases. The large key sizes create performance bottlenecks during secure element personalization and transaction processing. A limitation emerges in RAM utilization, where PQC keys exceeding 2 KB can overwhelm secure elements including 8-32 KB of total RAM, potentially causing operational failures. The evolving nature of PQC algorithms compounds these challenges. Current standardized algorithms include Module-Lattice-Based Digital Signature Standard (ML-DSA), Module-Lattice-Based Key-Encapsulation Mechanism (ML-KEM), Stateless Hash-Based Digital Signature Standard (SLH-DSA), Extended Merkle Signature Scheme (XMSS), and Leighton-Masur-Lambert (LMS), with more algorithms expected during market maturation.

The current market situation lacks viable solutions for PQC key management within the secure element industry. For example, the existing JAVA CARD API framework provides neither the optimization nor flexibility required for effective PQC key handling. Market demand for PQC support continues to grow, exemplified by JAVA CARD licensees requesting ML-KEM support in the JAVA CARD API. Additionally, organizations are advancing specifications to support NIST PQC algorithms with formal migration timelines beginning in 2025. These factors create a need for comprehensive PQC key management solutions in secure elements.

One or more embodiments address these and other challenges of PQC key management in resource constrained devices by introducing an approach based on the structure of PQC keys in algorithms, like ML-DSA, ML-KEM, XMSS, and LMS. These algorithms generate keys using fixed parameter sets combined with random seed values. One or more embodiments establish two distinct key formats, condensed and derived. The condensed format includes seed values, typically 32-64 bytes, alongside parameter set references. The derived format represents the complete key data derived through deterministic calculations defined by PQC standards, such as Federal Information Processing Standards (FIPS) 204 and FIPS 203, often exceeding 2 KB in length.

One or more embodiments implement these concepts through a comprehensive JAVA CARD API, enabling flexible key management across different memory types. The API supports multiple key handling operations, including creation of key objects using parameter set identifiers, importation of key data, and exportation capabilities. Key data operations can be performed in chunks using an init-update-doFinal paradigm with support for encrypted data during import. One or more embodiments allow applications to specify memory types (e.g., volatile or non-volatile memory) for storing key data in either condensed or derived formats. Key pair management is supported in one or more embodiments with APIs for creation and handling of both public and private key components. One or more embodiments include functionality for dynamic format conversion, allowing key objects to derive when needed and revert to a condensed form to free secure hardware element resources.

Cryptographic operations can utilize either format with the condensed format automatically deriving for single operations. Multiple derived and condensed formats may exist for a single key, providing additional flexibility. The API design in one or more embodiments accommodates various cryptographic operations, including digital signature operations, cryptographic encryption and decryption operations, key agreement or key exchange protocols, and key encapsulation mechanisms, supporting both explicit and implicit key derivation scenarios. This comprehensive approach effectively addresses the resource constraints of secure elements while maintaining operational flexibility for PQC implementations.

### 3. SECURE ELEMENT SYSTEM WITH EFFICIENT CRYPTOGRAPHIC KEY MANAGEMENT

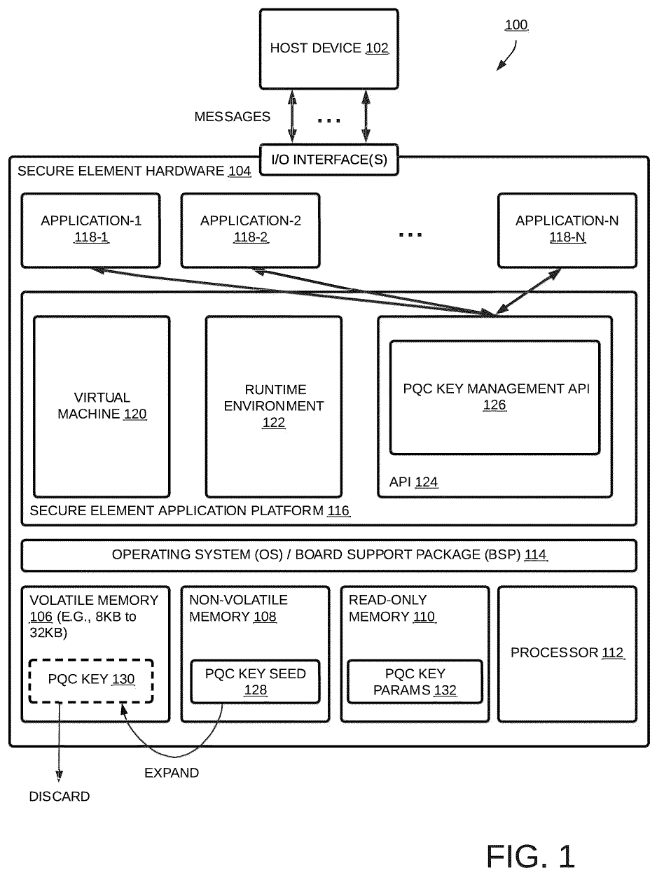

FIG. 1 illustrates an example of a secure element system architecture designed for post-quantum cryptographic key management in accordance with one or more embodiments. The system 100 comprises a host device 102 that includes a secure element hardware 104. The secure element 104 incorporates multiple memory components: volatile memory 106 for temporary storage, non-volatile memory 108 for persistent data, and ROM 110 for permanent instructions. A processor 112 serves as the computational core of the secure element 104.

The software architecture begins with an operating system/board support package 114, which provides low-level hardware abstraction. Above this layer resides the secure element application platform 116, which houses a virtual machine 120, a runtime environment 122, and an API 124. The API 124 specifically includes a PQC key management API 126, enabling secure handling of quantum-resistant cryptographic keys.

The system 100 employs a key management approach centered around PQC key seeds. A PQC key seed 128 resides in non-volatile memory 108, serving as the basis for key derivation. When applications 118 executing on the secure element request cryptographic operations, the system 100 performs a deterministic PQC key derivation process. This process transforms the stored seed 128 into a full PQC key 130, which then occupies space in volatile memory 106.

The deterministic PQC key derivation process transforms a stored PQC key seed into a complete PQC key through lattice-based operations. Applications executing on a secure element initiate key generation by requesting specific cryptographic operations. One or more embodiments determine whether key encapsulation or digital signature capabilities are needed. For key encapsulation requirements, ML-KEM operations transform the seed through Module Learning With Errors techniques to generate encapsulation/decapsulation key pairs. For digital signature requirements, ML-DSA operations employ both Module Learning With Errors and Module Short Integer Solution techniques to produce signing/verification key pairs. The selected expansion scheme performs deterministic mathematical computations involving polynomial arithmetic, matrix operations, and finite field calculations. The resulting derived key exhibits quantum-resistant properties based on the hardness assumptions of the underlying lattice problems. The complete PQC key occupies space in memory while maintaining consistent cryptographic characteristics due to the deterministic nature of the derivation process.

In one or more embodiments, the deterministic PQC key derivation process uses Module Learning with Errors (MLWE) operations to transform the PQC key seed into derived keys. When an application requests key derivation, the process applies ML-DSA (FIPS 204) and/or ML-KEM (FIPS 203) algorithms to the seed. ML-DSA performs lattice-based signing operations by generating polynomials over finite fields and computing matrix-vector products in a structured lattice. The ML-KEM handles key encapsulation through sampling of discrete Gaussian distributions and polynomial arithmetic in quotient rings. Matrix operations within the lattice space produce deterministic expansions of the seed material. Structured permutations and transformations of these expansions yield the full PQC key while maintaining quantum security properties. The derived keys exhibit consistent cryptographic characteristics due to the deterministic nature of the underlying lattice computations.

The architecture implements a security-focused memory management strategy. After completing requested cryptographic processes, the system 100 deliberately discards the derived PQC key 130 from volatile memory 106. However, the system 100 maintains the PQC key seed 128 in non-volatile memory 108, enabling regeneration of the full key when needed. This approach optimizes memory usage while maintaining security, given the substantial byte size of post-quantum cryptographic keys relative to the size of volatile memory 106.

The system 100 operates through a layered architecture where applications 118 interact with the PQC key management capabilities through defined API calls. This approach ensures secure and efficient handling of post-quantum cryptographic operations within the resource constraints of the secure element environment. Post-quantum cryptography encompasses cryptographic algorithms designed to remain secure against attacks by both classical computers and quantum computers. The field emerged from the recognition that quantum computers, once developed to a sufficient scale, could break many widely used cryptographic systems through algorithms, such as Shor's algorithm and Grover's algorithm. Traditional public-key cryptography relies heavily on mathematical problems, like integer factorization and discrete logarithms, which quantum computers could potentially solve in polynomial time. In response to these emerging threats, post-quantum cryptography develops alternative approaches based on different mathematical foundations.

The mathematical foundations of post-quantum cryptography include lattice-based cryptography, hash-based signatures, multivariate cryptography, and code-based cryptography. Lattice-based systems, for example, derive security from the difficulty of solving certain problems in high-dimensional lattices, while hash-based signatures build secure digital signatures from cryptographic hash functions. These mathematical problems are believed to remain computationally difficult even for quantum computers.

A distinguishing characteristic of post-quantum cryptographic systems lies in their resource usage. The key sizes and computational overhead typically exceed those of traditional cryptographic systems by significant margins. For instance, some post-quantum schemes require key sizes of several kilobytes, compared to hundreds of bits for current public-key systems. This increased resource demand poses challenges for implementation on constrained devices and embedded systems.

The development and standardization of post-quantum cryptography has gained momentum through efforts by organizations like the National Institute of Standards and Technology (NIST). Through public competitions and rigorous evaluation processes, NIST works to identify and standardize quantum-resistant algorithms suitable for widespread deployment. These standardization efforts aim to ensure the availability of thoroughly vetted cryptographic solutions before large-scale quantum computers become a reality, enabling a smooth transition from current cryptographic systems to quantum-resistant alternatives.

The host device 102 represents an electronic device that provides the physical and operational environment for the secure element 104. This host device 102 serves as both a housing structure and an interface facilitator for secure element operations. Examples of host device 102 include a smartphone, a tablet, a payment terminal, or any electronic system requiring secure cryptographic operations.

From a hardware perspective, the host device 102 provides infrastructure for the secure element 104, including power supply, communication buses, and physical protection. The host device 102 manages the physical interface specifications, which might include ISO/IEC 7816 for contact interfaces or ISO/IEC 14443 for contactless communication. These standardized interfaces provide data exchange between the host device 102 and the embedded secure element 104.

The host device 102 establishes a trusted boundary around the secure element 104. Through controlled interfaces, the host device 102 mediates communication between external applications and the secure element 104, helping prevent unauthorized access to sensitive cryptographic operations. The host device 102 implements proper security protocols to maintain the integrity of this communication channel. In the context of post-quantum cryptography implementation, the host device 102 handles the larger data volumes associated with post-quantum cryptographic operations, managing the increased bandwidth requirements for key exchange and cryptographic processes. The host device 102 also provides computational resources to support calculations used for post-quantum algorithms while still maintaining security boundaries for secure element operations.

From an architectural standpoint, the host device 102 implements drivers and middleware to facilitate integration with the secure element 104's operating system 114 and application platform 116. This software stack is designed to support post-quantum cryptographic operations while maintaining compatibility with existing secure element protocols and standards. The host device 102 serves as both a physical platform and a logical bridge, enabling secure and efficient execution of post-quantum cryptographic operations within the constrained environment of the secure element 104.

The secure element 104 represents a tamper-resistant hardware platform designed for executing cryptographic operations and safeguarding sensitive data. This specialized hardware component combines multiple memory types—volatile memory 106, non-volatile memory 108, and ROM 110—with a dedicated processor 112 to create a secure computing environment. The processor architecture may implement hardware-based cryptographic acceleration to enhance performance while maintaining strict security boundaries.

From a memory architecture perspective, the secure element's volatile memory 106 serves as temporary working space for cryptographic operations, while non-volatile memory 108 provides persistent storage for long-term data such as cryptographic keys and certificates. The ROM 110 includes security protocols and boot-loader code that may remain unchanged throughout the secure element's lifecycle. This memory organization enables the handling of cryptographic operations while maintaining data security.

The operating system/board support package 114 provides low-level hardware abstraction, managing memory allocation, process scheduling, and hardware-specific optimizations. Above this foundation, the secure element application platform 116 creates an environment for executing secure applications. This platform incorporates a virtual machine 120 for code isolation, a runtime environment 122 for application execution, and an application programming interface 124 for access to security services including PQC key management services.

A distinguishing characteristic of the secure element 104 lies in the implementation of physical security measures. These measures include sensors to detect tampering attempts, shields to prevent side-channel analysis, and circuitry designed to resist various forms of physical attacks. The secure element's processor 112 implements secure boot mechanisms to verify the integrity of stored code before execution, ensuring the platform remains trustworthy.

In the context of post-quantum cryptography, the secure element 104 faces challenges due to increased key sizes and computational requirements. The PQC key management API 126 addresses these challenges by providing specialized interfaces for handling quantum-resistant cryptographic operations. This API 126 works in conjunction with the memory architecture to efficiently manage large PQC keys through techniques, such as seed-based key generation and strategic use of different memory types.

The volatile memory 106 within the secure element 104 serves as a temporary workspace for executing cryptographic operations such as those involving post-quantum cryptography. This type of memory, implemented, for example, as Static Random-Access Memory (SRAM), loses stored data when power is removed from the secure element 104. The volatile nature of this memory provides a security advantage by ensuring sensitive cryptographic material cannot persist beyond the intended operational window.

During cryptographic operations, the volatile memory 106 stores derived PQC keys 130 generated from seed values. These derived keys require substantial memory space due to the larger key sizes of post-quantum cryptographic algorithms. For example, lattice-based cryptography might require several kilobytes of memory for a single derived key compared to just hundreds of bits for traditional cryptographic keys. The volatile memory 106 is therefore managed to accommodate these larger structures while working within the constraints of the secure element's resources.

From an architectural perspective, the volatile memory 106 operates in conjunction with the processor 112 to provide high-speed access to cryptographic materials during operations. The memory's organization includes dedicated regions for different purposes: workspace for cryptographic computations, temporary storage for derived keys, and buffers for input/output operations. This memory allocation helps maintain separation between different security contexts and optimizes the use of limited memory resources.

The secure element's operating system implements memory management policies for the volatile memory 106. These policies provide isolation between different applications accessing the memory space, and they enforce secure cleanup procedures after cryptographic operations are completed. For instance, when a cryptographic operation finishes, the system may actively overwrite memory locations that include sensitive data, such as derived PQC keys, with random values before releasing the memory for other uses. This secure memory zeroization hinders unauthorized access to residual cryptographic material.

Memory access patterns within the volatile memory 106 are designed to prevent side-channel attacks. The secure element employs various countermeasures, such as memory access randomization and constant-time operations, to protect against timing attacks and power analysis. These protections are useful when handling the larger key structures associated with post-quantum cryptography, as longer processing times could potentially expose more information through side channels.

The non-volatile memory 108 within the secure element 104 functions as persistent storage that retains data even when power is removed from the device. This memory type, implemented, for example, as EEPROM, or Flash memory, stores sensitive cryptographic materials that persist across power cycles. In the context of post-quantum cryptography, the non-volatile memory 108 stores PQC key seeds 128, which serve as foundational elements for generating full PQC keys. These seeds require less storage space than complete PQC keys, making them well-suited for the limited non-volatile memory capacity of secure elements. For instance, where a complete post-quantum key might require several kilobytes, the corresponding seed might only need a few hundred bytes of storage space.

The secure element's architecture incorporates protective measures specifically for the non-volatile memory 108. Hardware-based encryption shields the stored contents from unauthorized access, while error detection and correction mechanisms ensure data integrity over time. Memory wear-leveling algorithms distribute write operations across the available memory space, extending the operational lifespan of these storage cells, which typically support a finite number of write cycles. From a security perspective, the non-volatile memory 108 implements access control mechanisms. The operating system/board support package 114 manages these controls, ensuring applications are restricted to accessing authorized memory regions through well-defined interfaces.

The memory organization within the non-volatile storage follows a hierarchical structure, separating system configuration data, application data, and cryptographic materials. This structured approach enables efficient memory management while maintaining strong security boundaries between different types of stored information. For example, the PQC key seeds occupy specially protected memory segments, isolated from other application data and configured with additional security controls to prevent unauthorized modification or access.

The ROM 110 within the secure element 104 is a storage component that includes permanent, unchangeable code and data for the secure element's operation. This memory type, manufactured during the production process, becomes permanently fixed and cannot readily be modified after manufacturing. The immutable nature of ROM provides a root of trust for the secure element's security architecture.

From a functional perspective, the ROM 110 stores the initial boot code, cryptographic libraries, and fundamental security protocols required during the secure element's startup sequence. The boot code, often called the bootloader, performs security checks before transferring control to the operating system. These security checks verify the integrity of other memory components and ensure the secure element starts in a trusted state.

The cryptographic libraries stored in ROM 110 include optimized implementations of algorithms and mathematical functions. For post-quantum cryptography applications, these libraries might include specialized routines for lattice operations, hash functions, or other mathematical constructs fundamental to quantum-resistant algorithms. The permanent nature of these implementations ensures malicious code cannot compromise the basic cryptographic operations.

Security parameters and device-specific configurations also reside in the ROM 110. These parameters might include unique device identifiers, public key certificates of trusted authorities, or fundamental system constants needed for secure operation. By storing these values in ROM, the secure element establishes an immutable trust anchor that may remain consistent throughout the device lifecycle. The memory architecture employs protection mechanisms for the ROM 110. Physical security measures, such as anti-tampering shields and encrypted memory buses, protect against unauthorized access attempts. The processor 112 enforces access controls when reading from this memory region, ensuring authorized code can access sensitive boot sequences and security parameters.

The processor 112 functions as the computational core of the secure element 104, designed to execute cryptographic operations securely and efficiently. This specialized processor employs a Harvard architecture, which maintains separate instruction and data buses to enhance security by preventing instruction modification during runtime. The processor operates at frequencies typically ranging from 25 to 50 MHz, balancing performance requirements with power constraints inherent to secure elements. From a security perspective, the processor 112 implements multiple privilege levels and memory protection mechanisms. These security features create isolated execution environments, preventing unauthorized access between different security domains. The processor may include dedicated hardware accelerators for common cryptographic operations, such as AES encryption, SHA hashing, and public key algorithms. For post-quantum cryptography operations, the processor 112 efficiently handles larger key sizes and more complex mathematical computations through specialized instruction sets or dedicated acceleration units. The processor's instruction set architecture (ISA) includes security-focused instructions designed specifically for cryptographic operations. These instructions enable atomic operations, constant-time execution, and secure key handling to protect against timing and power analysis attacks.

Memory management within the processor 112 involves protection mechanisms. The processor implements a Memory Protection Unit (MPU) or Memory Management Unit (MMU) to enforce strict access controls between different memory regions. This hardware-based memory protection ensures applications are restricted to accessing authorized memory segments, creating strong isolation between different security contexts. The processor also includes specialized registers for storing sensitive cryptographic material during operations, with hardware-based protection against unauthorized access attempts.

The processor 112 works in conjunction with various hardware sensors to maintain a secure operating environment. These sensors monitor environmental conditions, such as voltage, temperature, and clock frequency, to detect potential tampering attempts. Upon detecting anomalous conditions, the processor 112 can trigger defensive measures, such as immediate memory clearing or system shutdown. This approach to security monitoring ensures the processor maintains a trusted execution environment even under adverse conditions. For post-quantum cryptographic operations, these security features are useful due to the increased complexity and longer execution times of quantum-resistant algorithms.

The operating system/board support package 114 represents a software layer that manages hardware resources and provides services within the secure element 104. This specialized software package combines a real-time operating system optimized for secure elements with hardware abstraction layers designed for cryptographic operations. The operating system portion handles task scheduling, memory management, and inter-process communication, while the board support package provides direct hardware interfaces and low-level drivers.

From a resource management perspective, the operating system component implements scheduling algorithms tailored for cryptographic operations. These schedulers balance the intensive computational requirements of post-quantum cryptography with the limited processing power available in secure elements. For example, when generating PQC keys from seeds, the scheduler might interleave these operations with other critical system tasks to maintain responsive system behavior while ensuring secure key generation. The operating system maintains separation between different memory spaces through hardware-assisted memory protection mechanisms.

The board support package component provides hardware abstraction through a series of drivers. These drivers manage direct interactions with the processor 112, various memory types (106, 108, 110), and security sensors. For cryptographic operations, the board support package supports hardware acceleration features through dedicated interfaces, enabling execution of mathematical operations used for post-quantum algorithms.

The operating system/board support package 114 implements secure boot procedures, validates cryptographic operations, and manages access controls across the system. Through these mechanisms, the software layer creates a trusted execution environment for handling sensitive cryptographic materials. The package also manages hardware-based random number generation, secure key storage, and cryptographic acceleration features, providing services for both traditional and post-quantum cryptographic operations.

The secure element application platform 116 provides an execution environment that bridges the underlying hardware capabilities of the secure element 104 with high-level application requirements. This platform layer builds upon the operating system/board support package 114 to create a secure environment for running cryptographic applications. The platform architecture incorporates three components: the virtual machine 120, runtime environment 122, and application programming interface 124. These components work together to support secure application execution. The virtual machine 120 creates isolated execution spaces for applications, preventing unauthorized interactions between different application contexts. The runtime environment 122 provides services and libraries for application execution, while the API 124 offers interfaces for accessing platform capabilities.

In the context of post-quantum cryptography, the secure element application platform 116 faces challenges due to the increased computational and memory requirements of quantum-resistant algorithms. The platform efficiently manages these operations within the constrained resources of a secure element. For example, when an application requests a PQC key operation, the platform coordinates memory allocation across different memory types, manages the key lifecycle, and ensures secure key handling throughout the operation. The secure element application platform 116 implements multiple security layers, including code verification, access control, and secure communication channels. Before executing any application code, the platform verifies the code's integrity and authenticity. During execution, the platform enforces security policies that control how applications interact with sensitive resources, such as cryptographic keys and secure memory regions.

The platform's flexibility enables support for various application types while maintaining strict security boundaries. Through the PQC key management API 126, applications can leverage post-quantum cryptographic capabilities. The platform manages the complexity of quantum-resistant algorithms, providing applications with interfaces while ensuring secure key handling. This abstraction allows application developers to focus on their specific functionality while the platform handles details of secure key management and cryptographic operations.

The application (e.g., 118-1, 118-2, . . . , or 118-N or generically “application 118”) represents a software program designed to run within the secure element 104, leveraging the secure environment provided by the secure element application platform 116. These applications serve specific security-focused purposes, such as payment processing, identity verification, or secure key management. From a technical perspective, the application 118 executes within a confined environment established by the virtual machine 120. This containment ensures the application cannot exceed authorized boundaries or interfere with other applications running on the secure element. When the application needs to perform cryptographic operations, particularly those involving post-quantum cryptography, the application communicates through defined API calls to the PQC key management API 126.

The application 118 requests PQC key operations through the API 126, triggering a sequence where the system generates full PQC keys 130 from stored seeds 128. This approach allows applications to work with quantum-resistant cryptography without having to directly manage the memory requirements of full PQC keys. The application 118 may remain unaware of the complex memory management happening behind the scenes, focusing instead on the cryptographic operations required for specific tasks.

Security considerations permeate application operations. Before execution, the application 118 code undergoes verification to ensure authenticity and integrity. During runtime, the application 118 operates under access controls that determine which resources and operations are permitted. For example, when an application 118 requests a cryptographic operation, the system verifies the application's permissions, manages key access, and ensures secure handling of sensitive data throughout the operation.

In the context of secure element system 100, the virtual machine 120 operates as a foundational component within the secure element application platform 116. The virtual machine 120 provides an abstraction layer between the secure element hardware 104 and applications 118, enabling platform-independent execution of applications written in a high-level programming language.

For a JAVA CARD platform implementation, the virtual machine 120 comprises a JAVA CARD Virtual Machine (JCVM) that interprets and executes JAVA CARD bytecode. The virtual machine 120 manages memory allocation, handles garbage collection, and enforces security boundaries between different applications 118 running on the secure element 104.

The virtual machine 120 works in conjunction with the runtime environment 122 to provide secure execution of post-quantum cryptographic operations. When an application 118 invokes the PQC key management API 126, the virtual machine 120 manages the execution context and ensures isolated access to the PQC key seed 128 and PQC key 130 in their respective memory locations. The virtual machine 120 enforces memory access controls that prevent unauthorized access to cryptographic materials across different security contexts.

Through bytecode interpretation, the virtual machine 120 enables the secure element 104 to execute the deterministic PQC key derivation process while maintaining strict isolation between applications 118. The virtual machine 120 coordinates with the processor 112 to ensure efficient execution of cryptographic operations while adhering to the resource constraints of the secure element hardware 104.

The virtual machine 120 and PQC key management API 126 enable implementation of PQC key management operations through native code, which executes directly on the processor 112. While applications 118 interact with the API 126 through high-level method calls, these calls map to native code implementations stored in ROM 110.

Native code implementations bypass bytecode interpretation overhead by executing processor-specific instructions. The deterministic PQC key derivation process benefits significantly from native execution, as complex mathematical operations can leverage hardware acceleration features of the processor 112. Memory operations involving the PQC key seed 128 and PQC key 130 execute more efficiently through direct hardware access rather than through virtual machine 120 abstractions.

The PQC key management API 126 exposes a high-level interface while internally delegating to native methods through the JAVA Native Interface (JNI) or similar bridging mechanisms. Applications 118 remain platform-independent while critical cryptographic operations execute in native code. This architectural approach maintains the security benefits of the virtual machine 120 while achieving performance improvements through hardware-optimized implementations.

Native code implementations can directly access hardware-based countermeasures against side-channel attacks. These countermeasures may include specialized processor 112 instructions or hardware-based random number generation. The secure element operating system 114 manages the secure loading and execution of native code components while maintaining isolation between different security contexts.

Memory management for PQC operations benefits from native implementation through direct control over volatile memory 106 and non-volatile memory 108 access patterns. The native code can implement optimized data structures and memory layouts specifically designed for the resource constraints of the secure element 104. This optimization reduces memory fragmentation and improves overall system performance during cryptographic operations.

The runtime environment 122 provides services and system resources used for secure execution of applications 118 on the secure element 104. The runtime environment 122 manages application lifecycles, handles communication between applications 118 and the operating system 114, and enforces security policies defined by the secure element application platform 116.

Memory management functions of the runtime environment 122 control allocation and deallocation of volatile memory 106 during PQC operations. When an application 118 requests generation of a PQC key 130, the runtime environment 122 coordinates with the virtual machine 120 to allocate appropriate memory segments while maintaining isolation between different security contexts.

The runtime environment 122 implements transactional memory mechanisms to ensure atomic operations during cryptographic processes. These mechanisms protect against data corruption or exposure in cases where PQC operations are interrupted. The runtime environment 122 manages secure transfer of data between volatile memory 106 and non-volatile memory 108 when storing or retrieving the PQC key seed 128.

Communication services provided by the runtime environment 122 enable secure message passing between applications 118 and the PQC key management API 126. The runtime environment 122 implements access control mechanisms that restrict API usage based on application privileges and security requirements. These mechanisms prevent unauthorized access to cryptographic materials and operations.

The runtime environment 122 manages resource scheduling and optimization to ensure efficient execution within the constraints of the secure element hardware 104. Runtime monitoring features track memory usage and processing load during PQC operations, enabling dynamic resource allocation adjustments to maintain system stability and performance.

The API 124 serves as a standardized interface layer within the secure element application platform 116, enabling applications 118 to access platform services and functionality. The API 124 comprises multiple interface components, including the PQC key management API 126, which provides specialized functionality for post-quantum cryptographic operations.

Applications 118 interact with the API 124 through well-defined method calls that abstract underlying implementation details. The API 124 enforces access control mechanisms to regulate application access to sensitive operations and resources. Security checks performed by the API 124 validate application privileges before permitting access to cryptographic functions.

The API 124 includes interface definitions for memory management, cryptographic operations, and communication services. Memory management interfaces enable applications 118 to request allocation and deallocation of resources in volatile memory 106 and non-volatile memory 108. Cryptographic interfaces expose methods for key generation, encryption, decryption, and digital signatures.

Communication interfaces within the API 124 facilitate secure data exchange between applications 118 and platform services. The API 124 implements error handling mechanisms to provide applications with meaningful feedback about operation status and failure conditions. Exception handling protocols ensure graceful error recovery while maintaining system security.

The API 124 supports extensibility through modular design, allowing addition of new interfaces as requirements evolve. Version management features in the API 124 maintain compatibility between different generations of applications 118 and platform functionality. Documentation associated with the API 124 specifies interface contracts, expected behaviors, and security requirements for application developers.

The PQC key management API 126 provides specialized methods for handling post-quantum cryptographic keys within the secure element 104. Applications 118 access PQC functionality through method calls that abstract complex key management operations into a standardized interface. The PQC key management API 126 implements secure protocols for key generation, storage, and utilization while operating within resource constraints of the secure element hardware.

Method definitions within the PQC key management API 126 support deterministic key derivation from seeds. Applications 118 invoke key generation methods that apply derivation algorithms to the PQC key seed 128 stored in non-volatile memory 108. The derivation process produces the PQC key 130 in volatile memory 106 for immediate cryptographic use.

Memory management methods in the PQC key management API 126 control allocation and deallocation of storage space for cryptographic materials. The API implements secure erasure protocols that remove the PQC key 130 from volatile memory 106 after completing requested cryptographic operations. Retention of the PQC key seed 128 in non-volatile memory 108 enables regeneration of the PQC key 130 when needed for subsequent operations.

Security features of the PQC key management API 126 enforce access control and key isolation. The API validates application privileges before permitting access to key management functions. Memory protection mechanisms prevent unauthorized access to cryptographic materials across different security contexts. Error handling protocols in the API provide applications with detailed status information while maintaining security of sensitive data.

The PQC key management API 126 supports native code implementation of cryptographic operations. Method calls from applications 118 map to optimized native routines that execute directly on the processor 112. Native implementation enables efficient use of hardware acceleration features while maintaining the security benefits of the virtual machine 120 environment.

The PQC key seed 128 represents a condensed cryptographic value stored in non-volatile memory 108 of the secure element 104. The PQC key seed 128 serves as source data for generating full-length post-quantum cryptography keys through deterministic derivation. The condensed format of the PQC key seed 128 reduces storage requirements within the limited non-volatile memory 108 of the secure element 104.

The PQC key seed 128 maintains persistence across power cycles due to storage in non-volatile memory 108, enabling consistent regeneration of identical PQC keys when needed for cryptographic operations. A deterministic relationship exists between the PQC key seed 128 and any derived PQC keys derived from the seed, ensuring cryptographic operations remain consistent and reproducible. The compact nature of the PQC key seed 128 addresses memory constraints while preserving the ability to generate full-size, post-quantum cryptographic keys on demand.

The secure element 104 protects the PQC key seed 128 through hardware-based security features inherent to secure element implementations. Storage of the PQC key seed 128 leverages memory protection mechanisms provided by the secure element hardware to prevent unauthorized access or modification.

The PQC key seed 128 can maintain an intermediate state between a minimum-length seed value and a fully derived PQC key 130. This partially derived form reduces computational overhead during subsequent derivation operations while balancing storage requirements in non-volatile memory 108. The secure element 104 implements selective derivation stages, where initial derivation operations transform a minimum-length seed into the partially derived PQC key seed 128.

The partially derived PQC key seed 128 preserves deterministic properties required for consistent key generation. Transformation from the partially derived PQC key seed 128 to the complete PQC key 130 follows defined mathematical operations specific to the post-quantum cryptographic algorithm in use. The secure element 104 stores derivation parameters alongside the partially derived PQC key seed 128, enabling proper continuation of the derivation process when generating the full PQC key 130.

Storage of PQC key seed 128 in a partially derived form provides memory optimization benefits. The secure element 104 calculates an optimal partial derivation point based on available non-volatile memory 108 capacity and computational resources. This optimization reduces total processing time when compared to full derivation from a minimum-length seed while maintaining a smaller storage footprint than the complete PQC key 130.

The runtime environment 122 manages the completion of key derivation from the partially derived PQC key seed 128 to PQC key 130. When applications 118 request cryptographic operations, the runtime environment 122 performs remaining derivation stages to generate the complete PQC key 130 in volatile memory 106. This approach preserves memory resources while providing efficient access to fully derived keys for cryptographic processing.

The PQC key 130 represents a fully derived cryptographic key suitable for post-quantum cryptographic operations. A deterministic derivation process transforms the PQC key seed 128 into PQC key 130, which resides in volatile memory 106 during active use. The complete form of PQC key 130 meets size requirements specified by post-quantum cryptographic algorithms, typically spanning multiple kilobytes.

The secure element 104 generates PQC key 130 in response to cryptographic operation requests from applications 118. Generation occurs through application of derivation functions to PQC key seed 128, producing the full-length key structure required for post-quantum cryptographic processing. The derived PQC key 130 maintains mathematical properties necessary for quantum-resistant cryptographic operations while existing temporarily in volatile memory 106.

Applications 118 utilize PQC key 130 through the PQC key management API 126, which manages access to the derived key during cryptographic operations. The runtime environment 122 coordinates memory allocation for PQC key 130, ensuring efficient use of limited volatile memory 106 resources. Upon completion of requested cryptographic operations, the secure element 104 removes PQC key 130 from volatile memory 106 to minimize memory consumption.

The temporary nature of PQC key 130 serves as a security measure, reducing exposure of the complete key material. Storage in volatile memory 106 ensures automatic removal of PQC key 130 during power loss events. The secure element 104 can regenerate identical instances of PQC key 130 as needed through consistent application of derivation functions to the persistent PQC key seed 128.

The PQC key parameters 132 comprise configuration values and algorithm-specific settings required for post-quantum cryptographic operations. These parameters define characteristics of both PQC key seed 128 and PQC key 130, including key sizes, algorithm identifiers, and derivation process requirements. The secure element 104 stores PQC key parameters 132 in non-volatile memory 108 alongside PQC key seed 128.

The runtime environment 122 references PQC key parameters 132 when executing derivation operations to generate PQC key 130. Parameter values guide the transformation process from PQC key seed 128 to a fully derived key, ensuring proper implementation of specified post-quantum algorithms. The PQC key management API 126 validates requested cryptographic operations against PQC key parameters 132 to confirm compatibility with selected algorithms and key configurations.

Applications 118 access relevant parameter information through structured queries to the PQC key management API 126. The secure element 104 protects PQC key parameters 132 through hardware-based security mechanisms, preventing unauthorized modification that could compromise cryptographic operations. Parameter values remain persistent across power cycles due to storage in non-volatile memory 108, maintaining consistent configuration for key generation processes.

The PQC key parameters 132 enable flexible support for multiple post-quantum cryptographic algorithms within the secure element 104. Parameter definitions accommodate varying key sizes and structural requirements across different post-quantum implementations. The runtime environment 122 optimizes memory allocation based on parameter specifications, efficiently managing limited resources during key derivation and cryptographic operations.

### 4. EXAMPLE KEY MANAGEMENT APPLICATION PROGRAMMING INTERFACES

The section presents examples of JAVA interfaces of the PQC key management API 126, The examples are provided to illustrate one or more embodiments of the present disclosure where specific details of an embodiment may vary from implementation to implementation. For example, an embodiment is not limited to being a JAVA interface or limited to the exact operation of an example. The examples are, accordingly, to be regarded in an illustrative rather than a restrictive sense.

### 4.1 PQC Key Generation Through Seed Derivation

In one or more embodiments, the PQC key management API 126 implements a method call that accepts at least two parameters, a key seed identifier referencing the stored PQC key seed 128 and a pointer to PQC key params 132 in ROM 110. Applications 118 invoke this method to initiate deterministic derivation of the PQC key seed 128 into the PQC key 130. The key seed identifier enables secure retrieval of the PQC key seed 128 from non-volatile memory 108. Access control mechanisms validate the calling application's authorization to use the referenced key seed. Upon successful validation, the API loads the PQC key seed 128 into a protected memory region for processing. PQC key params 132 stored in ROM 110 specify the derivation algorithm and associated parameters for generating the PQC key 130. The params structure includes algorithm identifiers, key size specifications, and additional configuration data required for the derivation process. Read-only storage of params ensures integrity of algorithm selection and prevents unauthorized modification of derivation parameters. The API executes the specified deterministic derivation algorithm to transform the PQC key seed 128 into the PQC key 130. Memory management functions allocate space in volatile memory 106 for storing the generated key. The derivation process may leverage native code implementation for optimal performance on the secure element hardware 104. Following successful key derivation, the API stores the PQC key 130 in volatile memory 106 with appropriate access controls. Applications 118 receive a reference to the derived key for use in cryptographic operations. The API maintains the association between the original key seed identifier and the derived key reference to support subsequent memory management operations.

In one or more embodiments, the following example interface of the PQC key management API 126 defines methods for PQC key management on secure elements:
package com.securelement.api;
/**
*API interface for managing Post-Quantum Cryptography (PQC) keys on secure elements.
*Provides methods for deriving PQC key seeds into full PQC keys using deterministic
*algorithms specified by immutable parameters.
*/
public interface PQCKeyManagementAPI {
/**
*Status word indicating successful operation
*/
public static final short SW_SUCCESS=(short) 0x9000;
/**
*Status word indicating invalid key seed identifier
/**
public static final short SW_INVALID_SEED_ID=(short) 0x6A88;
/**
*Status word indicating insufficient memory for derivation
*/
public static final short SW_INSUFFICIENT_MEMORY=(short) 0x6A84;
/**
*Status word indicating unauthorized access attempt
*/
public static final short SW_UNATHORIZED=(short) 0x6982;
/**
*Derives a PQC key seed into a full PQC key using specified parameters.
*The derived key is stored in volatile memory with access controls.
*
*@param keySeedId Identifier of the stored PQC key seed
*@param paramsPtr Memory pointer to immutable PQC key parameters
*@param paramsOffset Offset of parameters data in memory
*@param paramsLength Length of parameters data
*@param derivedKeyRef Buffer to store reference to derived key
*@param derivedKeyRefOffset Offset in buffer for derived key reference
*@return Status word indicating operation result
*@throws SecurityException If the calling application lacks authorization
*/
public short derivePQCKey(
short keySeedId,
byte[ ] paramsPtr,
short paramsOffset,
short paramsLength,
byte[ ] derivedKeyRef,
short derivedKeyRefOffset );
/**
*Releases an derived PQC key from volatile memory.
*The original key seed remains stored in non-volatile memory.
*
*@param derivedKeyRef Reference to the derived key
*@return Status word indicating operation result
*/
public short releaseDerivedKey(byte[ ] derivedKeyRef);
/**
*Retrieves parameters associated with an derived PQC key.
*
*@param derivedKeyRef Reference to the derived key
*@param paramsBuffer Buffer to store retrieved parameters
*@param paramsOffset Offset in buffer for parameters
*@return Length of parameters data written to buffer
*/
public short getDerivedKeyParams(
byte[ ] derivedKeyRef,
byte[ ] prebuffer,
short paramsOffset
);
}

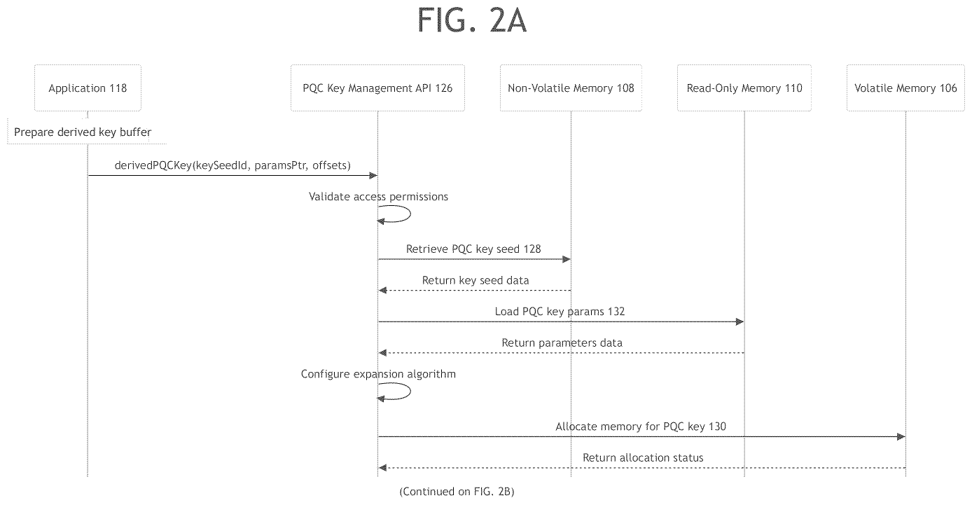

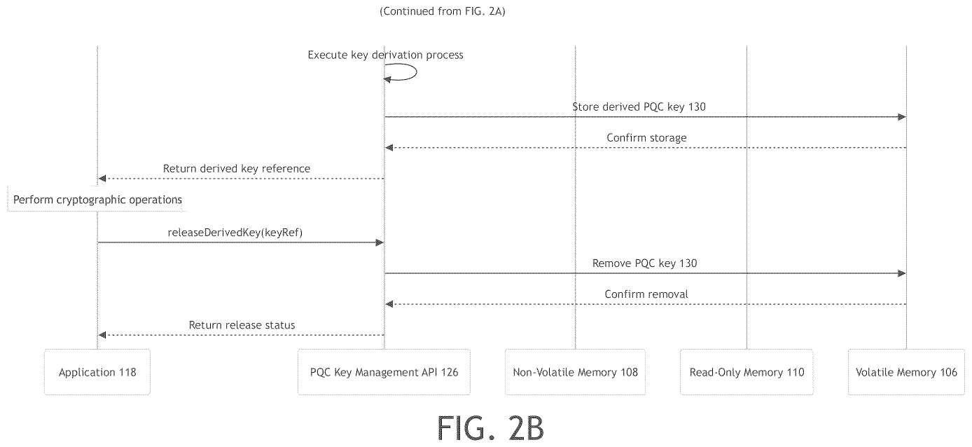

FIG. 2A and FIG. 2B illustrate an example of PQC key generation through seed derivation in accordance with one or more embodiments. The sequence diagram illustrates interactions between system components during PQC key derivation operations. The Application 118 initiates the sequence through derivePQCKey invocation. The PQC Key Management API 126 performs sequential operations: access validation, key seed retrieval from Non-Volatile Memory 108, parameter loading from ROM 110, and derived key storage in Volatile Memory 106.

Memory management operations occur through direct API interactions with respective memory components. The derivation process executes within the API context using retrieved seed data and parameters. The sequence concludes with key release operations, removing derived key data from volatile storage while preserving the original key seed.

Returning to the top of the example of FIG. 2A and FIG. 2B, the application 118 initiates interaction by preparing a byte array buffer to store the reference to an derived PQC key. The application 118 obtains a key seed identifier previously assigned during key seed generation and storage operations. A separate byte array references PQC key parameters 132 stored in ROM 110. The parameters specify configuration details, such as algorithm selection and key size requirements.

The application 118 invokes derivePQCKey through the PQC key management API 126, passing the key seed identifier and parameters pointer along with appropriate offset values. The API 126 validates access permissions for the calling application 118 against stored authorization records. Upon successful validation, the API 126 retrieves PQC key seed 128 from non-volatile memory 108 using the provided identifier.

The API 126 processes parameters 132 to configure the derivation algorithm. Memory allocation routines reserve space in volatile memory 106 sized according to the specified key length. The derivation process transforms PQC key seed 128 into PQC key 130 through deterministic operations defined by the algorithm parameters. The API 126 stores the generated PQC key 130 in the allocated volatile memory region.

After successful derivation, the API 126 writes a reference value into the application's buffer at the specified offset. The application 118 uses this reference to request cryptographic operations involving the derived key. Following completion of cryptographic processing, the application 118 calls releaseDerivedKey to free volatile memory resources. The API 126 removes PQC key 130 from volatile memory 106 while maintaining PQC key seed 128 in non-volatile storage for future derivation requests.

### 4.2 Key Object

One or more embodiments implement the PQC key management functionality through an object-oriented approach utilizing key objects. Applications interact with PQC keys through a KeyObject class that encapsulates the underlying key material and associated operations. The KeyObject provides an abstraction layer that shields applications from direct manipulation of key references and memory operations.

The KeyObject class exposes methods for key operations including derivation of the key material. Applications invoke KeyObject.derive() to trigger the deterministic derivation process. The derivation operation may occur explicitly through application calls or implicitly during cryptographic operations. When an application passes a KeyObject to cryptographic service objects, such as for digital signatures, the underlying implementation determines whether to perform automatic derivation of the key material.

In one or more embodiments, the following example illustrates object-oriented interactions for digital signature operations:
//Create signature object
SignatureObject signatureObj=new SignatureObject(algorithmID);
//Key object containing PQC key material
KeyObject keyObj=KeyObject.getInstance(keyIdentifier);
//Optional explicit derivation
keyObj.derive();
//Sign operation with key object
byte[ ] Signature=Signatureobj.sign(keyobj, Messagedata);

The SignatureObject accepts a KeyObject parameter rather than direct key material references. When the sign operation executes, the implementation verifies the derivation state of the provided KeyObject. If derivation has not occurred, the sign operation automatically triggers the key derivation process before proceeding with signature generation. This design enables flexible derivation timing while maintaining encapsulation of key management operations.

The object-oriented architecture supports multiple implementation approaches for key derivation timing. Applications may pre-emptively derive keys through explicit KeyObject method calls. Alternatively, cryptographic service objects can manage derivation timing based on operational requirements. The encapsulation of derivation logic within the KeyObject class ensures consistent derivation behavior regardless of the triggering mechanism.

Memory management operations occur transparently through the object lifecycle. Applications do not directly interact with the underlying memory storage or key references. The KeyObject implementation coordinates with the secure element memory subsystem to handle allocation and cleanup operations. This encapsulation simplifies application development while maintaining security boundaries around sensitive key material.

The object-oriented approach extends beyond signature operations to encompass other PQC key management interfaces described herein. The KeyObject class serves as a primary abstraction for encapsulating PQC key operations across multiple cryptographic services. Applications interact with encryption, key agreement, and other cryptographic functions through corresponding service objects that accept KeyObject parameters.

In one or more embodiments, the KeyObject instantiation process includes an import phase that occurs between instance creation and key derivation. After obtaining a KeyObject instance with a specified key identifier and memory type, applications import the key material before derivation operations can proceed. The import operation accepts a format parameter that determines how the system interprets the provided key data:
//Create key object instance
Keyobject keyobj=Keyobject.getInstance(keyIdentifier, memorytype);
//Import key material
keyObj.importKey(format, keyData);
//Optional explicit derivation with memory type specification keyObj.derive(memoryType);

The format parameter enables flexible handling of different key material representations. Depending on the specified format, the keyData parameter may contain either seed material for subsequent derivation or pre-derived key material. When importing seed material, the subsequent derive operation performs the complete derivation process. Alternatively, importing pre-derived key material allows direct use without additional derivation steps.

The memoryType parameter, present in both getInstance and derive operations, provides control over the memory subsystem allocation for both the initial key material and derived derivatives. This parameter enables applications to specify security and performance requirements for key material storage throughout the object lifecycle.

For encryption operations, applications construct an EncryptionObject instance configured with appropriate algorithm parameters. The EncryptionObject exposes encrypt and decrypt methods that accept KeyObject parameters. The underlying implementation manages key derivation timing based on operational requirements:
//Create encryption object
EncryptionObject encryptObj=new EncryptionObject(algorithmID);
//Key object containing PQC key material
KeyObject keyObj=KeyObject.getInstance(keyIdentifier);
// Encryption operation triggers derivation if needed
byte[ ] ciphertext=encryptObj.encrypt(keyObj, plaintext);

Key agreement protocols leverage KeyObject instances to represent both static and ephemeral keys. A KeyAgreementObject coordinates the protocol execution while maintaining encapsulation of key material through KeyObject parameters. The KeyAgreementObject implementation determines appropriate derivation timing for participating keys based on protocol requirements.

The KeyObject abstraction extends to key generation and storage operations. Applications request new key material through factory methods that return KeyObject instances. The KeyObject implementation coordinates with secure element services to generate and store key seeds while presenting a consistent interface to applications. Memory management occurs through standard object lifecycle mechanisms rather than explicit API calls.

This object-oriented design pattern promotes consistent key handling across cryptographic services while preserving security boundaries. Applications work with KeyObject instances without direct exposure to underlying key references or memory operations. The encapsulation of key management logic within service objects and the KeyObject class enables flexible implementation strategies while maintaining a standardized application interface.

In one or more embodiments, for encryption operations, applications construct an EncryptionObject instance configured with appropriate algorithm parameters. The EncryptionObject exposes encrypt and decrypt methods that accept KeyObject parameters. The underlying implementation manages key derivation timing based on operational requirements:
//Create encryption object
EncryptionObject encryptObj=new EncryptionObject(algorithmID);
//Create key object instance
KeyObject keyObj=KeyObject.getInstance(keyIdentifier, memoryType);
//Import key material
keyobj.importKey(format, Keydata);
//Encryption operation triggers derivation if needed
byte[ ] ciphertext=encryptObj.encrypt(keyObj, plaintext);

As with other cryptographic operations, the encryption workflow incorporates the key import phase between instance creation and operational use. The KeyObject. importKey operation prepares the key material for use in encryption operations, accepting either seed material or pre-derived keys based on the specified format parameter.

The encryption implementation automatically manages derivation timing when needed, while still allowing applications to explicitly control derivation through direct KeyObject method calls. This flexibility enables optimization of key derivation timing based on application-specific requirements while maintaining the standardized import-before-use pattern.

### 4.3 PQC Key Seed Import with Transaction Protection

In one or more embodiments, the PQC key management API 126 implements an importation method for securely transferring PQC key seed 128 data into non-volatile memory 108 of secure element 104. Applications 118 call this method by providing seed data and required parameters for secure storage. The API validates incoming seed data format and size compatibility with available non-volatile storage space. Memory management functions within the API allocate a protected region in non-volatile memory 108 for storing the PQC key seed 128. The allocation process ensures sufficient space while maintaining memory alignment requirements of the secure element hardware 104. Access control mechanisms establish security attributes for the allocated memory region to prevent unauthorized access. The API generates a unique identifier associated with the imported PQC key seed 128. Applications 118 receive this identifier for subsequent references to the stored seed in other API operations. The identifier-to-seed mapping persists in secure element 104 storage to support future key derivation operations. Security protocols in the API enforce encryption of the PQC key seed 128 during importation. The API implements integrity protection mechanisms to detect any tampering with seed data during transfer. Secure storage mechanisms in non-volatile memory 108 protect the imported seed against unauthorized modification or extraction. Transaction management features ensure atomic completion of seed importation operations. The API implements rollback procedures to handle failed import attempts while maintaining system stability. Error reporting mechanisms provide applications 118 with detailed status information about importation results.

In one or more embodiments, the following example interface of the PQC key management API 126 defines methods for secure importation of PQC key seeds:
package com.securelement.api;
/**
   *API interface for importing Post-Quantum Cryptography (PQC) key seeds into
   *secure element non-volatile memory. Implements secure transfer and storage
   *mechanisms with transaction management.
   */
public interface PQCKeySeedImportAPI {
   /**
      *Status word indicating successful importation
      */
   public static final short SW_IMPORT_SUCCESS=(short) 0x9000;
   /**
      *Status word indicating insufficient storage space
      */
   public static final short SW_INSUFFICIENT_SPACE=(short) 0x6A84;
   /**
      *Status word indicating invalid seed format
      */
   public static final short SW_INVALID_SEED=(short) 0x6A80;
   /**
      *Status word indicating encryption failure
      */
   public static final short SW_ENCRYPTION_ERROR=(short) 0x6988;
   /**
      *Status word indicating transaction error
      */
   public static final short SW_TRANSACTION_ERROR=(short) 0x6985;
   /**
      *Imports encrypted PQC key seed data into non-volatile memory with
      *integrity protection and access controls.
      *
      *@param seedData Buffer including encrypted seed data
      *@param seedOffset Offset of seed data in buffer
      *@param seedLength Length of seed data
      *@param params Import parameters (encryption, access control)
      *@param paramsOffset Offset of parameters in buffer
      *@param paramsLength Length of parameters data
      *@param seedId Buffer to receive generated seed identifier
      *@param seedIdOffset Offset for seed identifier in buffer
      *@return Status word indicating import result
      *@throws SecurityException If encryption or access validation fails
      */
   public short importPQCKeySeed(
      byte[ ] seedData,
      short seedOffset,
      short seedLength,
      byte[ ] params,
      short paramsOffset,
      short paramsLength,
      byte[ ] seedId,
      short seedIdOffset
   );
   /**
      *Verifies integrity of stored PQC key seed data.
      *
      *@param seedId Identifier of stored key seed
      *@return Status word indicating verification result
      */
   public short verifyKeySeedIntegrity(byte[ ] seedId);
   /**
      *Retrieves import parameters associated with stored key seed.
      *@param seedId Identifier of stored key seed
      *@param paramsBuffer Buffer to receive parameters
      *@param paramsOffset Offset in parameters buffer
      *@return Length of parameters data written
      */
   public short getKeySeedParams(
      byte[ ] seedId,
      byte[ ] paramsBuffer,
      short paramsOffset
   );
   /**
      *Removes imported key seed data and associated parameters.
      *
      *@param seedId Identifier of key seed to remove
      *@return Status word indicating removal result
      */
   public short removeKeySeed(byte[ ] seedId);
}

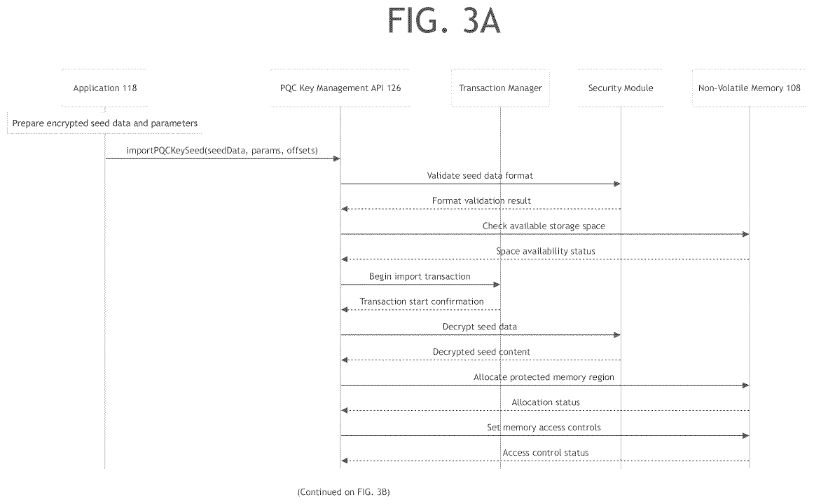

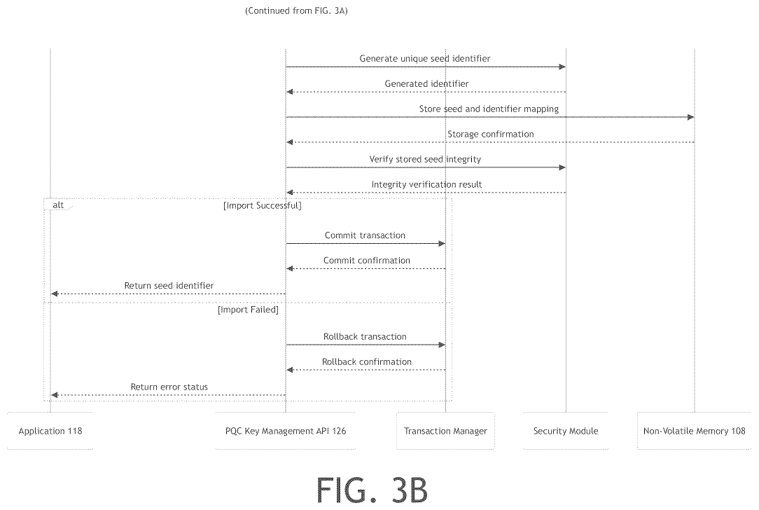

FIG. 3A and FIG. 3B illustrate an example of PQC key seed import with transaction protection in accordance with one or more embodiments. The sequence diagram illustrates secure importation of PQC key seed data through coordinated component interactions. The application 118 begins by invoking importPQCKeySeed with encrypted seed data and storage parameters. The PQC Key Management API 126 coordinates validation, security, and storage operations through dedicated system modules.

The Security Module performs data format validation and decryption operations. The Transaction Manager ensures atomic completion of import operations with rollback capability. Memory management operations execute through direct API interactions with Non-Volatile Memory 108, including space verification, protected region allocation, and access control configuration.

The sequence incorporates integrity verification steps before transaction completion. Successful operations result in returning a generated seed identifier to the application. Failed operations trigger transaction rollback procedures with appropriate error status reporting. The transaction-protected approach maintains system stability during import operations.

Returning to the top of the example of FIG. 3A and FIG. 3B, the application 118 begins by preparing encrypted PQC key seed data in a byte array buffer. A separate parameters buffer specifies encryption details, access control requirements, and memory allocation preferences for secure storage. The application 118 allocates an additional buffer to receive the generated seed identifier that will reference the imported seed data.

The application 118 invokes importPQCKeySeed through the PQC key management API 126, providing the encrypted seed data buffer, parameters buffer, and identifier buffer along with corresponding offset values. The API 126 decrypts the seed data using secure element cryptographic functions. Memory management routines within the API 126 calculate required storage space and verify availability in non-volatile memory 108. Upon successful validation, the API 126 initiates a JAVA CARD transaction to ensure atomic completion of the import operation.

Protected memory allocation creates a dedicated region in non-volatile memory 108 for storing the decrypted PQC key seed 128. The API 126 establishes access control attributes for the allocated memory region based on specified parameters. A unique identifier generation routine creates a reference value for the imported seed. The API 126 stores this identifier-to-seed mapping in a protected area of non-volatile memory 108.

Following successful storage operations, the API 126 writes the generated identifier into the application's buffer at the specified offset. The application 118 stores this identifier for future derivation requests through the PQC key management API 126. The application 118 may optionally call verifyKeySeedIntegrity to confirm successful importation. Upon completing seed usage, the application 118 can invoke removeKeySeed to securely delete the key seed.

### 4.4 PQC Derived Key Import with Memory Selection

In one or more embodiments, the PQC key management API 126 implements direct importation methods for derived PQC keys into either non-volatile memory 108 or volatile memory 106 of secure element 104. Applications 118 invoke these methods by specifying the target memory type and providing the derived key data along with required storage parameters. Memory management functions analyze the incoming key size and available storage space to determine placement feasibility. For importation to non-volatile memory 108, the API allocates a protected storage region sized to accommodate the derived PQC key. The allocation maintains alignment requirements specific to the secure element hardware 104 while preserving existing data structures. The API generates and returns a persistent identifier linked to the stored key location, enabling applications 118 to reference the imported key in subsequent operations. Volatile memory importation follows similar validation steps but implements temporary storage mechanisms. The API allocates protected regions in volatile memory 106 with appropriate access controls and memory boundaries. Applications 118 receive a session-specific identifier for referencing the imported key during cryptographic operations within the current execution context. Security mechanisms enforce encryption of derived keys during the import process. The API implements integrity verification to detect data tampering during transfer operations. Access control systems prevent unauthorized modification or extraction of imported keys from both volatile and non-volatile storage locations. Transaction management features ensure complete key importation or proper error handling. The API executes atomic operations with rollback capabilities for failed imports. Status reporting mechanisms communicate detailed results to applications 118, including success confirmation or specific error conditions encountered during importation.

In one or more embodiments, the following example interface of the PQC key management API 126 defines methods enabling direct importation of derived PQC keys into secure element memory:
package com.securelement.api;
/**
   *API interface for importing derived Post-Quantum Cryptography (PQC) keys into
   *secure element memory. Supports both volatile and non-volatile storage with
   *memory-specific security controls and reference management.
   */
public interface PQCDerivedKeyImportAPI {
   /**
      *Memory type indicators for import operations
      */
   public static final byte MEMORY_TYPE_VOLATILE=0x00;
   public static final byte MEMORY_TYPE_NON_VOLATILE=0x01;
   /**
      *Status words for operation results
      */
   public static final short SW_IMPORT_SUCCESS=(short) 0x9000;
   public static final short SW_INSUFFICIENT_SPACE=(short) 0x6A84;
   public static final short SW_INVALID_KEY=(short) 0x6A80;
   public static final short SW_ENCRYPTION_ERROR=(short) 0x6988;
   public static final short SW_TRANSACTION_ERROR=(short) 0x6985;
   public static final short SW_INVALID_MEMORY_TYPE=(short) 0x6A86;
   /**
      *Imports an derived PQC key into specified memory type with encryption
      *and integrity protection.
      *
      *@param memoryType Target memory type (volatile/non-volatile)
      *@param keyData Buffer including encrypted derived key
      *@param keyOffset Offset of key data in buffer
      *@param keyLength Length of key data
      *@param params Import parameters for storage configuration
      *@param paramsOffset Offset of parameters in buffer
      *@param paramsLength Length of parameters data
      *@param keyId Buffer to receive generated key identifier
      *@param keyIdOffset Offset for key identifier in buffer
      *@return Status word indicating import result
      *@throws SecurityException If encryption or access validation fails
      */
   public short importDerivedKey(
      byte memoryType,
      byte[ ] keyData,
      short keyOffset,
      short keyLength,
      byte[ ] params,
      short paramsOffset,
      short paramsLength,
      byte[ ] keyId,
      short keyIdOffset
   );
   /**
      *Verifies integrity of stored derived key.
      *
      *@param keyId Identifier of stored derived key
      *@return Status word indicating verification result
      */
   public short verifyDerivedKeyIntegrity(byte[ ] keyId);
   /**
      *Retrieves storage parameters for imported derived key.
      *
      *@param keyId Identifier of stored derived key
      *@param paramsBuffer Buffer to receive parameters
      *@param paramsOffset Offset in parameters buffer
      *@return Length of parameters data written
      */
   public short getDerivedKeyStorageParams(
      byte[ ] keyId,
      byte[ ] paramsBuffer,
      short paramsOffset
   );
   /**
      *Removes imported derived key from storage.
      *
      *@param keyId Identifier of derived key to remove
      *@return Status word indicating removal result
      */
   public short removeDerivedKey(byte[ ] keyId);
   /**
      *Checks if derived key identifier references volatile storage.
      *
      *@param keyId Identifier to check
      *@return True if key stored in volatile memory
      */
   public boolean isVolatileKey(byte[ ] keyId);
}

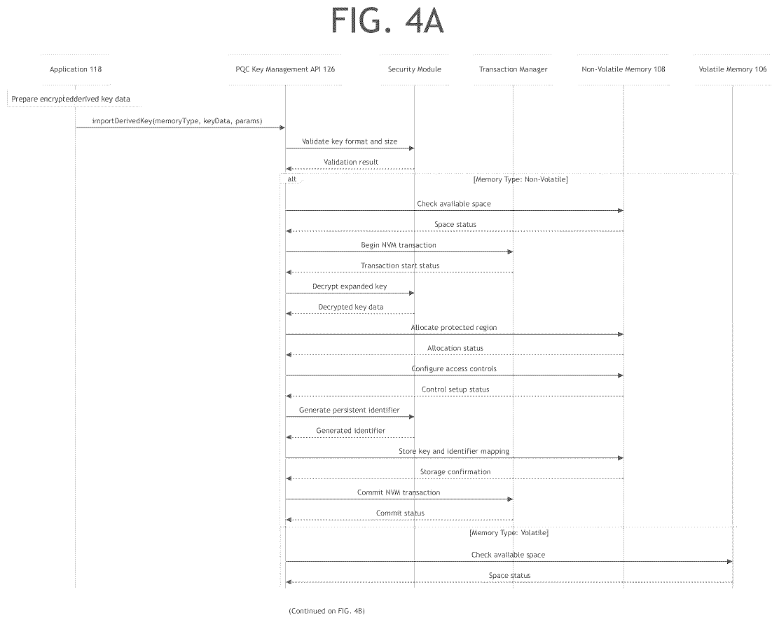

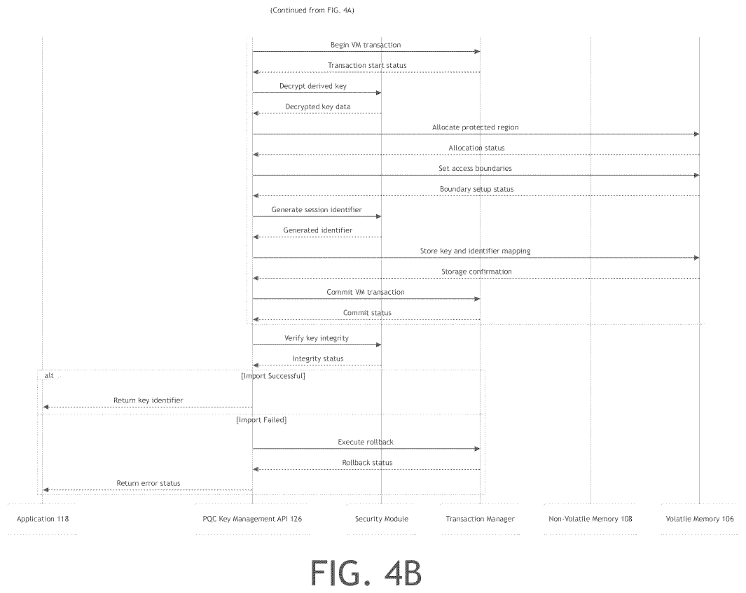

FIG. 4A and FIG. 4B illustrate an example of PQC derived key import with memory selection in accordance with one or more embodiments. The sequence diagram demonstrates interactions for importing derived PQC keys into secure element memory. The application 118 invokes importDerivedKey with memory type selection and encrypted key data. The PQC Key Management API 126 coordinates operations through multiple system components based on the selected memory type. For non-volatile storage, the sequence includes persistent identifier generation and enhanced access controls. Volatile storage operations implement session-specific identifiers and temporary protection mechanisms. Both paths incorporate transaction management for atomic operations.

The Security Module handles encryption, validation, and integrity verification. The Transaction Manager ensures operation atomicity with rollback capabilities. Memory management executes through distinct interactions with Non-Volatile Memory 108 or Volatile Memory 106 components.

The sequence concludes with integrity verification before completing or rolling back the transaction. Successful operations return appropriate identifiers for subsequent key references. Failed operations trigger comprehensive rollback procedures with detailed status reporting.

Returning to the top of the example of FIG. 4A and FIG. 4B, the application 118 initiates derived key importation by preparing a buffer including encrypted PQC key 130 data. A separate parameters buffer specifies security requirements and storage preferences. The application 118 selects MEMORY_TYPE_VOLATILE for temporary key storage in volatile memory 106, suitable for immediate cryptographic operations.

The application 118 calls importDerivedKey through the PQC key management API 126, providing memory type selection, encrypted key data, and storage parameters. The API 126 processes the encrypted key data using secure element cryptographic functions. Memory management routines analyze volatile memory 106 capacity to ensure sufficient space exists for the derived key. The API 126 starts a transaction to maintain atomic operation guarantees during the import process.

Memory allocation functions create a protected region in volatile memory 106 sized according to the derived key length. The API 126 configures access control attributes based on provided parameters to restrict key usage to authorized operations. A session-specific identifier generation routine creates a reference value for the imported PQC key 130. The API 126 maintains identifier-to-key mapping within protected memory structures of the secure element 104.

The API 126 writes the generated session identifier into the application's buffer at the specified offset position. The application 118 retains this identifier for referencing the imported key during subsequent cryptographic operations. The application 118 may verify successful importation through verifyDerivedKeyIntegrity. Upon completing key usage, the application 118 invokes removeDerivedKey to securely delete the imported PQC key 130 from volatile memory 106, freeing memory resources while maintaining security requirements.

In one or more embodiments, the PQC key management API 126 implements an object-oriented approach for managing derived keys through Key Objects. The Key Objects encapsulate the complete state and behavior of imported PQC keys, providing a higher-level abstraction above the underlying memory management operations. Applications 118 interact with these Key Objects through well-defined methods rather than directly manipulating memory identifiers or raw key data.

The KeyBuilder class serves as the primary factory for creating and importing Key Objects. The importDerivedKey method of KeyBuilder accepts configuration parameters, memory type selection, and derived key data to construct appropriate Key Objects. These Key Objects maintain internal references to the secure element memory locations while exposing a clean object-oriented interface to applications 118.

In one or more embodiments, the following example interface demonstrates the object-oriented structure for PQC key management:
package com.securelement.api;
/**
   *Factory class for creating and importing PQC Key Objects
   */
public class KeyBuilder {
   /**
      *Creates a Key Object from derived key data
      *
      *@param params Configuration parameters for key storage
      *@param memoryType Target memory type selection
      *@param derivedKeyBuffer Buffer containing derived key data
      *@return Key Object representing the imported key
      *@throws SecurityException If import validation fails
      */
   public static Key importDerivedKey(
      KeyParams params,
      byte memoryType,
      byte[ ] derivedKeyBuffer
   );
}
/**
   *Interface representing an imported PQC key
   */
public interface Key {
   /**
      *Verifies the integrity of the key
      *@return true if verification succeeds
      */
   public boolean verifyintegrity();
   /**
      *Retrieves the storage parameters for this key
      *@return KeyParams object containing storage configuration
      */
   public KeyParams getStorageParams();
   /**
      *Removes the key from secure element memory
      */
   public void remove();
   /**
      *Checks if key is stored in volatile memory
      *@return true if key uses volatile storage
      */
   public boolean isVolatile();
}

The object-oriented design patterns implemented by the PQC key management API 126 provide enhanced security through information hiding and encapsulation. Key Objects restrict direct access to memory locations and key material while exposing operations through method interfaces. The factory pattern implemented by KeyBuilder ensures proper initialization and configuration of Key Objects according to security requirements.

Applications 118 use the KeyBuilder class to create Key Objects representing imported PQC keys in either volatile memory 106 or non-volatile memory 108. The KeyBuilder. importDerivedKey method internally manages memory allocation, access control configuration, and secure storage of the derived key material. The returned Key Object provides applications 118 with a reference to the imported key for subsequent cryptographic operations.

Memory type selection influences the lifecycle and persistence of created Key Objects. Key Objects referencing volatile memory 106 maintain temporary session state, while Key Objects linked to non-volatile memory 108 represent persistent key material. The Key interface methods enable applications 118 to verify integrity, inspect storage parameters, and manage key lifecycle regardless of the underlying memory type.

Security mechanisms within the object-oriented implementation enforce proper key destruction through the remove() method. The PQC key management API 126 ensures secure deletion of key material and cleanup of associated memory regions when Key Objects are removed. The isVolatile() method allows applications 118 to determine the storage characteristics of Key Objects without exposing internal memory details.

In one or more embodiments, the KeyBuilder class supports multiple formats for key import operations. A first format accepts derived key material, where the complete derived key data may be provided either as a single buffer or as multiple sequential chunks. When importing derived format keys in chunks, the KeyBuilder maintains an internal state to accumulate and validate the key material across multiple import operations.

A second supported format enables key import using condensed representation, where a seed value serves as the basis for key generation. The condensed format reduces data transfer requirements during key import operations. The following interface extension demonstrates the additional key import methods:
public class KeyBuilder {
   /**
      *Creates a Key Object from a chunk of derived key data
      *
      *@param params Configuration parameters for key storage
      *@param memoryType Target memory type selection
      *@param keyChunk Current chunk of derived key data
      *@param chunkOffset Offset of current chunk in complete key
      *@param isFinal Indicates if this is the final chunk
      *@return Key Object representing the imported key
      *@throws SecurityException If chunk validation fails
      */
   public static Key importDerivedKeyChunk(
      KeyParams params,
      byte memoryType,
      byte[ ] keyChunk,
      int chunkOffset,
      boolean isFinal
   );
   /**
      *Creates a Key Object from a condensed seed value
      *
      *@param params Configuration parameters for key storage
      *@param memoryType Target memory type selection
      *@param seedBuffer Buffer containing the seed value
      *@return Key Object representing the generated key
      *@throws SecurityException If seed validation fails
      */
   public static Key importCondensedKey(
      KeyParams params,
      byte memoryType,
      byte[ ] seedBuffer
   );
}

The importDerivedKeyChunk method enables applications to transfer large derived keys in manageable portions. The method tracks the assembly of complete key material through the chunkOffset parameter and completes key construction when receiving the final chunk. Internal validation ensures consistency across chunks before creating the Key Object.

The importCondensedKey method accepts a seed value and performs deterministic key derivation within the secure environment. The method applies appropriate key derivation functions to generate the complete key material from the provided seed. Memory allocation and access controls are configured based on the specified parameters during the key generation process.

In one or more embodiments, a unified import method in the KeyBuilder class handles multiple key format types through a single interface. The following implementation demonstrates the consolidated key import functionality:
public class KeyBuilder {
   /**
      *Key format identifiers
      */
   public static final byte FORMAT_DERIVED=0x01;
   public static final byte FORMAT_CONDENSED=0x02;
   /**
      *Creates a Key Object from key data in specified format
      *
      *169 param format Format identifier for key data interpretation
      *@param memoryType Target memory type selection
      *@param keyData Buffer containing key material
      *@return Key Object representing the imported key
      *@throws SecurityException If import validation fails
      */
   public static Key importKey(
      byte format,
      byte memoryType,
      byte[ ] keyData
   );
}

The format parameter determines the interpretation and processing of the provided key material. When FORMAT_DERIVED is specified, the keyData parameter contains complete derived key material. When FORMAT_CONDENSED is specified, the keyData parameter contains a seed value for key generation. The unified method encapsulates format-specific validation and processing logic while maintaining consistent memory management behaviors.

The importKey method performs format-specific validation of the keyData buffer length and content. For derived format keys, the method validates the complete key structure. For condensed format keys, the method validates the seed value and executes internal key derivation operations. Memory allocation proceeds according to the resulting key material size rather than the input buffer size when processing condensed formats.

Applications specify the desired key format through the format parameter, enabling flexible key provisioning while abstracting format-specific processing details. The unified interface reduces implementation complexity while maintaining distinct security properties for different key formats. Memory type selection and configuration parameters continue to control key storage characteristics independent of the import format.

### 4.5 Streaming Protocol for PQC Key Import

In one or more embodiments, the PQC key management API 126 implements a streaming protocol for importing derived PQC keys through an init-update-doFinal session paradigm. The application 118 initiates a streaming session by calling an initialization method that establishes session parameters and prepares memory structures for receiving key data. Session parameters specify the target storage location, either volatile memory 106 or non-volatile memory 108. The update phase enables transfer of key data in manageable chunks through protocol buffers. Applications 118 make sequential update calls, passing chunks of the derived PQC key data. The API 126 processes incoming chunks directly into the target memory location without allocating intermediate storage buffers. Protocol buffer mechanisms provide efficient data transfer while maintaining memory constraints of the secure element 104. Memory management during streaming operates on a fixed-size buffer scheme. The API 126 processes received chunks within the protocol buffer size limitations. Direct streaming to the target memory location eliminates the need for additional memory allocation beyond protocol buffer requirements. This streaming approach enables handling of large PQC keys within resource-constrained environments. The doFinal phase completes key importation and finalizes memory storage. The API 126 performs integrity verification on the complete key data and establishes access control attributes. Applications 118 receive a reference identifier for the imported key upon successful session completion. Session resources are released after key storage finalization. Security mechanisms maintain data protection throughout the streaming process. The API 126 implements chunk-level validation and enforces secure transfer protocols. Error handling procedures address failures at any phase of the streaming session. Recovery mechanisms ensure proper cleanup of partial imports and maintain system stability.

In one or more embodiments, the following example interface of the PQC key management API 126 defines methods implementing a streaming protocol for importing PQC keys through an init-update-doFinal paradigm:
package com.se.api.pqc;
/**
   *Interface defining streaming protocol operations for importing Post-Quantum Cryptography (PQC) keys
   *on resource-constrained secure elements.
   */
public interface PQCKeyImport {
   /**
      *Storage location flags for imported PQC keys.
      */
   public static final byte STORAGE_VOLATILE=0x00;
   public static final byte STORAGE_NON_VOLATILE=0x01;
   /**
      *Status codes for streaming operations.
      */
   public static final short STATUS_SUCCESS=0x0000;
   public static final short STATUS_INVALID_PARAMS=0x6A80;
   public static final short STATUS_BUFFER_FULL=0x6A84;
   public static final short STATUS_INVALID_STATE=0x6985;
   public static final short STATUS_SECURITY_ERROR=0x6982;
   /**
      *Initializes a streaming session for PQC key import.
      *@param keyType type identifier for the PQC key algorithm
      *@param keySize size of the complete PQC key in bytes
      *@param storageLocation target storage location (STORAGE_VOLATILE or STORAGE_NON_VOLATILE)
      *@param buffer protocol buffer for receiving key data chunks
      *@param offset starting offset in the buffer
      *@param length length of initialization data
      *@return status code indicating operation result
      /
   public short initImport(byte keyType, short keySize, byte storageLocation, byte[ ] buffer, short offset, short length);
   /**
      *Updates the streaming session with a chunk of key data.
      *@param buffer protocol buffer including key data chunk
      *@param offset starting offset in the buffer
      *@param length length of key data chunk
      *@return number of bytes processed from the chunk
      *@throws SecurityException if data integrity validation fails
      */
   public short update(byte[ ] buffer, short offset, short length);
   /**
      *Completes the key import streaming session.
      *@param buffer protocol buffer including final key data chunk
      *@param offset starting offset in the buffer
      *@param length length of final chunk
      *@return reference identifier for the imported key
      *@throws SecurityException if final validation fails
      */
   public short doFinal(byte[ ] buffer, short offset, short length);
   /**
      *Aborts the current streaming session and releases resources.
      *Partial key data is securely cleared from memory.
      */
   public void abort();
   /**
      *Retrieves the maximum supported chunk size for update operations.
      *@return maximum chunk size in bytes
      */
   public short getMaxUpdateSize();
   /**
      *Checks if a streaming session is currently active.
      *@return true if a session is active, false otherwise
      */
   public boolean isSessionactive();
}

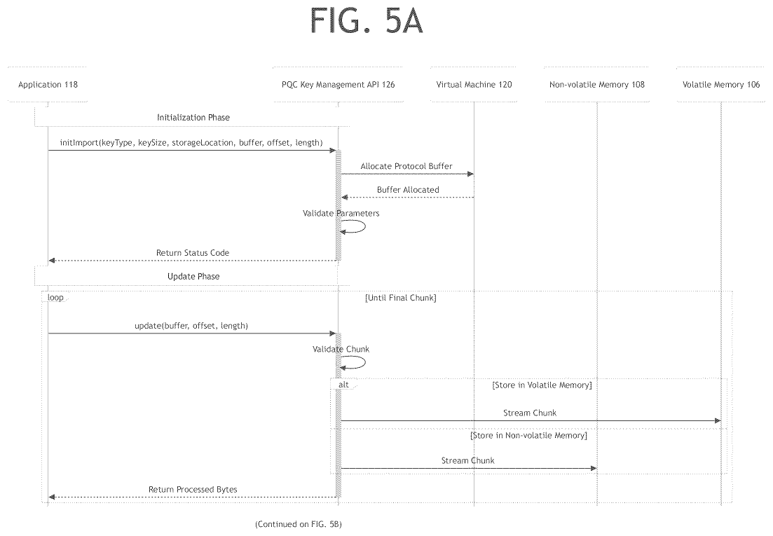

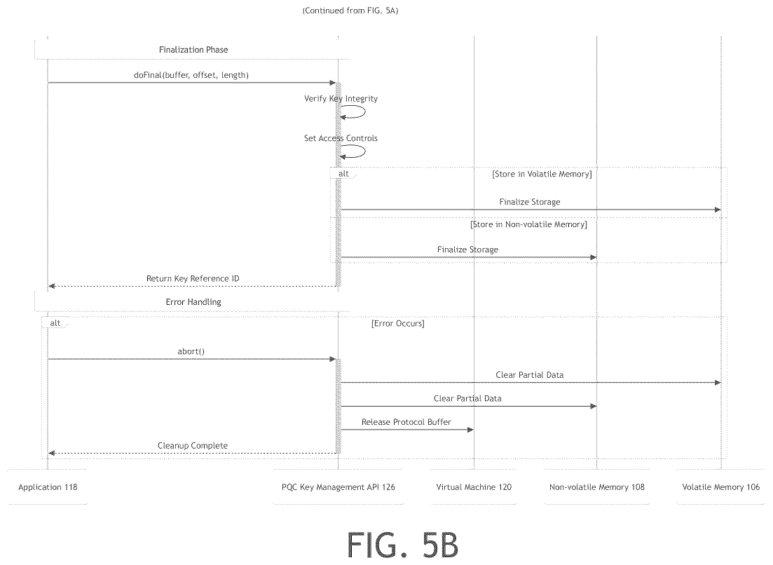

FIG. 5A and FIG. 5B illustrate an example of a streaming protocol for PQC key import to secure elements in accordance with one or more embodiments. The sequence diagram depicts interactions between the application 118 and PQC key management API 126 during key importation. The streaming protocol includes three primary phases: initialization, update, and finalization.

The initialization phase begins when the Application 118 calls initImport with parameters defining key characteristics and storage location. The API allocates a protocol buffer through the virtual machine 120 and validates session parameters.

During the update phase, the application 118 transmits key data chunks through sequential update calls. The API performs chunk-level validation before streaming data directly to the specified memory location. The storage destination varies based on initialization parameters, targeting either volatile memory 106 or non-volatile memory 108.

The finalization phase commences when the application 118 invokes doFinal with remaining key data. The API verifies integrity across received chunks and establishes access control attributes. Upon successful completion, the API returns a reference identifier for subsequent key usage.

Error handling mechanisms span phases. When errors occur, the application 118 initiates cleanup by calling abort. The API releases protocol buffers and removes partial key data from both memory locations. These recovery procedures maintain system stability during failed import operations.

The streaming protocol enables efficient transfer of large PQC keys while operating within secure element memory constraints. Direct streaming to target memory locations eliminates intermediate buffer requirements. Protocol buffer mechanisms enforce size limitations and chunk-level validation throughout the import process.

Returning to the top of the example of FIG. 5A and FIG. 5B, the application first determines the complete size of a ML-KEM-1024 public key requiring import, which spans 1568 bytes. Based on protocol buffer constraints of the secure element, the application plans to transfer the key data in 256-byte chunks.

The application initiates the streaming session by calling initImport with parameters specifying the ML-KEM-1024 algorithm type (0x42), key size (1568), and storage location (STORAGE_VOLATILE). The application passes an initial buffer including header metadata for the public key. The API validates the parameters and allocates a dedicated protocol buffer sized to accommodate incoming 256-byte chunks.

After successful initialization, the application enters the update phase. The application reads the first 256-byte chunk of key data from an external source into the protocol buffer. The application invokes the update method, passing the buffer including key data. The API processes the chunk directly into volatile memory without intermediate copying. The application continues sending subsequent chunks through repeated update calls. For any given chunk, the API returns the number of bytes successfully processed. The application tracks progress until transferring all but the final chunk.

When reaching the final 40 bytes of key data, the application calls doFinal with the remaining buffer content. The API validates integrity across all received chunks and finalizes key storage in volatile memory. Upon successful completion, the API returns a 16-bit reference identifier (e.g., 0x7B32) to the application. The application stores this identifier for subsequent cryptographic operations using the imported key.

If errors occur during any phase, such as integrity validation failures or buffer overflow conditions, the API returns appropriate status codes (e.g., STATUS_SECURITY_ERROR, STATUS_BUFFER_FULL). The application implements error handling by checking status codes after an operation. For unrecoverable errors, the application calls abort to terminate the session and release resources. The API ensures secure cleanup of any partially imported key material.

Through this streaming interaction pattern, the application successfully imports large PQC keys while working within memory constraints of the secure element. The protocol buffer mechanism eliminates the need for the application to manage complex memory allocation. Security validations integrated throughout the streaming process maintain data protection.

### 4.6 Protected PQC Key Import

In one or more embodiments, the PQC key management API 126 accepts encrypted data during import operations for both PQC key seeds 128 and derived PQC keys 130. The encryption layer provides confidentiality protection during transfer of key material from applications 118 to secure element storage. Applications 118 submit encrypted key data along with necessary cryptographic parameters for decryption. The API 126 implements decryption functionality within the secure element environment prior to storing imported keys. Decryption operations execute in protected memory regions of the secure element 104, maintaining confidentiality of key material throughout the import process. The decryption mechanisms support various encryption algorithms and modes specified through API parameters. Memory management functions allocate temporary space in volatile memory 106 for decryption operations. The API 126 processes encrypted data through streaming mechanisms to minimize memory requirements. Decrypted key material transfers directly to target storage locations in either volatile memory 106 or non-volatile memory 108. Access control mechanisms restrict decryption capabilities to authorized applications 118. The API 126 validates application privileges before permitting encrypted import operations. Security protocols ensure complete erasure of intermediate decrypted data from volatile memory 106 after successful storage of imported keys. Transaction management features handle atomic completion of encrypted import operations. The API 126 implements rollback procedures for failed imports to maintain system consistency. Status reporting mechanisms communicate decryption results and storage confirmations to applications 118. Error handling protocols address decryption failures while preserving security of encrypted key material.

In one or more embodiments, the following example interface of the PQC key management API 126 defines methods implementing encrypted key import functionality:
package com.securityapi.pqc;
import javacard.framework.*;
import javacard.security.*;
/**
   *Interface defining encrypted PQC key import operations for secure elements.
   *Supports both key seeds and derived keys with configurable encryption parameters.
   */
public interface PQCKeyImport {
   //Constants for encryption algorithms
   public static final byte ALG_AES_CBC=(byte) 0x01;
   public static final byte ALG_AES_GCM=(byte) 0x02;
   //Status codes for import operations
   public static final short SW_DECRYPTION_FAILED=(short) 0x6A80;
   public static final short SW_INVALID_KEY_TYPE=(short) 0x6A81;
   public static final short SW_INSUFFICIENT_MEMORY=(short) 0x6A84;
   public static final short SW_SECURITY_CONDITIONS_NOT_SATISFIED=(short) 0x6982;
   /**
      *Imports an encrypted PQC key seed using specified encryption parameters.
      *@param encryptedData buffer including encrypted key seed
      *@param encOffset starting offset of encrypted data
      *@param encLength length of encrypted data
      *@param algorithm encryption algorithm used (ALG_AES_CBC or ALG_AES_GCM)
      *@param decryptKey key handle for decryption
      *@param iv initialization vector buffer
      *@param ivOffset starting offset of IV
      *@param ivLength length of IV
      *@param keyId identifier for storing imported seed
      *@return status word indicating operation result
      *@throws CryptoException if decryption fails
      *@throws SystemException if memory allocation fails
      */
   public short importEncryptedKeySeed(
      byte[ ] encryptedData, short encOffset, short encLength,
      byte algorithm,
      Object decryptKey,
      byte[ ] iv, short ivOffset, short ivLength,
      short keyId
   );
   /**
      *Imports an encrypted derived PQC key for temporary usage.
      *@param encryptedData buffer including encrypted derived key
      *@param encOffset starting offset of encrypted data
      *@param encLength length of encrypted data
      *@param algorithm encryption algorithm used
      *@param decryptKey key handle for decryption
      *@param iv initialization vector buffer
      *@param ivOffset starting offset of IV
      *@param ivLength length of IV
      *@param keyType type of PQC key being imported
      *@return handle to imported key or negative error code
      *@throws CryptoException if decryption fails
      *@throws SystemException if memory allocation fails
      */
   public short importEncryptedDerivedKey(
      byte[ ] encryptedData, short encOffset, short encLength,
      byte algorithm,
      Object decryptKey,
      byte[ ] iv, short ivOffset, short ivLength,
      byte keyType
   );
   /**
      *Begins a streaming encrypted key import operation.
      *@param totalLength total length of encrypted data to be imported
      *@param algorithm encryption algorithm used
      *@param decryptKey key handle for decryption
      *@param iv initialization vector buffer
      *@param ivOffset starting offset of IV
      *@param ivLength length of IV
      *@param isKeySeed true if importing key seed, false for derived key
      *@param keyId identifier for key seed or key type for derived key
      *@return transaction handle or negative error code
      */
   public short beginStreamingKeyImport(
      short totalLength,
      byte algorithm,
      Object decryptKey,
      byte[ ] iv, short ivOffset, short ivLength,
      boolean isKeySeed,
      short keyId
   );
   /**
      *Processes a chunk of encrypted key data in streaming mode.
      *@param chunk buffer including chunk of encrypted data
      *@param offset starting offset in chunk buffer
      *@param length length of chunk data
      *@param transactionHandle handle from beginStreamingKeyImport
      *@return status word indicating chunk processing result
      */
   public short processKeyImportChunk(
      byte[ ] chunk, short offset, short length,
      short transactionHandle
   );
   /**
      *Completes a streaming key import operation.
      *@param transactionHandle handle from beginStreamingKeyImport
      *@return handle to imported key or status word for key seed
      */
   public short finalizeKeyImport(short transactionHandle);
   /**
      *Aborts a streaming key import operation and rolls back changes.
      *@param transactionHandle handle from beginStreamingKeyImport
      */
   public void abortkeyimport(short transactionHandle);
   /**
      *Retrieves status information about the last import operation.
      *@param statusBuffer buffer to receive status information
      *@param offset starting offset in status buffer
      *@return length of status information written
      */
   public short getLastImportStatus(byte[ ] statusBuffer, short offset);
}

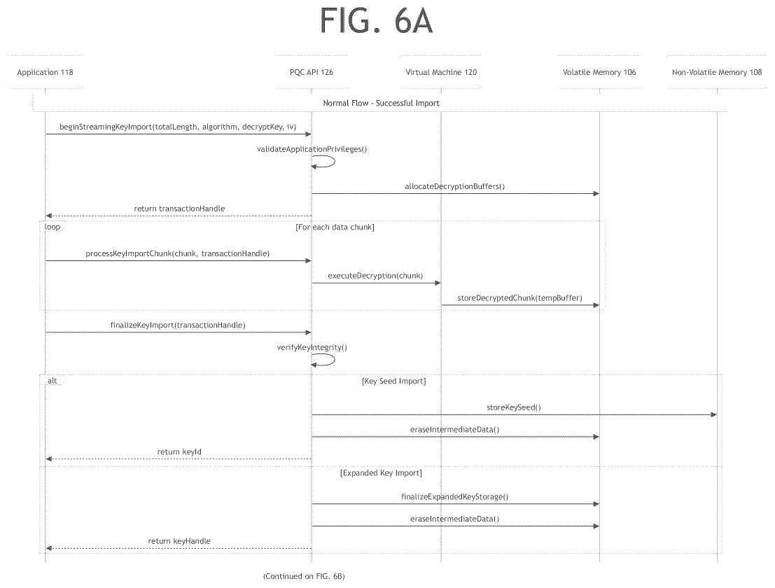

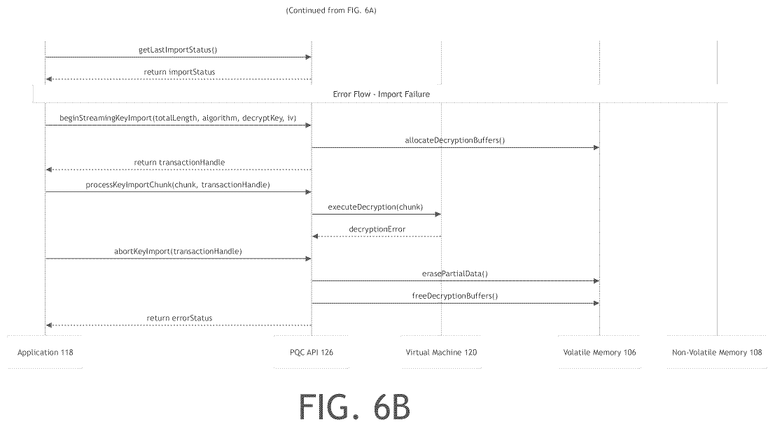

FIG. 6A and FIG. 6B illustrate an example of a secure element API for protected PQC key import in accordance with one or more embodiments. The interaction diagram illustrates two primary flows for encrypted key import operations, Successful Import Flow and Error Handling Flow.

The sequence begins when an application initiates a streaming import by calling beginStreamingKeyImport(). The API validates application privileges and allocates decryption buffers. A transaction handle returns to the application for subsequent operations. The application transmits encrypted data chunks through processKeyImportChunk() calls. The virtual machine executes decryption operations in protected memory regions. Decrypted chunks transfer to temporary volatile memory storage. Upon receiving the final chunk, the application invokes finalizeKeyImport(). The API verifies key integrity and stores the decrypted key material. For key seeds, storage occurs in non-volatile memory. For derived keys, storage remains in volatile memory. The API erases intermediate decryption data and returns appropriate handles to the application.

In one or more embodiments, the storage location configuration supports flexible deployment of key material across memory types. The API enables storing key seeds in volatile memory when heightened runtime security policies apply. Additionally, derived keys may reside in non-volatile memory when persistence requirements dictate longer-term storage. The memory storage assignment depends on system configuration parameters specified during initialization. These parameters control whether key seeds occupy volatile or non-volatile memory regions. The parameters also determine storage allocation for derived key material between volatile and non-volatile segments. The API validates memory placement requests against security policy requirements before executing storage operations.

Th error path demonstrates handling of decryption failures. When errors occur during chunk processing, the application calls abortKeyImport(). The API implements rollback procedures by erasing partial data and freeing allocated buffers. Error status information returns to the application through dedicated status reporting mechanisms.

Th interaction diagram of FIG. 6A and FIG. 6B emphasizes the separation between temporary decryption buffers in volatile memory and final key storage locations. Memory management operations maintain security by properly allocating and clearing sensitive data areas. Transaction management ensures atomic operations through consistent error handling and rollback procedures.

Returning to the top of the example of FIG. 6A and FIG. 6B, the application first prepares encrypted key material using AES-GCM encryption. The encrypted data comprises a ML-DSA signature verification key of 1344 bytes. The application transmits the encrypted key data in multiple chunks due to I/O buffer constraints of the secure element platform.

The application initiates the import operation by invoking beginStreamingKeyImport() on the PQC key management API. The method call specifies the total encrypted data length of 1344 bytes, the AES-GCM algorithm identifier, a reference to the decryption key stored in secure element memory, a 12-byte initialization vector, and a key type indicator for ML-DSA verification keys. The API validates the application's security privileges and allocates temporary decryption buffers in volatile memory. Upon successful initialization, the API returns a transaction handle to the application.

The application processes the encrypted key in 256-byte chunks. For a chunk, the application invokes processKeyImportChunk() with the chunk data and transaction handle. The API decrypts received chunks in the secure element's protected memory region. Decrypted key bytes transfer directly to a pre-allocated space in volatile memory. The API maintains a rolling hash of processed data for integrity verification.

After sending the final chunk, the application calls finalizeKeyImport() with the transaction handle. The API completes the decryption operation, verifies the authentication tag, and performs integrity checks on the assembled key material. The imported key undergoes validation to confirm compliance with ML-DSA verification key format requirements. Upon successful validation, the API stores the key in volatile memory and returns a key handle to the application.

The application can verify successful import completion by calling getLastImportStatus(). The status data includes the number of chunks processed, integrity check results, and memory locations of stored key material. The application uses the returned key handle to initiate subsequent signature verification operations through separate API methods.

If errors occur during the import sequence, the application invokes abortKeyImport() with the transaction handle. The API executes cleanup procedures to erase partial key material from memory and release allocated buffers. The transaction system ensures atomic operation by rolling back any incomplete storage operations.

The streaming import mechanism enables handling of large PQC keys while working within the secure element's memory constraints. The chunk-based processing minimizes volatile memory requirements by maintaining small working buffers. The API's transactional approach preserves system consistency even when import operations fail mid-sequence.

### 4.7 PQC Key Object Creation Through Parameter-Driven Storage Management

In one or more embodiments, the PQC key management API 126 implements a key object creation method through a structured parameter set. Applications 118 invoke creation by providing a parameter set identifier that references configuration data stored in ROM 110. The parameter set defines characteristics for the key object, including algorithm specifications and memory requirements. Format specification allows selection between condensed and derived key representations. Condensed formats utilize PQC key seeds 128, enabling storage in non-volatile memory 108 with reduced space requirements. Derived formats store complete PQC keys 130, supporting direct cryptographic operations without runtime derivation overhead. Memory type specification determines storage location for key data within secure element 104. Selection of volatile memory 106 suits temporary key usage scenarios, while non-volatile memory 108 provides persistent storage for long-term key availability. The API 126 validates memory availability and enforces alignment requirements based on the specified storage type. Object creation establishes necessary data structures and security attributes. The API 126 allocates memory regions according to format and type specifications, initializing access control mechanisms to protect key material. Applications 118 receive an object reference for subsequent operations on the created key structure. Memory management functions optimize resource utilization during object creation. The API 126 implements efficient allocation strategies based on specified formats and memory types. Format-specific handlers process key data according to condensation requirements, while memory-specific routines manage storage allocation within designated memory regions.

In one or more embodiments, the following example interface of the PQC key management API 126 defines methods implementing key object creation functionality using JAVA CARD's native types and conventions:
package com.security.pqc;
import javacard.framework.*;
import javacard.security.*;
/**
   *API interface for Post-Quantum Cryptography (PQC) key management operations
   *within secure element environments.
   */
public interface PQCKeyManagementInterface {
   //Key format constants
   public static final byte FORMAT_CONDENSED=(byte)0x01;
   public static final byte FORMAT_DERIVED=(byte)0x02;
   //Memory type constants
   public static final byte MEMORY_VOLATILE=(byte)0x01;
   public static final byte MEMORY_NON_VOLATILE=(byte)0x02;
   //Parameter set identifier ranges
   public static final short PARAM_SET_MIN=(short)0x0001;
   public static final short PARAM_SET_MAX=(short)0x00FF;
   //Status codes
   public static final short SUCCESS=(short)0x9000;
   public static final short ERROR_INVALID_PARAMS=(short)0x6A80;
   public static final short ERROR_INSUFFICIENT_MEMORY=(short)0x6A84;
   public static final short ERROR_INVALID_FORMAT=(short)0x6A86;
   /**
      *Creates a PQC key object based on specified parameters.
      *@param paramSetId Identifier for predefined parameter set in ROM
      *@param keyFormat Format specification (condensed/derived)
      *@param memoryType Memory type specification (volatile/non-volatile)
      *@param buffer Input buffer including initialization data
      *@param offset Starting offset in buffer
      *@param length Length of initialization data
      *@return Reference object for created key structure
      *@throws ISOException with following reason codes:
      *-ERROR_INVALID_PARAMS: Parameter set ID invalid
      *-ERROR_INSUFFICIENT_MEMORY: Not enough memory
      *-ERROR_INVALID_FORMAT: Format specification invalid
      */
   public PQCKeyObject createKeyObject(
      short paramSetId,
      byte keyFormat,
      byte memoryType,
      byte[ ] buffer,
      short offset,
      short length
   ) throws ISOException;
   /**
      *Retrieves parameter set information from ROM.
      *@param paramSetId Identifier for parameter set
      *@param infoBuffer Buffer to receive parameter information
      *@param infoOffset Starting offset in buffer
      *@return Length of parameter information written
      */
   public short getParameterSetInfo(
   short paramSetId,
   byte[ ] infoBuffer,
   short infoOffset
   );
   /**
      *Checks memory availability for key object creation.
      *@param keyFormat Format specification
      *@param memoryType Memory type specification
      *@param requiredBytes Number of bytes required
      *@return true if sufficient memory available
      */
   public boolean checkMemoryAvailable(
      byte keyFormat,
      byte memoryType,
      short requiredBytes)
   );
   /**
      *Deletes a PQC key object and releases associated resources.
      *@param keyObject Reference to key object for deletion
      */
   public void deleteKeyObject(PQCKeyObject keyObject);
}
/**
   *Interface defining PQC key object operations.
   */
public interface PQCKeyObject {
   /**
      *Retrieves format of key object.
      *@return Format specification byte
      */
   public byte getKeyFormat();
   /**
      *Retrieves memory type of key object.
      *@return Memory type specification byte
      */
   public byte getMemoryType();
   /**
      *Retrieves parameter set ID associated with key object.
      *@return Parameter set identifier
      */
   public short getParamSetId();
   /**
      *Exports key data to buffer.
      *@param buffer Output buffer for key data
      *@param offset Starting offset in buffer
      *@param length Maximum length to export
      *@return Actual length of exported data
      */
   public short exportKey(
      byte[ ] buffer,
      short offset,
      short length
   );
}

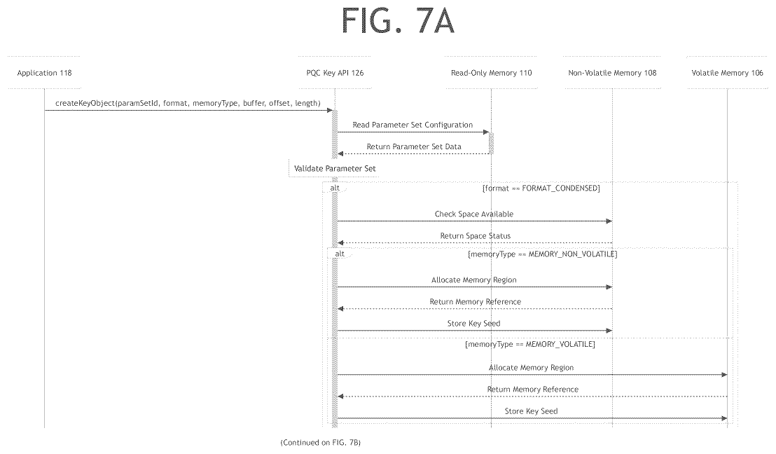

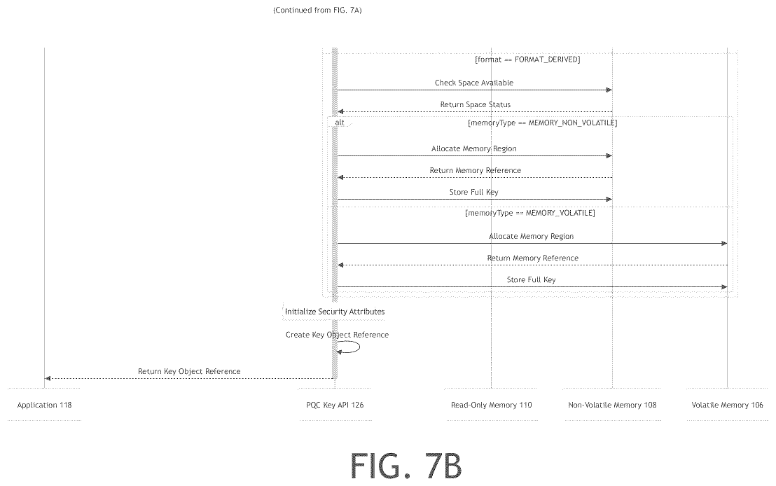

The sequence diagram of FIG. 7A and FIG. 7B illustrates key interactions in the PQC key object creation process. The Application initiates creation by invoking createKeyObject with parameter set identifier, format specification, and memory type. The PQC Key Management API retrieves parameter set configuration from ROM, enabling validation of the creation request.

Format specification determines key representation handling. Condensed format triggers seed-based storage operations, while derived format initiates full key storage procedures. Memory type specification directs storage allocation between Volatile Memory and Non-Volatile Memory components.

The API performs memory availability verification for the specified storage type. Memory allocation proceeds upon successful verification. The API creates appropriate data structures and establishes security attributes for the key object. Format-specific handlers process key material according to condensation requirements.

The sequence concludes with the API returning a key object reference to the application. The reference enables subsequent key operations through the established object interface. Memory management routines optimize resource utilization throughout the creation sequence.

The diagram emphasizes parallel paths for different format and memory type combinations, including the following: condensed format with non-volatile storage, condensed format with volatile storage, derived format with non-volatile storage, or derived format with volatile storage.

Returning to the top of FIG. 7A and FIG. 7B, the application first determines a suitable parameter set identifier based on the target PQC algorithm requirements. The application selects a parameter set identifier corresponding to the ML-KEM-768 algorithm specification stored in ROM.

The application initiates key object creation by calling the createKeyObject method of the PQCKeyManagementInterface. The method call specifies FORMAT_CONDENSED for the key format parameter to enable seed-based storage and MEMORY_NON_VOLATILE for the memory type parameter to maintain persistent key availability. The application provides a buffer including initialization data, which includes entropy for seed generation.

The API processes the creation request by validating the parameter set identifier against defined ranges. Parameter validation includes verification that the identifier falls between PARAM_SET_MIN and PARAM_SET_MAX values. The API retrieves the parameter set information from ROM using the getParameterSetInfo method to determine memory requirements and algorithm specifications.

Memory availability verification occurs through the checkMemoryAvailable method. The API calculates required storage space based on the condensed format specification and parameter set requirements. The method returns a Boolean, indicating sufficient non-volatile memory availability for key object creation.

Upon successful validation, the API allocates memory regions and establishes data structures for the key object. The API creates a PQCKeyObject instance including format specifications, memory type indicators, and parameter set information. The application receives a reference to the created key object for use in subsequent operations.

The application can then query key object properties through the PQCKeyObject interface methods. The getKeyFormat method returns FORMAT_CONDENSED, confirming the seed-based storage configuration. The getMemoryType method returns MEMORY_NON_VOLATILE, verifying persistent storage allocation. The getParamSetId method returns the original parameter set identifier, enabling parameter verification.

When key material access becomes necessary, the application invokes the exportKey method of the PQCKeyObject interface. The method extracts key data into the provided buffer at the specified offset. The application specifies a maximum length parameter to prevent buffer overflow conditions.

The application concludes key object management by calling the deleteKeyObject method when the key material becomes unnecessary. The API releases allocated memory regions and removes data structures associated with the key object. This interaction pattern demonstrates efficient key lifecycle management within secure element resource constraints.

### 4.8 Format-Specific PQC Key Exportation with Memory-Optimized Streaming and Access Control

In one or more embodiments, the PQC key management API 126 exports key material from existing key objects through format-specific methods. Applications 118 request exportation by providing the key object reference and specifying either condensed or derived output format. Format selection determines if the API returns PQC key seed 128 data or complete PQC key 130 data. Condensed format exportation retrieves key seed data from non-volatile memory 108. The API 126 implements secure access mechanisms to extract stored seed values while maintaining data protection. Memory management functions coordinate data transfer from secure storage to output buffers specified by the requesting application 118. Derived format exportation involves complete key structures from either volatile memory 106 or non-volatile memory 108. The API 126 processes stored key material according to derivation parameters defined in the source key object. Security mechanisms protect derived key data during transfer operations through encryption and integrity protection. Memory optimization techniques support efficient exportation processes. The API 126 implements streaming mechanisms for large key structures, enabling chunk-based data transfer through protocol buffers. Buffer management reduces memory overhead by avoiding allocation of temporary storage during exportation operations. Access control systems regulate key material exportation based on application privileges. The API 126 validates authorization levels before permitting access to stored key data. Security protocols ensure proper handling of sensitive material throughout the exportation process, including secure erasure of temporary buffers after completion.

In one or more embodiments, the following example interface of the PQC key management API 126 defines methods supporting secure exportation of PQC key material through format-specific operations:
package com.secureplatform.api;
/**
*Interface defining Post-Quantum Cryptography (PQC) key management operations
*for secure element applications. Provides methods for exporting key material
*in condensed and derived formats with secure memory management.
*/
public interface PQCKeyManagementAPI {
   //Format constants for key export
   public static final byte FORMAT_CONDENSED=0x01;
   public static final byte FORMAT_DERIVED=0x02;
   //Status codes
   public static final short SW_INSUFFICIENT_MEMORY=(short) 0x6A84;
   public static final short SW_SECURITY_STATUS_NOT_SATISFIED=(short) 0x6982;
   public static final short SW_INVALID_PARAMETER=(short) 0x6A80;
   /**
      *Exports key material from a PQC key object in specified format.
      *Implements streaming for large key structures using protocol buffers.
      *
      *@param keyObject Reference to source key object
      *@param format FORMAT_CONDENSED for seed data or FORMAT_DERIVED for complete key
      *@param buffer Output buffer for exported key material
      *@param offset Starting position in output buffer
      *@param length Maximum length of data to export
      *@return Number of bytes written to buffer
      *@throws SecurityException if application lacks required privileges
      */
   public short exportKey(Object keyObject, byte format, byte[ ] buffer, short offset, short length) throws SecurityException;
   /**
      *Continues streaming export operation for large key structures.
      *Must be called after initial exportKey() until all data is transferred.
      *
      *@param buffer Output buffer for next chunk of key material
      *@param offset Starting position in output buffer
      *@param length Maximum length of data to export
      *@return Number of bytes written or 0 if export complete
      */
   public short exportKeyChunk(byte[ ] buffer, short offset, short length);
   /**
      *Validates application privileges for key material access.
      *@param keyObject Reference to key object being accessed
      *@param operation Type of operation being performed
      *@return true if access granted, false if denied
      */
   public boolean checkAccess(Object keyObject, byte operation);
   /**
      *Securely erases temporary buffers used during export operations.
      *Called automatically after export completion.
      */
   public void cleanupExport();
   /**
      *Retrieves the maximum supported key size for export operations.
      *Applications use this to allocate appropriate buffer space.
      *
      *@param format FORMAT_CONDENSED or FORMAT_DERIVED
      *@return Maximum key size in bytes for specified format
      */
   public short getMaxKeySize(byte format);
   /**
      *Checks if streaming is required for key export based on format and size.
      *
      *@param keyObject Reference to key object
      *@param format FORMAT_CONDENSED or FORMAT_DERIVED
      *@return true if streaming required, false if single buffer sufficient
      */
   public boolean requiresStreaming(Object keyObject, byte format);
}

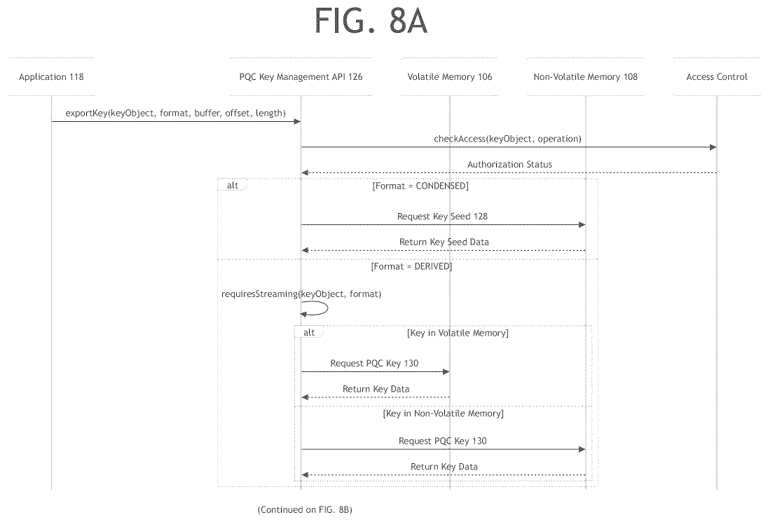

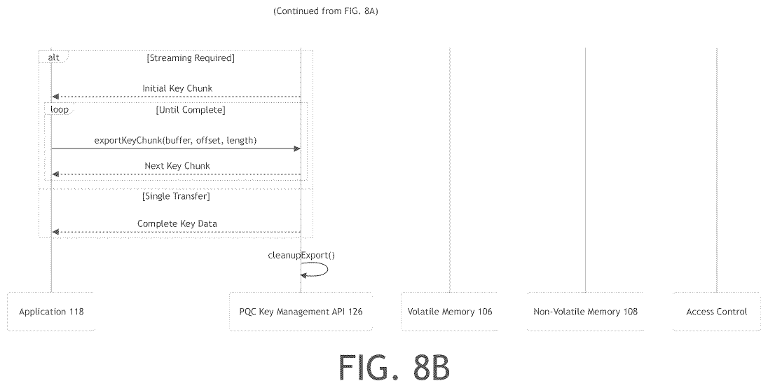

FIG. 8A and FIG. 8B illustrate an example of format-specific PQC key exportation with memory-optimized streaming and access control in accordance with one or more embodiments.

The sequence diagram depicts the interaction flow between system components during key material exportation. The Application 118 initiates the process by calling exportKey with parameters specifying the desired format. The PQC Key Management API 126 first validates application privileges through the Access Control system.

For condensed format requests, the API retrieves key seed data directly from Non-Volatile Memory 108. The derived format path involves additional complexity. The API determines streaming requirements based on key size and platform constraints. Key data retrieval occurs from either Volatile Memory 106 or Non-Volatile Memory 108, depending on the key's current storage location.

When streaming proves necessary, the API implements a chunk-based transfer mechanism. The initial exportKey call returns the first data segment. The Application 118 then enters a loop, repeatedly requesting additional chunks through exportKeyChunk until the transfer completes. This approach optimizes memory usage by avoiding large buffer allocations.

The diagram shows the security mechanisms integrated throughout the process. Access validation occurs before any key material access. The API maintains data protection through encrypted transfer operations. The sequence concludes with the cleanupExport operation, ensuring secure erasure of temporary buffers.

Returning to the top of the example of FIG. 8A and FIG. 8B, the application first determines storage requirements by calling getMaxKeySize() with FORMAT_DERIVED to obtain the required buffer size for derived key data. The application allocates a byte array sized according to the returned value.

The application initiates key exportation by invoking exportKey() while specifying FORMAT_DERIVED, passing a reference to the target key object and the allocated buffer. The API validates access permissions through checkAccess() before proceeding with the operation. Upon successful validation, the API locates the key material in volatile memory 106 or non-volatile memory 108 based on the key object's current state.

Due to large PQC key sizes, the API determines streaming necessity by calling requiresStreaming(). When streaming proves necessary, the initial exportKey() call returns a partial key segment. The application then enters a loop, repeatedly calling exportKeyChunk() to retrieve remaining key material. The application concatenates received chunks into the complete key structure. The process continues until exportKeyChunk() returns zero, signaling completion.

Throughout the export operation, the API maintains security through encrypted data transfer and integrity protection mechanisms. The API implements automatic cleanup procedures after completion, invoking cleanupExport() to securely erase temporary buffers. This interaction pattern ensures efficient memory utilization while maintaining security requirements.

### 4.9 Chunk-Based PQC Export Protocol

In one or more embodiments, the PQC key management API 126 enables chunk-based exportation through a session-oriented protocol. Export sessions begin with an initialization call that establishes export parameters and prepares memory structures. Applications 118 specify desired format and chunk size constraints during session initialization. Update phase operations transfer key data incrementally from secure element storage to output buffers. The API 126 manages data retrieval from volatile memory 106 or non-volatile memory 108 based on source key object location. Protocol buffer mechanisms handle chunk transmission without requiring additional memory allocation within the secure element 104. Session state tracking maintains consistency across multiple update operations. The API 126 implements progress monitoring to ensure complete key material extraction through sequential chunk transfers. Memory management functions coordinate buffer utilization between successive update calls, preserving resource constraints of the secure element hardware. The doFinal phase concludes export operations and validates data integrity. Applications 118 receive confirmation of successful exportation upon session completion. The API 126 executes cleanup procedures to remove temporary session data and release allocated resources. Security mechanisms ensure proper erasure of sensitive material from intermediate buffers. Error handling protocols address failures during any session phase. The API 126 implements recovery procedures to maintain system stability when export operations encounter problems. Status reporting mechanisms provide applications 118 with detailed feedback about chunk transfer results and overall session completion state.

In one or more embodiments, the following example interface of the PQC key management API 126 defines a complete session-based protocol for exporting PQC keys in chunks while working within secure element memory constraints:
package com.secureplatform.pqc;
/**
   *Interface defining chunk-based PQC key export operations.
   *Implements session-oriented protocol for exporting large PQC keys
   *in memory-constrained environments.
   */
public interface PQCKeyExportSession {
   /**
      *Export format options for PQC key material
      */
   public static final byte FORMAT_RAW=0x00;
   public static final byte FORMAT_X509=0x01;
   public static final byte FORMAT_PKCS8=0x02;
   /**
      *Status codes for export operations
      */
   public static final short STATUS_SUCCESS=0x0000;
   public static final short STATUS_INCOMPLETE=0x6300;
   public static final short STATUS_INVALID_STATE=0x6985;
   public static final short STATUS_BUFFER_FULL=0x6A84;
   public static final short STATUS_INVALID_PARAM=0x6A86;
   /**
      *Initializes a new key export session.
      *@param keyRef Reference to the PQC key object to export
      *@param format Export format (FORMAT_RAW, FORMAT_X509, FORMAT_PKCS8)
      *@param maxChunkSize Maximum size in bytes for each exported chunk
      *@return STATUS_SUCCESS if session initialized successfully
      */
   public short initExport(Object keyRef, byte format, short maxChunkSize);
   /**
      *Updates export buffer with next chunk of key data.
      *@param buffer Output buffer for receiving key data chunk
      *@param offset Starting offset in buffer
      *@param length Maximum length to write
      *@return Number of bytes written to buffer or STATUS_INCOMPLETE if more chunks remain
      */
   public short updateExport(byte[ ] buffer, short offset, short length);
   /**
      *Completes export session and performs integrity validation.
      *@param buffer Final output buffer
      *@param offset Starting offset in buffer
      *@param length Maximum length to write
      *@return STATUS_SUCCESS if export completed successfully
      */
   public short finalizeExport(byte[ ] buffer, short offset, short length);
   /**
      *Returns current progress of export operation.
      *@return Percentage complete (0-100)
      */
   public byte getProgress();
   /**
      *Retrieves detailed status information about export session.
      *@param buffer Status data output buffer
      *@param offset Starting offset in buffer
      *@return Number of status bytes written
      */
   public short getStatus(byte[ ] buffer, short offset);
   /**
      *Aborts current export session and releases resources.
      *@return STATUS_SUCCESS if cleanup completed
      */
   public short abort();
}

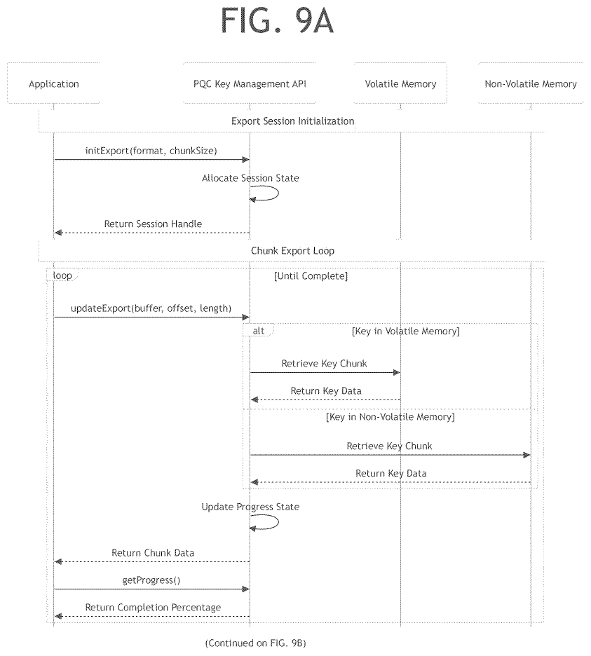

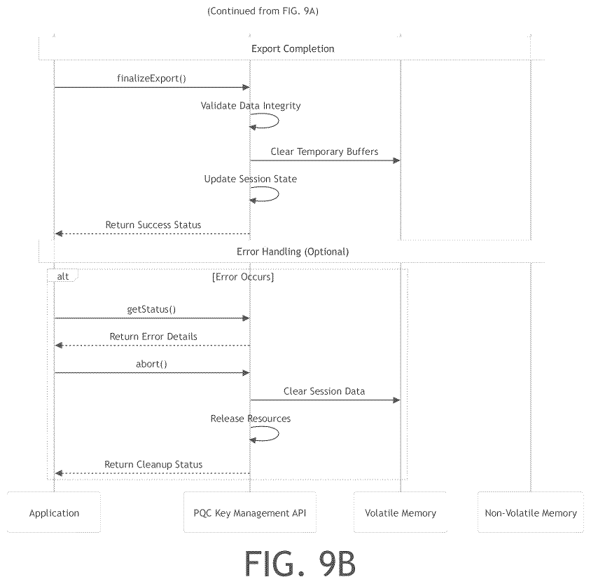

FIG. 9A and FIG. 9B illustrate an example of a chunk-based PQC key export protocol for secure elements in accordance with one or more embodiments. The sequence diagram illustrates the interaction flows between system components during PQC key exportation. The Application initiates communication through the initExport method, providing format specifications and chunk size parameters. The PQC Key Management API establishes session state and returns a handle to the Application.

The chunk export loop represents the primary data transfer sequence. The Application repeatedly calls updateExport with buffer parameters. The API retrieves key material from either Volatile Memory or Non-Volatile Memory, depending on key storage location. Progress monitoring occurs through getProgress calls, enabling the Application to track completion status.

Session completion involves the finalizeExport method call. The API performs data integrity validation and executes cleanup procedures. Error handling flows demonstrate recovery mechanisms, including status retrieval and session abortion. The abort sequence ensures proper resource cleanup and secure data erasure.

The diagram emphasizes memory management aspects through explicit interaction with Volatile Memory and Non-Volatile Memory components. Protocol buffer mechanisms operate within the API layer, managing chunk transmission without additional memory allocation. The complete sequence maintains security requirements while operating within secure element resource constraints.

Returning to the top of FIG. 9A and FIG. 9B, the application initiates a PQC key export session by invoking the PQC key management API with initialization parameters. During initialization, the application specifies the desired export format (such as X.509 or raw key material) and defines chunk size constraints based on available secure element memory. The API processes these parameters and establishes memory structures required for the chunked export operation.

Following successful initialization, the application enters an export loop phase. The application allocates a fixed-size buffer to receive key material chunks. The buffer size aligns with secure element I/O constraints, typically ranging from 128 to 256 bytes. During an iteration, the application calls the updateExport method of the API, providing the prepared buffer along with offset and length parameters.

The API responds to update requests by retrieving key material from secure element storage. When the source key resides in volatile memory, the API directly copies chunks to the output buffer. For keys stored in non-volatile memory, the API manages data access through the secure element's memory management system. The API implements protocol buffer mechanisms to handle chunk transmission efficiently, eliminating the need for additional memory allocation within the secure element.

Throughout the export process, the application monitors progress by checking return values from update operations. A status code of STATUS_INCOMPLETE indicates more chunks remain, prompting the application to continue the export loop. The API maintains internal state tracking to ensure consistent chunk sequencing across multiple update calls. The application can query detailed progress information through dedicated status methods provided by the API.

After receiving all key material chunks, the application initiates export completion through the finalizeExport method. The API performs integrity validation on the exported data during this phase. Successful validation generates a completion status code, confirming proper key material extraction. The API then executes cleanup procedures, removing temporary session data and releasing allocated resources.

Error handling occurs at multiple points in the interaction. The application checks status codes after an API call to detect potential failures. When errors occur, the application can invoke the abort method to terminate the export session cleanly. The API implements recovery procedures to maintain system stability during error conditions. The application can retrieve detailed error information through the status reporting mechanisms of the API.

The entire interaction operates within the secure element's resource constraints. Memory management remains a key focus with the API coordinating buffer utilization between successive operations. Security mechanisms ensure proper erasure of sensitive material from intermediate buffers upon session completion or termination.

### 4.10 Parameter-Driven PQC Key Pair Creation

In one or more embodiments, the PQC key management API 126 provides methods for creating key pair objects through parameter-driven initialization. Applications 118 invoke creation by supplying an identifier referencing algorithm-specific parameters stored in ROM 110. The parameter set defines cryptographic characteristics, including key sizes, mathematical structures, and memory requirements, for both public and private components. Memory management functions allocate storage regions in secure element 104 based on parameter specifications. Private key components are stored in protected memory areas with strict access controls, while public key components maintain accessibility for cryptographic operations. The allocation process ensures proper memory alignment and security boundaries within volatile memory 106 or non-volatile memory 108. Creation procedures establish data structures for managing paired key relationships. The API 126 generates object references that enable applications 118 to perform operations on public and private components while maintaining key relationships. Security mechanisms enforce access restrictions between paired components according to cryptographic requirements specified in the parameter set. Parameter validation ensures compatibility with secure element resources. The API 126 verifies memory availability and processing capabilities against parameter requirements before initiating key pair creation. Memory optimization techniques implement efficient storage strategies for parameter-defined key structures, considering condensation options and derivation needs. Transaction management features provide atomic creation operations. Applications 118 receive status information about successful object initialization or specific error conditions. The API 126 executes rollback procedures when creation fails, maintaining system stability through proper resource cleanup and security state preservation.

In one or more embodiments, the following example interface of the PQC key management API 126 defines methods that implement the PQC key management functionality:
package com.secureplatform.pqc;
/**
   *API interface for Post-Quantum Cryptography (PQC) key pair management on secure elements.
   *Provides methods for parameter-driven key pair creation and lifecycle management.
   */
public interface PQCKeyManagementInterface {
   /**
      *Status codes for key pair creation operations
      */
   public static final short STATUS_SUCCESS=(short) 0x9000;
   public static final short ERROR_INSUFFICIENT_MEMORY=(short) 0x6A84;
   public static final short ERROR_INVALID_PARAMETERS=(short) 0x6A80;
   public static final short ERROR_UNSUPPORTED_ALGORITHM=(short) 0x6A81;
   public static final short ERROR_TRANSACTION_FAILURE=(short) 0x6A82;
   /**
      *Algorithm parameter reference identifiers
      */
   public static final byte ALG_ML-KEM_512=(byte) 0x01;
   public static final byte ALG_ML-KEM_768=(byte) 0x02;
   public static final byte ALG_ML-KEM_1024=(byte) 0x03;
   public static final byte ALG_ML-DSA_2=(byte) 0x11;
   public static final byte ALG_ML-DSA_3=(byte) 0x12;
   public static final byte ALG_ML-DSA_5=(byte) 0x13;
   /**
      *Memory allocation strategies
      */
   public static final byte MEMORY_PERSISTENT=(byte) 0x01;
   public static final byte MEMORY_TRANSIENT_DESELECT=(byte) 0x02;
   public static final byte MEMORY_TRANSIENT_RESET=(byte) 0x03;
   /**
      *Creates a PQC key pair object using algorithm-specific parameters.
      *@param algorithmRef Algorithm parameter reference identifier
      *@param keyPairHandle Buffer to store the created key pair handle
      *@param keyPairHandleOffset Offset in the handle buffer
      *@param memoryStrategy Memory allocation strategy for key components
      *@return Status code indicating operation result
      */
   public short createKeyPair(byte algorithmRef,
      byte[ ] keyPairHandle,
      short keyPairHandleOffset,
      byte memoryStrategy);
   /**
      *Retrieves parameter specifications for a given algorithm reference.
      *@param algorithmRef Algorithm parameter reference identifier
      *@param paramBuffer Buffer to store parameter information
      *@param paramOffset Offset in the parameter buffer
      *@return Length of parameter data written to buffer
      */
   public short getAlgorithmParameters(byte algorithmRef,
      byte[ ] paramBuffer,
      short paramOffset);
   /**
      *Validates system resources against parameter requirements.
      *@param algorithmRef Algorithm parameter reference identifier
      *@return Status code indicating validation result
      */
   public short validateParameters(byte algorithmRef);
   /**
      *Retrieves public key component from a key pair.
      *@param keyPairHandle Handle identifying the key pair
      *@param publicKeyBuffer Buffer to store public key data
      *@param publicKeyOffset Offset in the public key buffer
      *@return Length of public key data written to buffer
      */
   public short getPublicKey(byte[ ] keyPairHandle,
      byte[ ] publicKeyBuffer,
      short publicKeyOffset);
   /**
      *Checks if private key operations are allowed for a key pair.
      *@param keyPairHandle Handle identifying the key pair
      *@return Boolean indicating private key accessibility
      */
   public boolean isPrivateKeyAccessible(byte[ ] keyPairHandle);
   /**
      *Releases resources associated with a key pair.
      *@param keyPairHandle Handle identifying the key pair
      *@return Status code indicating operation result
      */
   public short destroyKeyPair(byte[ ] keyPairHandle);
   /**
      *Retrieves memory requirements for key pair creation.
      *@param algorithmRef Algorithm parameter reference identifier
      *@param requirementsBuffer Buffer to store memory requirements
      *@param requirementsOffset Offset in the requirements buffer
      *@return Length of requirements data written to buffer
      */
   public short getMemoryRequirements(byte algorithmRef,
      byte[ ] requirementsBuffer,
      short requirementsOffset);
   /**
      *Begins an atomic key pair creation transaction.
      *@param algorithmRef Algorithm parameter reference identifier
      *@return Status code indicating transaction initiation result
      */
   public short beginKeyPairTransaction(byte algorithmRef);
   /**
      *Commits or rolls back a key pair creation transaction.
      *@param commit True to commit, false to roll back
      *@return Status code indicating transaction completion result
      */
   public short endKeyPairTransaction(boolean commit);
}

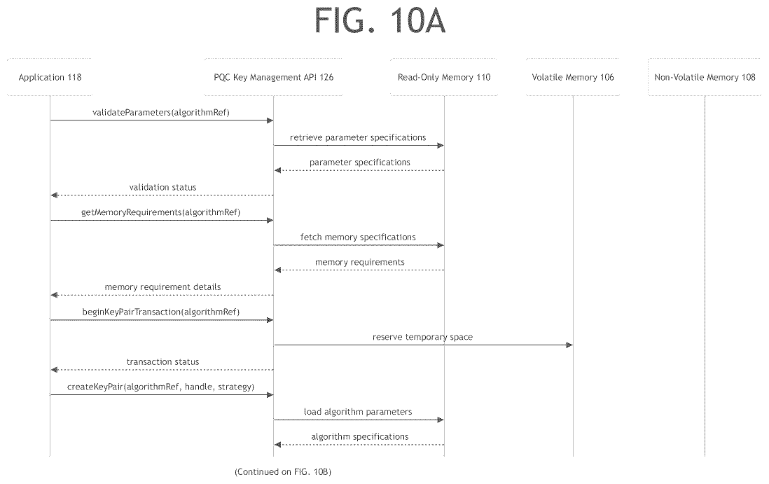

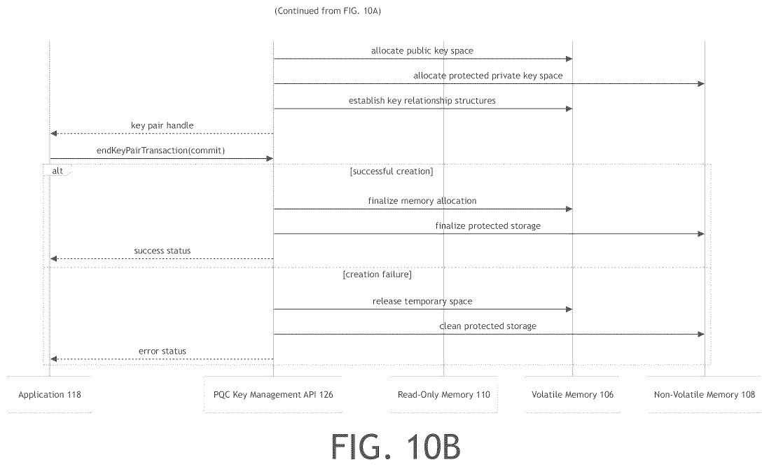

FIG. 10A and FIG. 10B illustrate an example of parameter-driven PQC key pair creation with secure element memory management in accordance with one or more embodiments. The sequence diagram illustrates the interactions between system components during PQC key pair creation. The Application initiates parameter validation by sending an algorithm reference to the API. The API retrieves parameter specifications from ROM and validates resource compatibility. Memory requirement verification follows with the API consulting ROM for detailed specifications.

Transaction management begins when the Application requests key pair creation. The API reserves temporary space in Volatile Memory for transaction safety. The creation sequence involves loading algorithm parameters from ROM, allocating public key space in Volatile Memory and establishing protected private key storage in Non-Volatile Memory.

Key relationship structures maintain associations between public and private components. The transaction concludes with either successful commitment or rollback. Successful creation finalizes memory allocations and protected storage. Failed creation triggers cleanup procedures, releasing temporary space and clearing protected storage areas.

The diagram emphasizes security boundaries through separate memory interactions. Public key components reside in Volatile Memory with controlled access, while private key components occupy protected Non-Volatile Memory regions. The API manages these security domains throughout the creation lifecycle, maintaining isolation between public and private components.

Returning to the top of FIG. 10A and FIG. 10B, the application initiates PQC key pair creation by first requesting parameter validation through the validateParameters method, passing ALG_ML-KEM_768 as the algorithm reference. The API processes this request by examining the secure element's available resources against the stored ML-KEM-768 parameters in ROM. These parameters specify memory requirements including a 1184-byte public key size and a 2400-byte private key size.

Upon successful parameter validation, the application calls getMemoryRequirements to determine precise memory allocation needs. The API returns a structured buffer including separate volatile and non-volatile memory requirements for the selected algorithm. The application uses this information to verify sufficient memory availability before proceeding with key pair creation.

The application then invokes beginKeyPairTransaction to start an atomic creation operation for the ML-KEM-768 key pair. The API establishes transaction boundaries and prepares secure element resources for the creation process. The application proceeds by calling createKeyPair with ALG_ML-KEM_768 and MEMORY_TRANSIENT_DESELECT parameters. This specification directs the API to allocate volatile memory for temporary storage of derived key components.

During key pair creation, the API allocates memory regions according to the ML-KEM-768 parameters. The private key components receive protected memory areas with restricted access controls. The public key components maintain accessibility for subsequent operations. The API generates a key pair handle, which serves as a reference for future operations on the created key pair.

The application receives the key pair handle and verifies successful creation through status code examination. Upon confirmation of successful creation, the application calls endKeyPairTransaction with a commit parameter of true. The API finalizes the transaction, establishing permanent resource allocations and security controls for the key pair.

Following creation, the application retrieves the public key through getPublicKey, providing the key pair handle. The API enforces access controls while copying public key data to the provided buffer. The application verifies public key accessibility while private key protection remains enforced through isPrivateKeyAccessible checks.

When key pair usage concludes, the application calls destroyKeyPair with the key pair handle. The API releases allocated resources, ensuring secure cleanup of key material and associated data structures. Memory regions return to the secure element's resource pool while maintaining security guarantees throughout the destruction process.

### 4.11 Linked Public-Private Key References

In one or more embodiments, the PQC key management API 126 establishes a linked structure between separate public and private key objects within secure element 104. The key pair object maintains references to both constituent key objects while enforcing appropriate security boundaries. Applications 118 access paired keys through object references that map to distinct storage locations in volatile memory 106 or non-volatile memory 108. The public key object includes externally accessible components required for cryptographic operations. Memory management functions store public key data in regions configured for controlled access by authorized applications 118. The API 126 implements memory optimization through selective condensation and derivation of public key components based on operational requirements. Private key objects reside in protected memory regions with restricted access controls. The API 126 enforces strict security policies on private key operations through hardware-backed protection mechanisms. Memory allocation for private keys prioritizes security features available in the secure element 104, including hardware-based encryption and secure storage protocols. Reference management systems track relationships between paired objects throughout lifecycle operations. The API 126 maintains consistency when performing operations that affect both public and private components. Memory operations coordinate changes across paired objects while preserving security boundaries between public and private key material. Access control mechanisms differentiate privileges for public and private key operations. Applications 118 receive operation-specific permissions based on security requirements for individual key components. The API 126 validates authorization levels before permitting access to sensitive private key functions while allowing appropriate utilization of public key capabilities.

In one or more embodiments, the following example interface of the PQC key management API 126 defines a comprehensive API for managing PQC key pairs within secure elements:
package com.security.pqc;
import javacard.security.*;
import javacard.framework.*;
/**
   *API interface for managing Post-Quantum Cryptography (PQC) key pairs within secure elements.
   *Provides methods for key lifecycle management with optimized memory handling and security controls.
   */
public interface PQCKeyManagementAPI {
   //Key Pair Management
   /**
      *Creates a linked PQC key pair structure with separate public and private components.
      *@param keyType Type identifier for the PQC algorithm
      *@param keySize Size of the key in bytes
      *@return Reference to the created key pair object
      *@throws CryptoException if key generation fails
      */
   public PQCKeyPair createKeyPair(byte keyType, short keySize) throws CryptoException;
   /**
      *Links existing public and private key components into a paired structure.
      *@param publicKeyRef Reference to public key object
      *@param privateKeyRef Reference to private key object
      *@return Reference to the paired key structure
      *@throws SecurityException if access validation fails
      */
   public PQCKeyPair linkKeyComponents(Object publicKeyRef, Object privateKeyRef) throws SecurityException;
   //Public Key Operations
   /**
      *Imports public key data with optimized memory allocation.
      *@param buffer Buffer including public key data
      *@param offset Starting offset in buffer
      *@param length Length of key data
      *@return Reference to created public key object
      */
   public Object importPublicKey(byte[ ] buffer, short offset, short length);
   /**
      *Condenses public key components for efficient storage.
      *@param publicKeyRef Reference to public key object
      *@return Success status
      */
   public boolean condensePublicKey(Object publicKeyRef);
   /**
      *Derives condensed public key for operational use.
      *@param publicKeyRef Reference to condensed public key
      *@return Success status
      */
   public boolean derivePublicKey(Object publicKeyRef);
   //Private Key Operations
   /**
      *Generates private key in protected memory region.
      *@param algorithm PQC algorithm identifier
      *@param keySize Size of private key
      *@return Reference to protected private key object
      *@throws CryptoException if generation fails
      */
   public Object generatePrivateKey(byte algorithm, short keySize) throws CryptoException;
   /**
      *Securely imports private key material with hardware protection.
      *@param buffer Encrypted private key data
      *@param offset Starting offset in buffer
      *@param length Length of key data
      *@return Reference to protected private key object
      *@throws SecurityException if validation fails
      */
   public Object importPrivateKey(byte[ ] buffer, short offset, short length) throws SecurityException;
   // Access Control
   /**
      *Validates application authorization for key operations.
      *@param keyRef Reference to key object
      *@param operation Requested operation type
      *@return Authorization status
      */
   public boolean validateAccess(Object keyRef, byte operation);
   /**
      *Grants operation-specific permissions to applications.
      *@param appID Application identifier
      *@param permissions Permission flags
      *@return Success status
      */
   public boolean grantPermissions(AID appID, byte permissions);
   // Memory Management
   /**
      *Releases memory resources associated with key objects.
      *@param keyRef Reference to key object
      *@return Success status
      */
   public boolean releaseKeyResources(Object keyRef);
   /**
      *Manages volatile memory allocation for derived keys.
      *@param requiredSize Required memory size
      *@return Available memory size
      */
   Public Short Managevolatilememory(short Requiredsize);
   //Constants
   public static final byte OPERATION_SIGN=0x01;
   public static final byte OPERATION_VERIFY=0x02;
   public static final byte OPERATION_ENCRYPT=0x03;
   public static final byte OPERATION_DECRYPT=0x04;
   public static final byte PERMISSION_PUBLIC_READ=0x01;
   public static final byte PERMISSION_PUBLIC_USE=0x02;
   public static final byte PERMISSION_PRIVATE_USE=0x04;
   public static final byte ALG_PQC_ML-KEM=0x01;
   public static final byte ALG_PQC_ML-DSA=0x02;
}

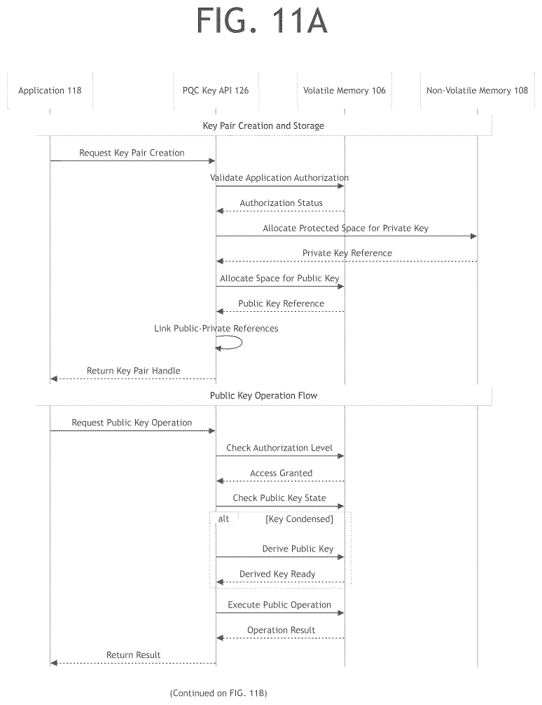

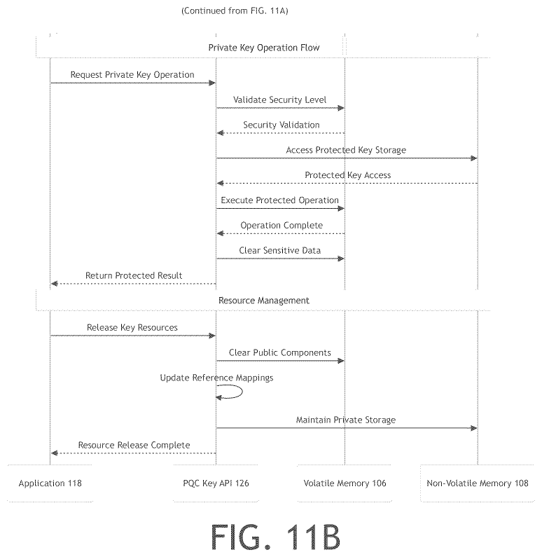

FIG. 11A and FIG. 11B illustrate an example of memory-optimized, post-quantum key management for secure elements through linked public-private key references in accordance with one or more embodiments. The sequence diagram illustrates the primary interaction flows between system components. The application initiates operations through the PQC Key Management API. The API coordinates with the Security Control Layer to enforce access policies and manage cryptographic operations.

Memory management operations involve both Volatile Memory and Non-Volatile Memory components. The Volatile Memory stores derived public keys and temporary operation data. The Non-Volatile Memory maintains protected storage for private key material with hardware-backed security features.

The diagram shows four main interaction sequences: key pair creation and storage sequence establishing linked public-private structures, public key operation flow with condensation state management, private key operation flow utilizing protected memory access, and resource management sequence for coordinated cleanup operations.

A sequence maintains security boundaries through validation checks and controlled access to protected resources. The API manages reference relationships throughout operation lifecycles while enforcing appropriate isolation between public and private components.

Returning to the top of FIG. 11A and FIG. 11B, the application initiates an interaction with the PQC key management API by requesting creation of a new PQC key pair structure. The API validates the application's authorization level and allocates memory regions for both public and private components. A deterministic key generation process creates the private key material in a protected memory segment with hardware-backed security controls. The public key components are derived and stored in a separate memory region configured for controlled access.

After key generation, the API establishes reference mappings between the public and private components. These reference mappings enable coordinated operations while maintaining strict separation between sensitive materials. The application receives object references that serve as handles for subsequent cryptographic operations. The reference system abstracts the actual storage locations from the application layer, allowing the API to optimize memory usage transparently.

When the application needs to perform a cryptographic operation, the application invokes the API with the relevant key references and operation parameters. The API first validates the application's permissions for the requested operation type. For operations involving public key components, the API checks if the key is in condensed form. The API automatically derives condensed public keys into volatile memory when required for active use. The derivation process allocates temporary memory buffers sized appropriately for the specific PQC algorithm requirements.

During private key operations, the API enforces additional security controls through hardware protection mechanisms. The API coordinates access to protected memory regions including private key material while maintaining isolation from other system components. After completing cryptographic operations, the API manages cleanup of temporary buffers and selective condensation of derived public keys. Memory management functions monitor resource utilization and optimize storage allocation based on system constraints.

The reference management system tracks modifications to either public or private components throughout these operations. When the application signals completion of key usage, the API coordinates release of allocated resources while preserving the integrity of persistent key material. The permission management system continues to enforce access controls on remaining key references based on the application's authorization level.

### 4.12 Format-Specifica Memory Allocation and Condensation

In one or more embodiments, the PQC key management API 126 creates key pair objects through format-specific initialization parameters for public and private components. Memory allocation occurs separately for public and private keys according to specified memory types within volatile memory 106 or non-volatile memory 108. Format selection determines if keys exist in condensed seed form or derived complete form. Random number generation follows algorithm specifications provided during object creation. The API 126 utilizes designated random algorithms to generate entropy for key materials. Hardware-backed random number generators within secure element 104 provide cryptographic quality randomness when available through the specified algorithm. Public key storage parameters define format and memory placement for externally accessible components. Condensed public keys are stored as seeds requiring derivation before use, while derived formats maintain complete key structures. Memory type selection for public keys balances accessibility needs with available secure element resources. Private key parameters establish heightened security controls through format and memory specifications. Condensed private keys minimize storage requirements in non-volatile memory 108 through seed-based representation. Derived private keys support direct cryptographic operations but require additional memory resources. Memory type selection for private keys prioritizes security features available in the target storage location. Format-specific handlers process key generation according to condensation requirements. The API 126 implements efficient memory utilization through selective condensation and derivation based on specified formats. Memory management functions optimize allocation based on format characteristics while maintaining security boundaries between public and private components.

In one or more embodiments, the following example interface of the PQC key management API 126 defines methods implementing key management capabilities for post-quantum cryptography on secure element platforms:
package com.securityapi.pqc;
import javacard.framework.*;
import javacard.security.*;
/**
   *API interface for Post-Quantum Cryptography (PQC) key management operations.
   *Provides methods for creating, storing, and managing PQC key pairs with
   *configurable memory allocation and format specifications.
   */
public interface PQCKeyManagementAPI {
   //Format constants for key storage
   public static final byte FORMAT_CONDENSED=(byte)0x01;
   public static final byte FORMAT_DERIVED=(byte)0x02;
   //Memory type constants
   public static final byte MEMORY_TYPE_RAM=(byte)0x01;
   public static final byte MEMORY_TYPE_EEPROM=(byte)0x02;
   // Algorithm family identifiers
   public static final byte ALG_ML-DSA=(byte)0x01;
   public static final byte ALG_ML-KEM=(byte)0x02;
   public static final byte ALG_FALCON=(byte)0x03;
   /**
      *Creates a PQC key pair object with specified format and memory parameters.
      *@param algorithm PQC algorithm identifier
      *@param publicKeyFormat Format specification for public key storage
      *@param privateKeyFormat Format specification for private key storage
      *@param publicKeyMemoryType Memory type for public key storage
      *@param privateKeyMemoryType Memory type for private key storage
      *@return Reference to created key pair object
      *@throws CryptoException if parameters are invalid or resources unavailable
      */
   public PQCKeyPair createKeyPair(
      byte algorithm,
      byte publicKeyFormat,
      byte privateKeyFormat,
      byte publicKeyMemoryType,
      byte privateKeyMemoryType) throws CryptoException;
   /**
      *Generates key pair using specified random number generation algorithm.
      *@param keyPair Reference to key pair object
      *@param randomAlgorithm Algorithm identifier for random generation
      *@throws CryptoException if generation fails
      */
   public void generateKeyPair(
      PQCKeyPair keyPair,
      byte randomAlgorithm) throws CryptoException;
   /**
      *Imports public key data with specified format parameters.
      *@param keyPair Target key pair for import
      *@param buffer Buffer including key data
      *@param offset Starting offset in buffer
      *@param length Length of key data
      *@throws CryptoException if import fails
      */
   public void importPublicKey(
      PQCKeyPair keyPair,
      byte[ ] buffer,
      short offset,
      short length) throws CryptoException;
   /**
      *Imports private key data with specified format parameters.
      *@param keyPair Target key pair for import
      *@param buffer Buffer including key data
      *@param offset Starting offset in buffer
      *@param length Length of key data
      *@throws CryptoException if import fails
      */
   public void importPrivateKey(
      PQCKeyPair keyPair,
      byte[ ] buffer,
      short offset,
      short length) throws CryptoException;
   /**
      *Exports public key in specified format.
      *@param keyPair Source key pair for export
      *@param buffer Output buffer for key data
      *@param offset Starting offset in buffer
      *@return Length of exported key data
      *@throws CryptoException if export fails
      */
   public short exportPublicKey(
      PQCKeyPair keyPair,
      byte[ ] buffer,
      short offset) throws CryptoException;
   /**
      *Derives condensed key format to full representation.
      *@param keyPair Key pair including condensed format
      *@param keyType Specifies public or private key derivation
      *@throws CryptoException if derivation fails
      */
   public void deriveKey(
      PQCKeyPair keyPair,
      byte keyType) throws CryptoException;
   /**
      *Condenses derived key format to seed representation.
      *@param keyPair Key pair including derived format
      *@param keyType Specifies public or private key condensation
      *@throws CryptoException if condensation fails
      */
   public void condenseKey(
      PQCKeyPair keyPair,
      byte keyType) throws CryptoException;
   /**
      *Clears key pair data and releases associated memory.
      * @param keyPair Key pair to clear
      */
   public void clearKeyPair(PQCKeyPair keyPair);
}
/**
   *Interface representing a PQC key pair with associated parameters
   *and memory management capabilities.
   */
   interface PQCKeyPair {
      public static final byte KEY_TYPE_PUBLIC=(byte)0x01;
      public static final byte KEY_TYPE_PRIVATE=(byte)0x02;
   /**
      *Returns current format of specified key component.
      *@param keyType Type of key to query
      *@return Format identifier
      */
   public byte getKeyFormat(byte keyType);
   /**
      *Returns current memory type of specified key component.
      *@param keyType Type of key to query
      *@return Memory type identifier
      */
   public byte getKeyMemoryType(byte keyType);
   /**
      *Returns algorithm associated with key pair.
      *@return Algorithm identifier
      */
   public byte getAlgorithm();
}

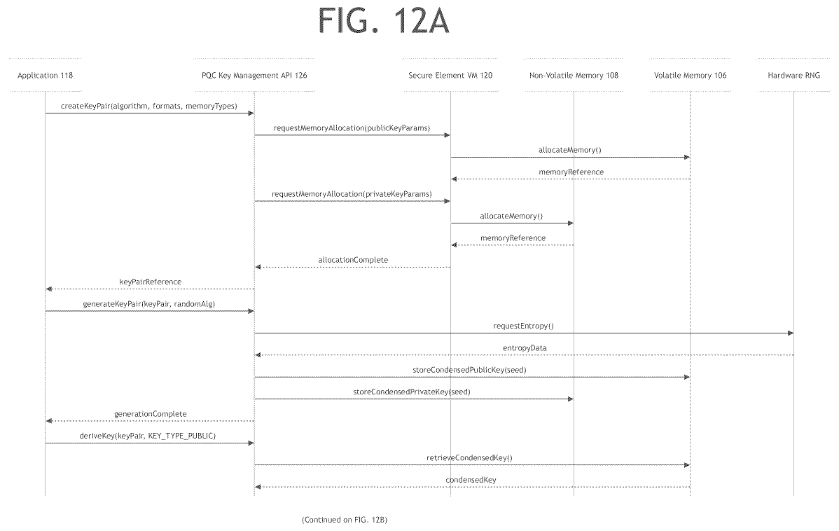

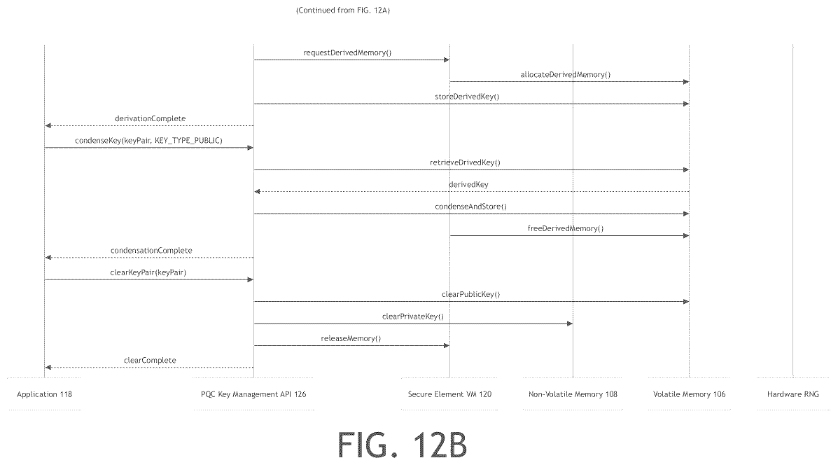

FIG. 12A and FIG. 12B illustrate an example of memory-optimized, post-quantum key management for resource-constrained secure elements through format-specific memory allocation and condensation in accordance with one or more embodiments. The sequence diagram illustrates the temporal flow of interactions between system components during PQC key management operations. The diagram shows five main operation sequences:
Key Pair Creation: The application initiates key pair creation by specifying algorithm parameters, format selections, and memory type requirements. The API coordinates with the Virtual Machine to allocate appropriate memory in volatile and non-volatile storage based on specified parameters;
Key Generation: Random number generation begins with entropy requests to the hardware RNG. The API processes obtained entropy according to the specified algorithm, storing condensed seed representations in designated memory locations;
Key Derivation: Public key derivation operations retrieve condensed seeds from volatile memory. The API requests additional memory allocation for derived formats, then performs deterministic derivation of the key material;
Key Condensation: Condensation operations convert derived key formats back to seed representation. The API manages memory deallocation for derived formats while preserving condensed representations; and
Key Clearing: Memory cleanup operations clear key material from both volatile and non-volatile storage. The API coordinates with the Virtual Machine to release allocated memory resources.

The diagram demonstrates separation between public and private key operations through distinct memory interactions. Format-specific handling appears through condensation and derivation sequences. Memory type distinctions manifest in interactions with volatile versus non-volatile storage components.

Returning to the top of the example of FIG. 12A and FIG. 12B, an application executing on the secure element initiates interaction with the PQC key management API by requesting creation of a key pair object. The application specifies ML-DSA as the selected algorithm, designating condensed format for both public and private components. Memory type parameters direct public key storage to RAM while allocating private key storage in EEPROM. The API processes these specifications by allocating appropriate memory structures and initializing format-specific handlers for the condensed representation.

Following object creation, the application invokes key pair generation using the hardware random number generator algorithm. The API coordinates with the secure element's random number generation hardware to obtain cryptographic quality entropy. This entropy feeds into the ML-DSA key generation process, producing condensed seed representations for both public and private components. The condensed public key occupies minimal RAM space while the private key seed stores securely in EEPROM.

The application then requires the public key in derived format for signature verification operations. A call to the deriveKey method triggers the API to perform deterministic derivation of the public key seed. The API allocates additional RAM space for the derived format and executes the ML-DSA-specific derivation process. The derived public key remains in RAM until the application completes verification operations.

After verification processing, the application invokes condensation of the public key to release RAM resources. The API executes the condenseKey method, which reduces the derived public key back to seed form. Throughout these operations, the private key remains in condensed format within EEPROM, maintaining minimal storage requirements while preserving generation capability.

The application concludes interaction by requesting cleanup of the key pair object. The API's clearKeyPair method securely erases key material from both RAM and EEPROM locations. Memory deallocation occurs according to the originally specified memory types, maintaining proper resource management within the secure element environment.

### 4.13 Runtime Derivation of PQC Key Seeds

In one or more embodiments, the PQC key management API 126 enables runtime derivation of stored key objects through format conversion methods. Applications 118 request key derivation by providing the source key object reference and target memory type specification. The API validates memory availability in the specified target location within volatile memory 106 or non-volatile memory 108 before initiating derivation. Memory management functions allocate space according to derived format requirements of the cryptographic algorithm. Derivation operations process key material from condensed seed format into complete key structures needed for cryptographic functions. The source key object maintains original data, while derived representations populate newly allocated memory regions. Format conversion executes through deterministic derivation algorithms specified in PQC key params 132. The API 126 applies designated derivation procedures to transform PQC key seed 128 data into PQC key 130 structures. Memory optimization techniques minimize resource consumption during derivation by processing key material directly into target memory locations. Access control mechanisms preserve security boundaries during format conversion. The API 126 enforces authorization requirements for derivation operations based on key object security attributes. Memory protection features ensure that derived key material remains accessible to authorized applications 118 within designated security contexts. Transaction management ensures atomic completion of derivation operations. The API 126 implements rollback procedures for failed derivations to maintain system consistency. Status reporting mechanisms communicate derivation results to applications 118, including confirmation of successful format conversion or specific error conditions encountered during processing.

In one or more embodiments, the following example interface of the PQC key management API 126 defines methods for managing PQC key operations:
package org.globalplatform.pqc;
import javacard.framework.*;
import javacard.security.*;
/**
   *PQC Key Management API for secure element platforms.
   *Provides methods for runtime derivation and management of PQC keys.
   */
public interface PCQKeyManagementInterface {
   /** Key derivation target memory types */
   public static final byte TARGET_MEMORY_RAM=0x01;
   public static final byte TARGET_MEMORY_PERSISTENT=0x02;
   /** Status codes for key operations */
   public static final short STATUS_SUCCESS=0x0000;
   public static final short STATUS_INSUFFICIENT_MEMORY=0x6A84;
   public static final short STATUS_INVALID_KEY_FORMAT=0x6A85;
   public static final short STATUS_UNAUTHORIZED_ACCESS=0x6982;
   public static final short STATUS_INVALID_PARAMS=0x6A86;
   /**
      *Derives a PQC key seed into a full key structure.
      *@param keyRef Reference to the source key seed object
      *@param targetMemoryType Memory type for derived key (RAM or persistent)
      *@param keyParams Buffer including algorithm-specific derivation parameters
      *@param keyParamsOffset Offset in keyParams buffer
      *@param keyParamsLength Length of key parameters data
      *@param derivedKeyRef Reference buffer to receive derived key handle
      *@param derivedKeyRefOffset Offset in derivedKeyRef buffer
      *@return Status code indicating operation result
      *@throws SecurityException if caller lacks required privileges
      *@throws SystemException if system error occurs during derivation
      */
   public short deriveKey(Object keyRef,
      byte targetMemoryType,
      byte[ ] keyParams,
      short keyParamsOffset,
      short keyParamsLength,
      byte[ ] derivedKeyRef,
      short derivedKeyRefOffset)
   throws SecurityException, SystemException;
   /**
      *Validates available memory for key derivation.
      *@param requiredSpace Memory space required for derived key
      *@param targetMemoryType Target memory type to check
      *@return True if sufficient space available, false otherwise
      */
   public boolean checkMemoryAvailable(short requiredSpace, byte targetMemoryType);
   /**
      *Retrieves derivation parameters for a PQC algorithm.
      *@param algorithmID Algorithm identifier
      *@param params Buffer to receive parameter data
      *@param paramsOffset Offset in params buffer
      *@return Length of parameter data written
      *@throws SystemException if algorithm not supported
      */
   public short getDerivationParams(byte algorithmID,
      byte[ ] params,
      short paramsOffset)
   throws SystemException;
   /**
      *Configures security attributes for derived keys.
      *@param keyRef Reference to key object
      *@param attributes Buffer including security attributes
      *@param attributesOffset Offset in attributes buffer
      *@param attributesLength Length of attributes data
      *@return Status code indicating operation result
      *@throws SecurityException if caller lacks required privileges
      */
   public short setKeyAttributes(Object keyRef,
      byte[ ] attributes,
      short attributesOffset,
      short attributesLength) throws SecurityException;
   /**
      *Begins a key derivation transaction.
      *@return Transaction handle
      *@throws TransactionException if transaction cannot be started
      */
   public short beginDerivationTransaction() throws TransactionException;
   /**
      *Commits a key derivation transaction.
      *@param transactionHandle Handle from beginDerivationTransaction
      *@return Status code indicating operation result
      *@throws TransactionException if commit fails
      */
   public short commitDerivationTransaction(short transactionHandle) throws TransactionException;
   /**
      *Aborts a key derivation transaction.
      *@param transactionHandle Handle from beginDerivationTransaction
      *@throws TransactionException if abort fails
      */
   public void abortDerivationTransaction(short transactionHandle) throws TransactionException;
   /**
      *Releases derived key memory.
      *@param derivedKeyRef Reference to derived key
      *@return Status code indicating operation result
      *@throws SecurityException if caller lacks required privileges
      */
   public short releaseDerivedKey(Object derivedKeyRef) throws SecurityException;
   /**
      *Retrieves status of last derivation operation.
      *@param statusBuffer Buffer to receive detailed status
      *@param statusOffset Offset in status buffer
      *@return Length of status data written '*/
   public short getLastOperationStatus(byte[ ] statusBuffer, short statusOffset);
}

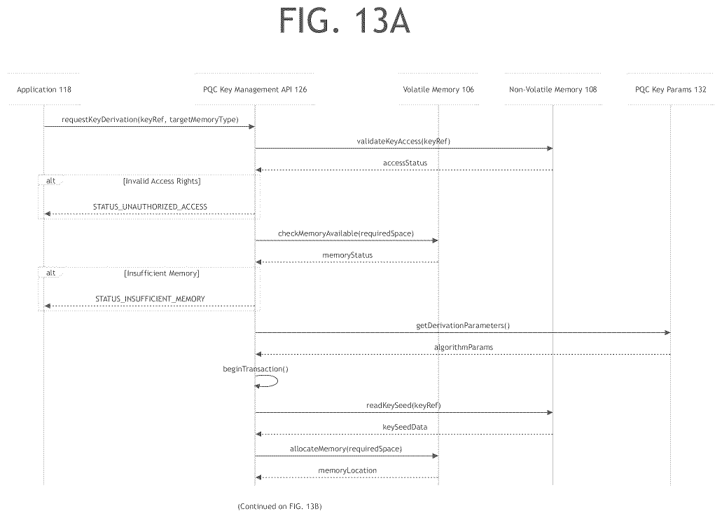

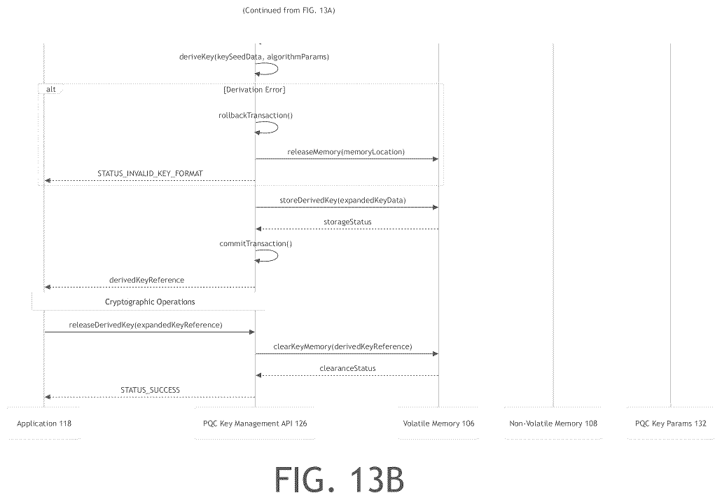

FIG. 13A and FIG. 13B illustrate an example of runtime derivation of PQC key seeds into derived key structures enabling secure element applications to perform cryptographic operations while optimizing memory usage through deterministic key derivation procedures in accordance with one or more embodiments.

The sequence diagram illustrates interactions between components during PQC key derivation operations. The Application 118 initiates an derivation request by providing a key reference and target memory specification. The PQC Key Management API 126 performs access validation through Non-Volatile Memory 108 components. Memory availability checks execute against Volatile Memory 106 systems before proceeding with derivation.

The derivation sequence retrieves algorithm parameters from PQC Key Params 132 storage. Transaction boundaries encompass key seed retrieval, memory allocation, and derivation operations. The API implements error handling paths for access violations, memory constraints, and derivation failures. Successful operations result in derived key storage within designated memory regions.

The diagram captures memory management operations, including allocation for derived keys and subsequent release after cryptographic operations complete. Status reporting flows provide operation results to the requesting application. The transaction framework ensures atomic completion or rollback of derivation operations.

Returning to the top of the examine of FIG. 13A and FIG. 13B, the application provides a reference to the source key seed object and specifies volatile memory as the target storage location. Prior to executing the derivation operation, the API validates available RAM space by comparing the memory requirements of the derived key format against current system resources.

Upon confirming sufficient memory availability, the API retrieves derivation parameters associated with the PQC algorithm specified in the key seed metadata. These parameters define the deterministic derivation procedure for transforming the condensed seed into a complete key structure. The API then initiates a transaction to ensure atomic completion of the derivation process.

The derivation operation processes the key seed data according to the specified algorithm parameters. The resulting derived key material populates newly allocated regions in volatile memory. Throughout the derivation process, the API maintains security boundaries by validating the application's authorization to access the key material based on security attributes associated with the source key seed.

Following successful key derivation, the API returns a reference to the derived key object to the requesting application. The application then uses this reference to perform cryptographic operations with the derived key material. The derived key remains accessible only to authorized applications within the designated security context.

When cryptographic operations are completed, the application invokes the API to release the derived key memory. The API clears the key material from volatile memory while preserving the original key seed in non-volatile storage. Memory release operations execute within a transaction to maintain system consistency. The API provides status information to the application indicating successful completion of the derivation and release operations or specific error conditions encountered during processing.

This interaction pattern enables applications to efficiently manage PQC keys while operating within the resource constraints of the secure element. The API handles memory management, security enforcement, and transaction control, allowing applications to focus on cryptographic operations rather than low-level key handling details.

### 4.14 Secure Erasure of Derived PQC Keys

In one or more embodiments, the PQC key management API 126 implements reversion methods for releasing derived key resources from secure element memory. Applications 118 invoke reversion by referencing a previously derived key object. The reversion process targets derived PQC key 130 data stored in volatile memory 106 or non-volatile memory 108. Memory management functions execute secure erasure of derived key material through multiple-pass overwrite operations. The secure element 104 applies hardware-backed erasure mechanisms when available to ensure complete removal of sensitive cryptographic data. Reversion operations maintain the original PQC key seed 128 in non-volatile memory 108 while removing derived formats. Resource recovery procedures release memory allocations associated with derived key structures. The API 126 updates memory management tables to reflect freed storage regions following successful key data removal. Memory defragmentation processes optimize available space after reversion operations are completed, consolidating freed memory blocks for future allocation. Access control systems prevent reversion operations from affecting protected seed data. The API 126 validates authorization levels before permitting removal of derived key material. Security mechanisms ensure concurrent operations cannot access key data during reversion processes, maintaining operational integrity within the secure element 104. Transaction monitoring ensures complete resource cleanup during reversion operations. The API 126 tracks memory release status and reports completion status to applications 118. Error handling protocols address partial reversion scenarios through recovery procedures that maintain system stability and security state consistency.

In one or more embodiments, the following example interface of the PQC key management API 126 defines methods implementing key reversion functionality.
package com.security.pqc;
/**
   *Interface defining Post-Quantum Cryptography (PQC) key management operations
   *for secure element implementations. The interface provides methods for
   *reverting derived PQC keys and managing associated resources.
   */
public interface PCSKeyManagement {
   /**
      *Status codes for reversion operations
      */
   public static final byte REVERSION_SUCCESS=0x00;
   public static final byte REVERSION_ERROR_KEY_NOT_FOUND=0x01;
   public static final byte REVERSION_ERROR_INVALID_STATE=0x02;
   public static final byte REVERSION_ERROR_UNAUTHORIZED=0x03;
   public static final byte REVERSION_ERROR_CONCURRENT_ACCESS=0x04;
   /**
      *Memory overwrite patterns for secure erasure
      */
   public static final byte[ ] OVERWRITE_PATTERN_ZERO={0x00};
   public static final byte[ ] OVERWRITE_PATTERN_ONE={(byte)0xFF};
   public static final byte[ ] OVERWRITE_PATTERN_RANDOM=null; //Platform generates random pattern
   /**
      *Reverts a derived PQC key and releases associated resources.
      *Performs secure erasure through multiple-pass overwrites.
      *
      *@param keyHandle Reference to the derived key object
      *@param overwritePattern Pattern to use for secure erasure
      *@param numPasses Number of overwrite passes to perform
      *@return Status code indicating reversion result
      *@throws SecurityException if caller lacks sufficient privileges
      */
   public byte revertDerivedKey(short keyHandle, byte[ ] overwritePattern, byte numPasses);
   /**
      *Validates authorization level for key reversion operations.
      *@param keyHandle Reference to the derived key object
      *@return true if caller has sufficient privileges
      */
   public boolean checkReversionAuth(short keyHandle);
   /**
      *Initiates memory defragmentation after key reversion.
      *Consolidates freed memory blocks for future allocation.
      *
      *@return Number of bytes recovered through defragmentation
      */
   public short defragmentMemory();
   /**
      *Retrieves status of most recent reversion operation.
      *
      *@param keyHandle Reference to the derived key object
      *@return Status code indicating operation state
      */
   public byte getReversionStatus(short keyHandle);
   /**
      *Aborts active reversion operation and restores consistent state.
      *Used for handling partial reversion scenarios.
      *
      *@param keyHandle Reference to the derived key object
      *@return Status code indicating abort result
      */
   public byte abortReversion(short keyHandle);
   /**
      *Acquires exclusive access lock for reversion operation.
      *Prevents concurrent access during key material removal.
      *
      *@param keyHandle Reference to the derived key object
      *@return true if lock was successfully acquired
      */
public boolean acquireReversionLock(short keyHandle);
   /**
      *Releases exclusive access lock after reversion completion.
      *
      *@param keyHandle Reference to the derived key object
      */
   public void releaseReversionLock(short keyHandle);
}

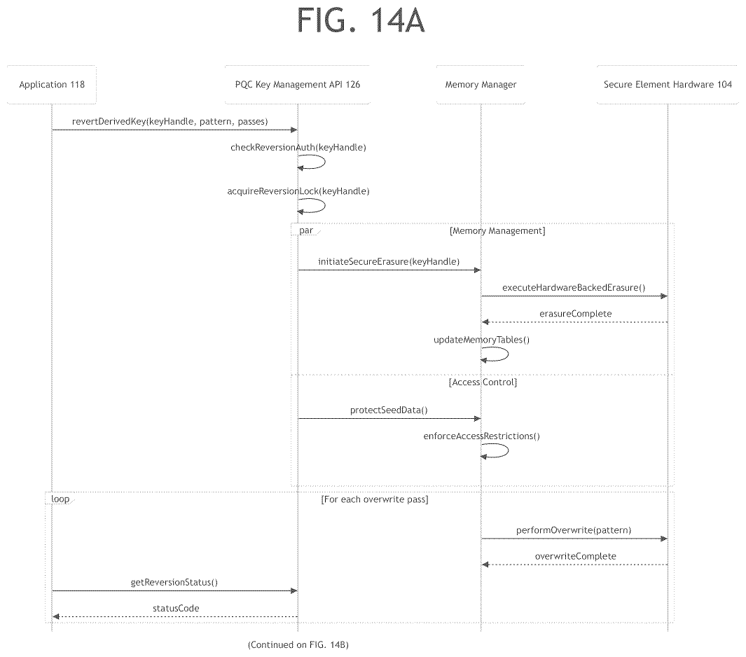

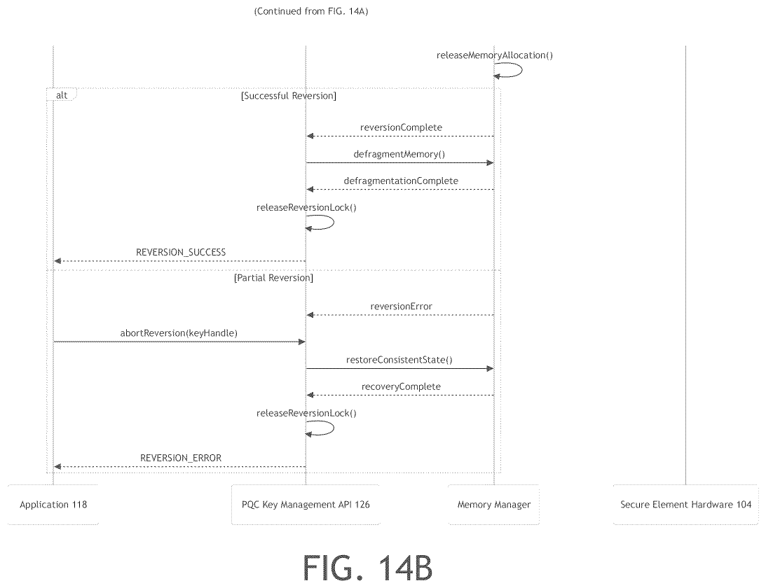

FIG. 14A and FIG. 14B illustrate an example of hardware-backed secure erasure of derived PQC keys while preserving associated key seeds through synchronized memory management, transaction monitoring, and access control operations in accordance with one or more embodiments.

The sequence diagram illustrates the interaction flow between system components during PQC key reversion operations. The application initiates reversion by calling the PQC Key Management API with a key handle, overwrite pattern, and number of passes. The API performs authorization checks and acquires an exclusive lock to prevent concurrent access.

Parallel operations commence for memory management and access control. The Memory Manager coordinates with Secure Element Hardware to execute hardware-backed secure erasure while protecting seed data through access restrictions. Multiple overwrite passes occur based on the specified pattern with the application monitoring status through API queries.

Memory allocation release follows successful erasure. The system then processes one of two paths, either successful reversion leading to memory defragmentation and lock release or error handling through the abort procedure to restore consistent state. The API reports final status to the application, maintaining security state consistency throughout the operation.

The diagram emphasizes protection of seed data in non-volatile memory while derived key material undergoes secure removal. Transaction monitoring and error recovery mechanisms ensure operational integrity within the secure element environment. Memory optimization through defragmentation prepares the system for subsequent key operations.

Returning to the top of FIG. 14A and FIG. 14B, a typical interaction between an application and the PQC key management API begins when the application obtains a handle to a previously derived PQC key stored in volatile memory. The application initiates key reversion by invoking revertDerivedKey() through the PQC key management API, passing the key handle, a specified overwrite pattern, and the desired number of secure erasure passes.

Before processing the reversion request, the API validates authorization by calling checkReversionAuth() to verify that sufficient privileges exist for the requesting application. Upon successful authorization, the API attempts to acquire an exclusive lock via acquireReversionLock() to prevent concurrent access during the reversion operation. The lock acquisition ensures memory consistency throughout the secure erasure process.

The API then executes multiple-pass overwrite operations on the memory regions including the derived key material. These overwrite operations leverage hardware-backed secure erasure capabilities when available on the secure element. During reversion, the application can monitor progress by calling getReversionStatus() to retrieve the current operation state.

Memory management procedures update internal tables to track freed regions as the derived key material undergoes secure erasure. The API maintains the original PQC key seed in protected non-volatile memory while removing derived formats from volatile memory. Following successful key material removal, the API releases the exclusive access lock through releaseReversionLock().

The API then initiates memory defragmentation by calling defragmentMemory() to consolidate the freed memory blocks. Defragmentation optimizes available space for future key derivation operations. The application receives status codes indicating successful completion of both the reversion and defragmentation operations.

In error scenarios where reversion cannot complete normally, the application may invoke abortReversion() to restore system stability. The abort procedure ensures consistent state management while maintaining security properties of the key material. Throughout the interaction, the API enforces access control policies, preventing unauthorized modification of protected seed data stored in non-volatile memory.

### 4.15 Execution of Cryptographic Operations Through Specialized Objects that Process Derived Key Formats

In one or more embodiments, the PQC key management API 126 executes cryptographic operations through specialized objects that process derived key formats. Signature, Cipher, KeyAgreement, and KeyEncapsulation objects receive derived PQC key 130 data as operation parameters. The derived format enables direct utilization of complete key structures stored in volatile memory 106 or non-volatile memory 108. Signature objects perform digital signature generation and verification using derived public or private key components. The API 126 validates key format compatibility with requested signature algorithms before initiating operations. Memory management functions maintain derived key data throughout signature processing while enforcing access controls based on operation type. Cipher objects implement encryption and decryption functions using derived key structures. The API 126 processes cipher operations within protected memory regions of secure element 104. Memory optimization techniques minimize data transfer operations between derived keys and cipher processing buffers. KeyAgreement objects establish shared secrets through derived public-private key pairs. The API 126 coordinates key agreement protocols using derived format data from both participating keys. Memory management systems allocate temporary storage for intermediate results while maintaining security boundaries between key materials. KeyEncapsulation objects generate and process encapsulated keys using derived format parameters. The API 126 executes encapsulation operations with direct access to complete key structures. Memory handlers manage derived keys throughout encapsulation procedures while enforcing object-specific security policies within the secure element environment. Status reporting mechanisms track operation completion and resource utilization. The API 126 communicates operation results to applications 118 through standardized interfaces. Error handling protocols address operation failures while maintaining derived key security in volatile memory 106 or non-volatile memory 108.

In one or more embodiments, the following example interface of the PQC key management API 126 defines methods enabling implementation of PQC operations on secure elements through specialized objects:
package com.secureplatform.pqc;
/**
   *Provides Post-Quantum Cryptography (PQC) key management operations for secure elements.
   *Implements derived key format processing for cryptographic operations through
   *specialized objects managing volatile and non-volatile memory resources.
   */
public interface PQCKeyManagementAPI {
   /**
      *Creates a Signature object for PQC digital signature operations.
      *@param algorithm PQC signature algorithm identifier
      *@param mode Operation mode (SIGN or VERIFY)
      *@return Signature object configured for specified algorithm
      *@throws CryptoException when algorithm is unsupported
      */
   public Signature createPQCSignature(byte algorithm, byte mode) throws CryptoException;
   /**
      *Creates a Cipher object for PQC encryption operations.
      *@param algorithm PQC encryption algorithm identifier
      *@param mode Operation mode (ENCRYPT or DECRYPT)
      *@return Cipher object configured for specified algorithm
      *@throws CryptoException when algorithm is unsupported
      */
   public Cipher createPQCCipher(byte algorithm, byte mode) throws CryptoException;
   /**
      *Creates a KeyAgreement object for PQC key exchange protocols.
      *@param algorithm PQC key agreement algorithm identifier
      *@return KeyAgreement object configured for specified algorithm
      *@throws CryptoException when algorithm is unsupported
      */
   public KeyAgreement CreatePQCKeyAgreement(byte algorithm) throws CryptoException;
   /**
      *Creates a KeyEncapsulation object for PQC key encapsulation mechanisms.
      *@param algorithm PQC encapsulation algorithm identifier
      *@return KeyEncapsulation object configured for specified algorithm
      *@throws CryptoException when algorithm is unsupported
      */
   public KeyEncapsulation createPQCKeyEncapsulation(byte algorithm) throws CryptoException;
   /**
      *Derives a PQC key seed into full key material in volatile memory.
      *@param keyBuffer Buffer including key seed data
      *@param keyOffset Starting offset of key seed in buffer
      *@param keyLength Length of key seed data
      *@return Handle to derived key in volatile memory
      *@throws CryptoException when derivation fails
      */
   public short derivePQCKey(byte[ ] keyBuffer, short keyOffset, short keyLength) throws CryptoException;
   /**
      *Releases derived PQC key material from volatile memory.
      *@param keyHandle Handle to derived key material
      */
   public void clearDerivedKey(short keyHandle);
   /**
      *Reports status of last PQC operation.
      *@return Status code indicating operation result
      */
   public byte getOperationStatus();
   /**
      *Constants defining supported PQC algorithms
      */
   public static final byte ALG_ML-DSA=(byte)0x01;
   public static final byte ALG_ML-KEM=(byte)0x02;
   public static final byte ALG_FALCON=(byte)0x03;
   /**
      *Constants defining operation modes
      */
   public static final byte MODE_SIGN=(byte)0x01;
   public static final byte MODE_VERIFY=(byte)0x02;
   public static final byte MODE_ENCRYPT=(byte)0x03;
   public static final byte MODE_DECRYPT=(byte)0x04;
   /**
      *Status codes for operation results
      */
   public static final byte STATUS_SUCCESS=(byte)0x00;
   public static final byte STATUS_INVALID_KEY=(byte)0x01;
   public static final byte STATUS_MEMORY_ERROR=(byte)0x02;
   public static final byte STATUS_OPERATION_ERROR=(byte)0x03;
}
/**
   *Interface for PQC digital signature operations using derived key formats.
   */
public interface Signature {
   /**
      *Initializes signature operation with derived PQC key.
      *@param keyHandle Handle to derived key material
      *@throws CryptoException when key format is invalid
      */
   public void init(short keyHandle) throws CryptoException;
   /**
      *Signs input data using derived private key.
      *@param inBuff Buffer including input data
      *@param inOffset Starting offset of input data
      *@param inLength Length of input data
      *@param sigBuff Buffer for signature output
      *@param sigOffset Starting offset for signature
      *@return Length of generated signature
      *@throws CryptoException when signing fails
      */
   public short sign(byte[ ] inBuff, short inOffset, short inLength, byte[] sigBuff, short sigOffset) throws CryptoException;
   /**
      *Verifies signature using derived public key.
      *@param inBuff Buffer including input data
      *@param inOffset Starting offset of input data
      *@param inLength Length of input data
      *@param sigBuff Buffer including signature
      *@param sigOffset Starting offset of signature
      *@param sigLength Length of signature
      *@return true if signature is valid
      *@throws CryptoException when verification fails
      */
   public boolean verify(byte[ ] inBuff, short inOffset, short inLength, byte[ ] sigBuff, short sigOffset, short sigLength) throws CryptoException;
}
/**
   *Interface for PQC key encapsulation mechanisms using derived key formats.
   */
public interface KeyEncapsulation {
   /**
      *Initializes encapsulation with derived PQC key.
      *@param keyHandle Handle to derived key material
      *@throws CryptoException when key format is invalid
      */
   public void init(short keyHandle) throws CryptoException;
   /**
      *Generates encapsulated key and encapsulation.
      *@param encBuff Buffer for encapsulation output
      *@param encOffset Starting offset for encapsulation
      *@param sharedBuff Buffer for shared secret output
      *@param sharedOffset Starting offset for shared secret
      *@return Length of generated encapsulation
      *@throws CryptoException when generation fails
      */
   public short encapsulate(byte[ ] encBuff, short encOffset, byte[ ] sharedBuff, short sharedOffset) throws CryptoException;
   /**
      *Decapsulates shared secret from encapsulation.
      *@param encBuff Buffer including encapsulation
      *@param encOffset Starting offset of encapsulation
      *@param encLength Length of encapsulation
      *@param sharedBuff Buffer for shared secret output
      *@param sharedOffset Starting offset for shared secret
      *@return Length of recovered shared secret
      *@throws CryptoException when decapsulation fails
      */
   public short decapsulate(byte[ ] encBuff, short encOffset, short encLength, byte[ ] sharedBuff, short sharedOffset) throws CryptoException;
}

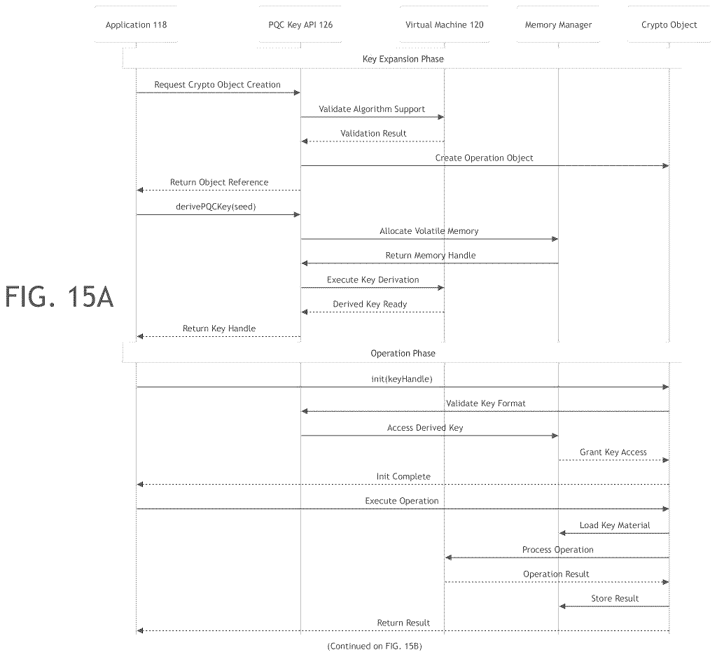

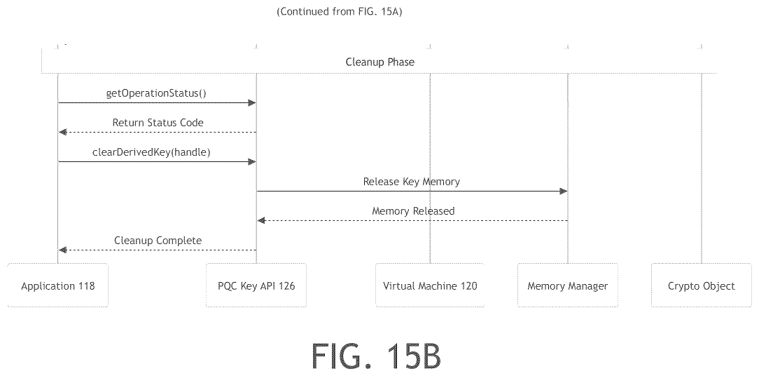

FIG. 15A and FIG. 15B illustrate an example of a post-quantum cryptography key management API that enables secure element applications to execute cryptographic operations through specialized objects that process derived key formats stored in memory while maintaining security boundaries and optimizing resource utilization in accordance with one or more embodiments.

The sequence diagram illustrates the interaction flow between system components during PQC operations. The application 118 initiates operations by requesting creation of specialized cryptographic objects from the PQC Key Management API 126. The API validates algorithm support through the Virtual Machine 120 and creates appropriate operation objects.

Key derivation sequences begin when the application 118 calls derivePQCKey with seed data. The Memory Manager allocates volatile memory space and returns a handle. The Virtual Machine 120 executes derivation algorithms to generate complete key structures from seed data.

Operation sequences commence with object initialization using the key handle. The cryptographic object validates key format compatibility through the API and establishes access to derived key material. The object executes requested operations by loading key material through the Memory Manager and processing data through the Virtual Machine 120.

Cleanup sequences involve status verification and memory release. The application 118 queries operation status and initiates key cleanup through clearDerivedKey. The Memory Manager releases volatile memory resources while maintaining seed data in non-volatile storage.

The diagram emphasizes security boundaries and memory management throughout operation sequences. Protected memory regions include derived keys while minimizing data transfer operations. Status reporting and error handling mechanisms ensure proper operation completion and resource management.

Returning to the top of FIG. 15A and FIG. 15B, the application first obtains a reference to the PQC key management API through the secure element platform's service registry. The application then invokes createPQCSignature with algorithm parameter ALG_ML-DSA and mode parameter MODE_SIGN to create a Signature object for generating digital signatures.

Before performing signature operations, the application is required to provide derived key material to the Signature object. The application calls derivePQCKey with a buffer including a previously stored PQC key seed. The PQC key management API processes this request by allocating space in volatile memory and executing deterministic key derivation algorithms on the seed data. The API returns a handle identifying the location of derived key material in volatile memory. The application passes this handle to the Signature object's init method, enabling the object to access the derived private key for signature generation.

The application prepares input data for signing in a byte array buffer. A call to the Signature object's sign method processes this input data using the derived private key material. The sign method stores the resulting signature in an output buffer provided by the application. Throughout the signing operation, the derived key material remains secured within the volatile memory regions managed by the API.

Following successful signature generation, the application queries operation status through getOperationStatus. The status code STATUS_SUCCESS indicates proper completion of the signing operation. The application then calls clearDerivedKey with the key handle to release volatile memory resources. The PQC key management API removes the derived key material while preserving the original key seed in non-volatile memory for future operations.

The application may subsequently create additional cryptographic objects for different PQC operations. Requests to createPQCCipher, createPQCKeyAgreement, or createPQCKeyEncapsulation return specialized objects configured for specific algorithms. These objects follow similar patterns of key derivation, operation execution, and resource cleanup. The API maintains separation between derived keys used by different objects while optimizing memory usage across operations.

### 4.16 Processing Cryptographic Operations by Temporarily Deriving Condensed Key Seeds

In one or more embodiments, the PQC key management API 126 processes cryptographic operations through specialized objects that accept condensed key formats. Signature, Cipher, and KeyEncapsulation objects receive PQC key seed 128 data as operation parameters. Memory management functions perform temporary derivation of condensed keys during individual operation execution. Signature objects derive condensed private keys for signature generation or condensed public keys for verification. The API 126 allocates volatile memory 106 segments to store temporarily derived key material. Derivation procedures derive PQC key 130 structures through deterministic algorithms specified in PQC key params 132. Memory handlers release derived key data upon signature operation completion. Cipher objects process encryption and decryption requests using condensed key formats. The API 126 executes inline key derivation within protected memory regions of secure element 104. Temporary storage allocation supports derived key utilization during cipher operations. Secure erasure procedures remove derived key material following operation completion. KeyEncapsulation objects perform encapsulation and decapsulation with condensed key representations. The API 126 derives condensed keys into volatile memory 106 for single operation execution. Memory management systems maintain security boundaries between original condensed keys and temporary derived formats. Cleanup routines ensure removal of derived key material after encapsulation processing completes. Transaction monitoring ensures proper resource management throughout operation sequences. The API 126 tracks memory allocation and release for temporary key derivation. Error handling mechanisms address operation failures through secure cleanup of derived key material. Status reporting functions communicate operation results while preserving condensed key security in non-volatile memory 108.

In one or more embodiments, the following example interface of the PQC key management API 126 defines methods implementing PQC key management functionality:
package com.security.pqc;
import javacard.framework.*;
import javacard.security.*;
/**
   *API interface for Post-Quantum Cryptography (PQC) key management operations.
   *Provides functionality for signature, cipher, and key encapsulation using condensed key formats.
   */
public interface PQCKeyManagementInterface {
   //Constants for operation types
   public static final byte ALG_PQC_SIGNATURE=(byte)0x01;
   public static final byte ALG_PQC_CIPHER=(byte)0x02;
   public static final byte ALG_PQC_KEM=(byte)0x03;
   //Status codes
   public static final short STATUS_SUCCESS=(short)0x9000;
   public static final short STATUS_INVALID_PARAMS=(short)0x6A80;
   public static final short STATUS_INSUFFICIENT_MEMORY=(short)0x6A84;
   public static final short STATUS_OPERATION_FAILED=(short)0x6A88;
   /**
      *Creates a PQC signature object with specified parameters.
      *@param params Buffer including algorithm parameters
      *@param paramsOffset Offset of parameters in buffer
      *@param paramsLength Length of parameters
      *@return Handle to created signature object
      *@throws CryptoException if object creation fails
      */
   public short createSignatureObject(byte[ ] params, short paramsOffset, short paramsLength) throws CryptoException;
   /**
      *Initializes signature operation with condensed key seed.
      *@param signatureHandle Handle to signature object
      *@param keyMode Key usage mode (SIGN or VERIFY)
      *@param keySeed Buffer including condensed key seed
      *@param seedOffset Offset of key seed in buffer
      *@param seedLength Length of key seed
      *@return Status code indicating operation result
      */
   public short initSignature(short signatureHandle, byte keyMode, byte[ ] keySeed, short seedOffset, short seedLength);
   /**
      *Performs signature operation using derived key.
      *@param signatureHandle Handle to signature object
      *@param data Input data buffer
      *@param dataOffset Offset of data in buffer
      *@param dataLength Length of data
      *@param signature Output signature buffer
      *@param signatureOffset Offset for signature output
      *@return Length of generated signature or verification result
      */
   public short processSignature(short signatureHandle, byte[ ] data, short dataOffset, short dataLength, byte[ ] signature, short signatureOffset);
   /**
      *Creates a PQC cipher object with specified parameters.
      *@param params Buffer including algorithm parameters
      *@param paramsOffset Offset of parameters in buffer
      *@param paramsLength Length of parameters
      *@return Handle to created cipher object
      *@throws CryptoException if object creation fails
      */
   public short createCipherObject(byte[ ] params, short paramsOffset, short paramsLength) throws CryptoException;
   /**
      *Initializes cipher operation with condensed key seed.
      *@param cipherHandle Handle to cipher object
      *@param keyMode Operation mode (ENCRYPT or DECRYPT)
      *@param keySeed Buffer including condensed key seed
      *@param seedOffset Offset of key seed in buffer
      *@param seedLength Length of key seed
      *@return Status code indicating operation result
      */
   public short initCipher(short cipherHandle, byte keyMode, byte[ ] keySeed, short seedOffset, short seedLength);
   /**
      *Performs cipher operation using derived key.
      *@param cipherHandle Handle to cipher object
      *@param input Input data buffer
      *@param inputOffset Offset of input in buffer
      *@param inputLength Length of input
      *@param output Output data buffer
      *@param outputOffset Offset for output
      *@return Length of processed data
      */
   public short processCipher(short cipherHandle, byte[ ] input, short inputOffset, short inputLength, byte[ ] output, short outputOffset);
   /**
      *Creates a PQC key encapsulation mechanism (KEM) object.
      *@param params Buffer including algorithm parameters
      *@param paramsOffset Offset of parameters in buffer
      *@param paramsLength Length of parameters
      *@return Handle to created KEM object
      *@throws CryptoException if object creation fails
      */
   public short createKEMObject(byte[ ] params, short paramsOffset, short paramsLength) throws CryptoException;
   /**
      *Initializes KEM operation with condensed key seed.
      *@param kemHandle Handle to KEM object
      *@param keyMode Operation mode (ENCAPSULATE or DECAPSULATE)
      *@param keySeed Buffer including condensed key seed
      *@param seedOffset Offset of key seed in buffer
      *@param seedLength Length of key seed
      *@return Status code indicating operation result
      */
   public short initKEM(short kemHandle, byte keyMode, byte[ ] keySeed, short seedOffset, short seedLength);
   /**
      *Performs KEM operation using derived key.
      *@param kemHandle Handle to KEM object
      *@param input Input data buffer
      *@param inputOffset Offset of input in buffer
      *@param inputLength Length of input
      *@param output Output data buffer
      *@param outputOffset Offset for output
      *@return Length of processed data
      */
   public short processKEM(short kemHandle, byte[ ] input, short inputOffset, short inputLength, byte[ ] output, short outputOffset);
   /**
      *Releases resources associated with cryptographic object.
      *@param objectHandle Handle to object being released
      *@return Status code indicating operation result
      */
   public short releaseObject(short objectHandle);
   /**
      *Retrieves status information for last operation.
      *@param statusBuffer Buffer to receive status information
      *@param statusOffset Offset in buffer for status
      *@return Length of status information
      */
   public short getStatus(byte[ ] statusBuffer, short statusOffset);
}

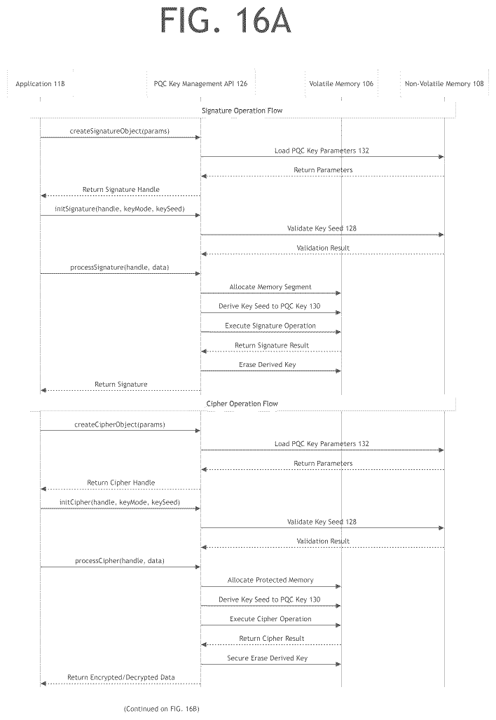

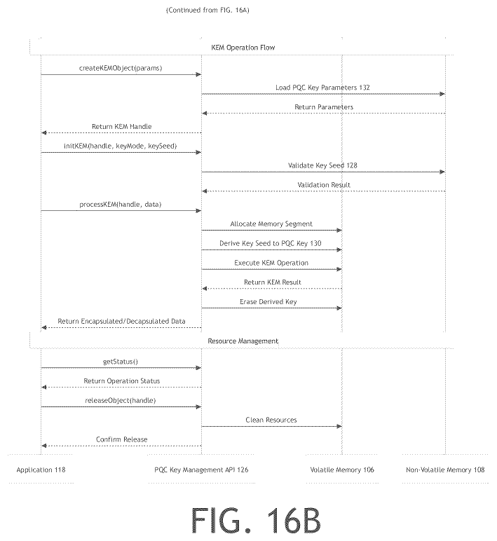

FIG. 16A and FIG. 16B illustrate an example of a secure element application platform that implements PQC key management through an API that processes cryptographic operations by temporarily deriving condensed key seeds into volatile memory while maintaining security boundaries between derived and condensed formats in accordance with one or more embodiments.

The sequence diagram illustrates three primary operation flows for PQC key management: Signature operations, Cipher operations, and Key Encapsulation Mechanism (KEM) operations. A flow demonstrates the interaction between application 118, PQC Key Management API 126, Volatile Memory 106, and Non-Volatile Memory 108 components.

The signature operation flow begins with the application 118 creating a signature object through the API 126. The API 126 loads parameters from Non-Volatile Memory 108 and returns a handle to the application 118. During signature processing, the API 126 manages temporary key derivation in Volatile Memory 106, followed by secure erasure of derived key material.

The cipher operation flow follows a similar pattern but implements additional security measures for protected memory operations. The API 126 performs inline key derivation within designated secure memory regions of the Volatile Memory 106. Secure erasure procedures ensure complete removal of derived key material after cipher operations are complete.

The KEM operation flow demonstrates encapsulation and decapsulation processes. The API 126 maintains strict security boundaries between condensed keys in Non-Volatile Memory 108 and derived formats in Volatile Memory 106. Memory management includes allocation, derivation, operation execution, and cleanup phases. Resource management operations span all three flows.

The application 118 can query operation status and release object handles, triggering cleanup procedures in Volatile Memory 106. The diagram shows how the API 126 tracks resource allocation and implements proper cleanup procedures throughout the operation sequences.

Returning to the top of FIG. 16A and FIG. 16B example, the application 118 interacts with the PQC key management API 126 through a sequence of method calls that manage key derivation and cryptographic operations. When the application 118 needs to perform a digital signature operation, the application 118 first invokes createSignatureObject with a byte array including algorithm-specific parameters. The API 126 processes these parameters and returns a handle that uniquely identifies the created signature object within the secure element 104.

Using the returned signature handle, the application 118 calls initSignature to prepare for signing data. The application 118 provides a condensed key seed stored in non-volatile memory 108 along with a mode indicator specifying signature generation. The API 126 validates the key seed format and prepares internal data structures for the signing operation without immediately deriving the key.

The application 118 then calls processSignature with input data to be signed. Upon receiving this request, the API 126 allocates a segment of volatile memory 106 and derives the condensed key seed into a full PQC key 130 suitable for signature generation. The API 126 executes the signature algorithm using the derived key and input data, producing a digital signature that returns to the application 118. Following signature generation, the API 126 securely erases the derived key material from volatile memory 106 while preserving the original condensed key seed.

To verify the transaction completed successfully, the application 118 calls getStatus to retrieve operation results. The API 126 returns status information that indicates successful completion of the signature operation and proper cleanup of derived key material. The application 118 concludes the operation sequence by calling releaseObject with the signature handle, allowing the API 126 to free any remaining resources associated with the signature object.

Throughout this interaction, the API 126 maintains security boundaries between the condensed and derived key representations while efficiently managing volatile memory resources. The application 118 interacts with the condensed key format through the API 126 methods, remaining isolated from the complexity of key derivation and cleanup operations occurring within the secure element 104.

In one or more embodiments, the PQC key management API 126 implements initialization methods using key objects that encapsulate condensed key seed data. A key object provides a secure container for managing condensed key material throughout cryptographic operations. The key object structure maintains seed data in protected memory regions while exposing controlled interfaces for derivation operations.

The following example interface demonstrates the initialization methods that accept key objects:
public interface PQCKeyManagementInterface {
   // Previous constants remain unchanged
   /**
      *Creates a key object containing condensed key material.
      *@param keySeed Buffer containing condensed key seed
      *@param seedOffset Offset of key seed in buffer
      *@param seedLength Length of key seed
      *@return Created KeyObject
      *@throws CryptoException if object creation fails
      */
   public KeyObject createKeyObject(byte[ ] keySeed, short seedOffset, short seedLength) throws CryptoException;
   /**
      *Initializes signature operation with key object.
      *@param signatureHandle Handle to signature object
      *@param keyMode Key usage mode (SIGN or VERIFY)
      *@param keyObj KeyObject containing seed
      *@return Status code indicating operation result
      */
   public short initSignature(short signatureHandle, byte keyMode, KeyObject keyObj);
   /**
      *Initializes cipher operation with key object.
      *@param cipherHandle Handle to cipher object
      *@param keyMode Operation mode (ENCRYPT or DECRYPT)
      *@param keyObj KeyObject containing seed
      *@return Status code indicating operation result
      */
   public short initCipher(short cipherHandle, byte keyMode, KeyObject keyObj);
   /**
      *Initializes KEM operation with key object.
      *@param kemHandle Handle to KEM object
      *@param keyMode Operation mode (ENCAPSULATE or DECAPSULATE)
      *@param keyObj KeyObject containing seed
      *@return Status code indicating operation result
      */
   public short initKEM(short kemHandle, byte keyMode, KeyObject keyObj);
   //Additional method for key object management
   /**
      *Releases resources associated with key object.
      *@param keyObj KeyObject being released.
      *@return Status code indicating operation result
      */
   public short releaseKeyObject(short keyHandle);
   //Previous methods remain unchanged
}

The API 126 maintains key objects separately from operation-specific objects. Applications create key objects through the createKeyObject method, which stores condensed key seeds in protected memory regions. The method returns a handle that uniquely identifies the key object for subsequent operations.

Initialization methods for signature, cipher, and KEM operations accept the key object handle rather than direct seed data. The revised approach enhances security by reducing exposure of raw key material during parameter passing. Memory management functions track both operation objects and key objects independently, enabling proper resource cleanup when operations complete.

When the application 118 initializes a cryptographic operation, the API 126 validates the provided key object handle and configures the operation using the encapsulated seed data. The key object maintains seed protection while supporting temporary key derivation for specific operations. Resource management systems monitor both key objects and operation objects to ensure proper cleanup of derived key material and release of associated memory.

### 6. PRACTICAL APPLICATIONS, ADVANTAGES, AND IMPROVEMENTS

One or more embodiments address a gap in the current secure element platform APIs, which lacks native support for PQC key management despite growing market demand for PQC implementations on secure elements. One or more embodiments deliver significant advantages for secure element application developers by providing a streamlined approach to PQC key handling. Memory optimization represents a key benefit, achieved through the flexible condensation and derivation mechanisms. The API enables efficient key importation and utilization processes, reducing the complexity of PQC implementation for application developers. Security benefits emerge from the integration of key generation, condensation, and derivation functions within the certified platform environment. These cryptographic operations can leverage native code implementations, allowing direct access to hardware acceleration features of the secure element. Native code implementation also enables the use of hardware-based countermeasures against side-channel attacks. This approach combines development efficiency, resource optimization, and security enhancement, providing a robust foundation for PQC implementation on secure element platforms such as the JAVA CARD platform.

### 7. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

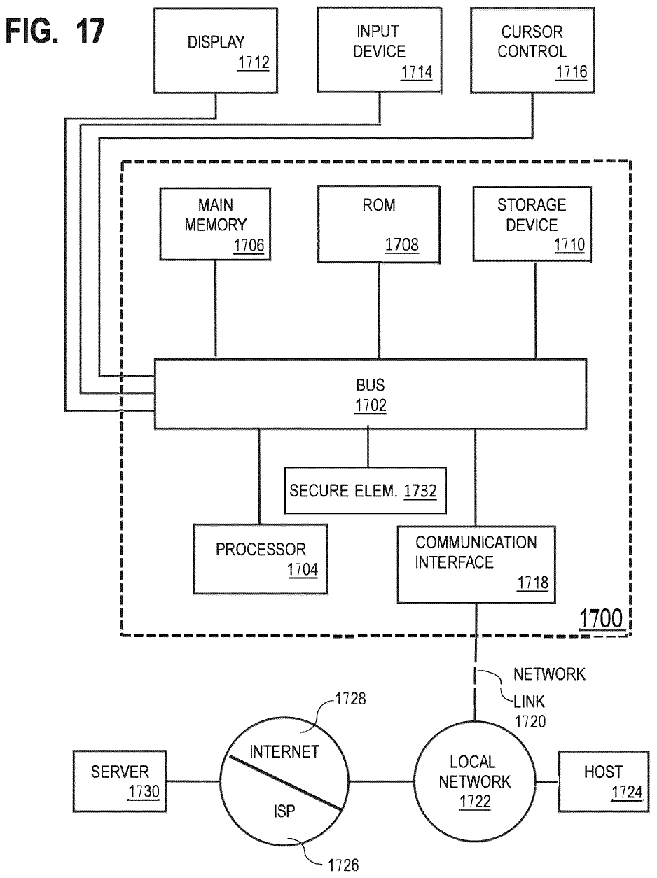

For example, FIG. 17 is a block diagram that illustrates a computer system 1700 upon which an embodiment of the disclosure may be implemented. In one or more embodiments, computer system 1700 implements host device 102 of FIG. 1. Computer system 1700 includes a bus 1702 or other communication mechanism for communicating information, and a hardware processor 1704 coupled with bus 1702 for processing information. Hardware processor 1704 may be, for example, a general-purpose microprocessor.

Computer system 1700 also includes a main memory 1706, such as a random-access memory (RAM) or other dynamic storage device, coupled to bus 1702 for storing information and instructions to be executed by processor 1704. Main memory 1706 also may be used for storing temporary variables or other intermediate information during execution of instructions to be executed by processor 1704. Such instructions, when stored in non-transitory storage media accessible to processor 1704, render computer system 1700 into a special-purpose machine that is customized to perform the operations specified in the instructions.

Computer system 1700 further includes a read only memory (ROM) 1708 or other static storage device coupled to bus 1702 for storing static information and instructions for processor 1704. A storage device 1710, such as a magnetic disk, optical disk, or a Solid-State Drive (SSD) is provided and coupled to bus 1702 for storing information and instructions.

Computer system 1700 may be coupled via bus 1702 to a display 1712, such as a cathode ray tube (CRT), for displaying information to a computer user. An input device 1714, including alphanumeric and other keys, is coupled to bus 1702 for communicating information and command selections to processor 1704. Another type of user input device is cursor control 1716, such as a mouse, a trackball, or cursor direction keys for communicating direction information and command selections to processor 1704 and for controlling cursor movement on display 1712. This input device typically has two degrees of freedom in two axes, a first axis (e.g., x) and a second axis (e.g., y), that allows the device to specify positions in a plane.

Computer system 1700 may implement the techniques described herein using customized hard-wired logic, one or more ASICs or FPGAs, firmware and/or program logic which in combination with the computer system causes or programs computer system 1700 to be a special-purpose machine. According to one embodiment, the techniques herein are performed by computer system 1700 based on processor 1704 executing one or more sequences of one or more instructions contained in main memory 1706. Such instructions may be read into main memory 1706 from another storage medium, such as storage device 1710. Execution of the sequences of instructions contained in main memory 1706 causes processor 1704 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 1710. Volatile media includes dynamic memory, such as main memory 1706. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 1702. Transmission media can also take the form of acoustic or light waves, such as those generated during radio-wave and infra-red data communications.

Various forms of media may be involved in carrying one or more sequences of one or more instructions to processor 1704 for execution. For example, the instructions may initially be carried on a magnetic disk or solid-state drive of a remote computer. The remote computer can load the instructions into its dynamic memory and send the instructions over a telephone line using a modem. A modem local to computer system 1700 can receive the data on the telephone line and use an infra-red transmitter to convert the data to an infra-red signal. An infra-red detector can receive the data carried in the infra-red signal and appropriate circuitry can place the data on bus 1702. Bus 1702 carries the data to main memory 1706, from which processor 1704 retrieves and executes the instructions. The instructions received by main memory 1706 may optionally be stored on storage device 1710 either before or after execution by processor 1704.

Computer system 1700 also includes a communication interface 1718 coupled to bus 1702. Communication interface 1718 provides a two-way data communication coupling to a network link 1720 that is connected to a local network 1722. For example, communication interface 1718 may be an integrated services digital network (ISDN) card, cable modem, satellite modem, or a modem to provide a data communication connection to a corresponding type of telephone line. As another example, communication interface 1718 may be a local area network (LAN) card to provide a data communication connection to a compatible LAN. Wireless links may also be implemented. In any such implementation, communication interface 1718 sends and receives electrical, electromagnetic or optical signals that carry digital data streams representing various types of information.

Network link 1720 typically provides data communication through one or more networks to other data devices. For example, network link 1720 may provide a connection through local network 1722 to a host computer 1724 or to data equipment operated by an Internet Service Provider (ISP) 1726. ISP 1726 in turn provides data communication services through the worldwide packet data communication network now commonly referred to as the “Internet” 1728. Local network 1722 and Internet 1728 both use electrical, electromagnetic or optical signals that carry digital data streams. The signals through the various networks and the signals on network link 1720 and through communication interface 1718, which carry the digital data to and from computer system 1700, are example forms of transmission media.

Computer system 1700 can send messages and receive data, including program code, through the network(s), network link 1720 and communication interface 1718. In the Internet example, a server 1730 might transmit a requested code for an application program through Internet 1728, ISP 1726, local network 1722 and communication interface 1718.

The received code may be executed by processor 1704 as it is received, and/or stored in storage device 1710, or other non-volatile storage for later execution.

A secure element 1732 is coupled to bus 1702. For example, the secure element 1732 may be secure element 104 of FIG. 1 or otherwise configured to perform techniques disclosed herein for efficient cryptographic key management in resource constrained devices where secure element 1732 is an example of A resource constrained device. Secure element 1732 is a tamper-resistant hardware component designed to securely store and process sensitive data and cryptographic keys as well as perform security-critical operations in a highly constrained environment. It operates as an isolated execution environment, providing robust protection against both physical and logical attacks. Secure element 1730 may be equipped with a dedicated secure processor, non-volatile memory for storing confidential information, and specialized cryptographic hardware accelerators. Secure element 1732 may run a lightweight operating system with support for standards, such as ISO/IEC 7816 or GlobalPlatform specifications, to ensure interoperability and secure communication. Secure element 1732 may be integrated as embedded chips (eSE), removable components (UICC or microSD), or standalone modules (TPMs or smart cards). Secure element 1732 may be used in various applications, such as mobile payments, authentication, digital identities, and secure IoT deployments. The architecture of secure element 1732 may emphasize secure boot, encrypted communication, tamper detection, and isolation from the host system 1700.

Secure element 1732 may be connected to the host system 1700 through various interfaces, depending on its form factor, use case, and the host system's architecture. For example, secure element 1732 can be an embedded secure element (eSE) directly soldered onto the host system's printed circuit board, such as, for example, where host system 1700 is a smartphone, a tablet, or an IoT device. Another possible connection involves secure element 1732 as part of a Universal Integrated Circuit Card (UICC) physically inserted into a SIM slot. In another possible connection, secure element 1732 is a MicroSD secure element inserted into the host system's microSD card slot. In another possible connection, secure element 1732 is a USB secure element plugged into a USB port of host system 1700. In another possible connection, secure element 1732 is a separate chip connected via General-Purpose Input/Output (GPI), Serial Peripheral Interface (SPI), or Inter-Integrated Circuit (I²C). In another possible connection, secure element 1732 is a Near-Field Communication (NFC) secure element integrated into a NFC controller chip such as in a contactless payment implementation.

The secure element 1732 may include a processor capable of directly or indirectly executing a set of instructions that are configured to perform PQC key management operations disclosed herein. The processor within secure element 1732 executes instructions stored in memory components, such as RAM, ROM, or flash memory. These instructions implement specific post-quantum cryptographic key management operations. The processor may execute instructions directly when the instructions comprise native machine code compatible with the processor's instruction set architecture. The processor may execute instructions indirectly when the instructions require interpretation or compilation through a virtual machine or runtime environment. PQC key management operations performed by the processor include, but are not limited to, deriving condensed key seeds into full PQC keys, storing derived keys in volatile memory, executing cryptographic functions using the derived keys, and securely erasing derived key material after operations complete. The processor coordinates with memory management systems to allocate and release memory segments for temporary key derivation while maintaining security boundaries between condensed and derived key formats.

### 8. MISCELLANEOUS; EXTENSIONS

ess otherwise defined, all terms (including technical and scientific terms) are to be given their ordinary and customary meaning to a person of ordinary skill in the art and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

1. A secure element system comprising:
a secure element comprising a volatile memory, a non-volatile memory, and a processor; and
a set of instructions which, when executed directly or indirectly by the processor, causes the secure element to perform of a set of operations comprising:
storing a cryptographic key seed in memory of the secure element;
based on receiving a request sent from an application executing on the secure element system, generating a cryptographic key based on applying a deterministic cryptographic key derivation process to the cryptographic key seed;
storing the cryptographic key in the memory of the secure element; and
subsequent to executing a cryptographic process requested by the application using the cryptographic key, discarding the cryptographic key stored in memory of the secure element while retaining the cryptographic key seed in memory of the secure element.

2. The secure element system of claim 1, wherein the set of operations further comprises:
subsequent to the discarding the cryptographic key:
based on receiving a request sent from the application, generating the cryptographic key based on applying the deterministic cryptographic key derivation process to the cryptographic key seed;
storing the cryptographic key in memory of the secure element; and
subsequent to executing a cryptographic process using the cryptographic key, discarding the cryptographic key stored in memory of the secure element.

3. The secure element system of claim 1, wherein the set of operations further comprises:
receiving a request sent from the application to discard the cryptographic key; and
discarding the cryptographic key based on the request sent from the application to discard the cryptographic key.

4. The secure element system of claim 1, wherein the set of operations further comprises:
receiving the cryptographic key seed sent from an application executing on the secure element system; and
storing the cryptographic key seed in memory of the secure element based on the receiving the cryptographic key seed sent from an application executing on the secure element system.

5. The secure element system of claim 1, wherein the request sent from the application specifies a memory type; and wherein the set of operations further comprises storing the cryptographic key in memory of the secure element of the memory type.

6. The secure element system of claim 1, wherein the request sent from the application specifies a set of one or more cryptographic key parameters; and wherein the set of operations further comprises generating the cryptographic key based on the set of one or more cryptographic key parameters.

7. The secure element system of claim 1, wherein the request sent from the application identifies a set of one or more cryptographic key parameters; and wherein the set of the operations further comprises:
retrieving the set of one or more cryptographic key parameters from a read-only memory of the secure element; and
generating the cryptographic key is based on the set of one or more cryptographic key parameters.

8. The secure element system of claim 1, wherein the request sent from the application indicates the deterministic cryptographic key derivation process to apply to the cryptographic key seed.

9. The secure element system of claim 1, wherein the deterministic cryptographic key derivation process is a hash-based cryptographic key derivation process, a block cipher-based cryptographic key derivation process, or a stream cipher-based cryptographic key derivation process.

10. The secure element system of claim 1, wherein the cryptographic key seed is equal to, or less than 64 bytes and the cryptographic key is greater than 64 bytes.

11. The secure element system of claim 1, wherein the set of operations further comprises generating the cryptographic key based on a set of one or more cryptographic key parameters that is stored in a type of memory of the secure element that is different than a type of memory of the secure element that stores the cryptographic key seed.

12. The secure element system of claim 1, wherein the set of operations further comprises storing a plurality of cryptographic key seeds in memory of the secure element; and wherein the request sent from the application executing on the secure element system uniquely identifies the cryptographic key seed.

13. The secure element system of claim 1, wherein the request sent from the application requests performance of the cryptographic process.

14. The secure element system of claim 1, wherein the request sent from the application requests derivation of the cryptographic key seed into the cryptographic key.

15. The secure element system of claim 1, wherein the set of operations further comprises generating the cryptographic key seed.

16. The secure element system of claim 1, wherein the set of operations further comprises:
determining an amount of memory of the secure element; and
discarding the cryptographic key based on the amount of memory.

17. A method comprising:
storing a post-quantum cryptographic key seed in memory of a device;
based on receiving a request sent from an application, generating a post-quantum cryptographic key based on applying a deterministic post-quantum cryptographic key derivation process to the post-quantum cryptographic key seed;
storing the post-quantum cryptographic key in memory of the device; and
subsequent to executing a cryptographic process using the post-quantum cryptographic key, discarding the post-quantum cryptographic key stored in memory of the device while retaining the post-quantum cryptographic key seed in memory of the device.

18. The method of claim 17, further comprising:
subsequent to the discarding the post-quantum cryptographic key:
based on receiving a request sent from the application, generating the post-quantum cryptographic key based on applying the deterministic post-quantum cryptographic key derivation process to the post-quantum cryptographic key seed;
storing the post-quantum cryptographic key in memory of the device; and
subsequent to executing a cryptographic process using the post-quantum cryptographic key, discarding the post-quantum cryptographic key stored in memory of the device.

19. One or more non-transitory computer-readable media storing a set of instructions which, when directly or indirectly executed by a processor of a secure element, cause performance of a set of operations comprising:
storing a post-quantum cryptographic key seed in non-volatile memory of the secure element;
based on receiving a request sent from an application, generating a post-quantum cryptographic key based on applying a deterministic post-quantum cryptographic key derivation process to the post-quantum cryptographic key seed;
storing the post-quantum cryptographic key in volatile memory of the secure element; and
subsequent to executing a cryptographic process using the post-quantum cryptographic key, discarding the post-quantum cryptographic key stored in volatile memory of the secure element while retaining the post-quantum cryptographic key seed in non-volatile memory of the secure element.

20. The one or more non-transitory computer-readable media of claim 19, the set of operations further comprising:
subsequent to the discarding the post-quantum cryptographic key:
based on receiving a request sent from the application, generating the post-quantum cryptographic key based on applying the deterministic post-quantum cryptographic key derivation process to the post-quantum cryptographic key seed;
storing the post-quantum cryptographic key in volatile memory of the secure element; and
subsequent to executing a cryptographic process using the post-quantum cryptographic key, discarding the post-quantum cryptographic key stored in volatile memory of the secure element while retaining the post-quantum cryptographic key seed in non-volatile memory of the secure element.
